(19) United States
(12) Patent Application Publication
(10) Pub. No.: US 2012/0004268 A1
(43) Pub. Date: Jan. 5, 2012

(54) INSECTICIDAL COMPOSITIONS COMPRISING CYCLIC CARBONYLAMIDINES

(75) Inventors: Peter JESCHKE, Bergisch Gladbach (DE); Olga MALSAM, Rosrath (DE); Peter LÖSEL, Leverkusen (DE)

(73) Assignee: BAYER CROPSCIENCE AG, MONHEIM (DE)

(21) Appl. No.: 13/172,121

(22) Filed: Jun. 29, 2011

Related U.S. Application Data
(60) Provisional application No. 61/360,086, filed on Jun. 30, 2010.

(30) Foreign Application Priority Data
Jun. 29, 2010 (EP) 10167799.5

(51) Int. Cl. A01N 43/76; A01N 43/836; A01P 9/00; A01P 7/00; A01P 5/00; A01N 43/78; A01P 7/04

(52) U.S. Cl. 514/340; 514/365

(57) ABSTRACT

Compositions comprising at least one cyclic carbonylamidine of the formula (I)

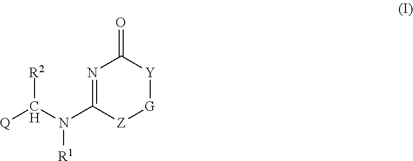

in which Y, G, Z, Q, R¹ and R² are as defined in the description and at least one activity enhancer selected from the group consisting of penetrants and ammonium or phosphonium salts of the formula (II)

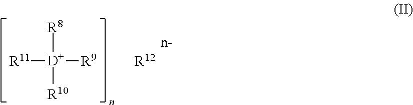

in which D, n, R⁸, R⁹, R¹⁰, R¹¹ and R¹² are as defined in the description.

### CROSS REFERENCE TO RELATED APPLICATIONS

This application claims priority to EP 10167799.5 filed Jun. 29, 2010 and U.S. Provisional Application No. 61/360,086 filed Jun. 30, 2010, the contents of which are incorporated herein by reference in their entireties.

### BACKGROUND

1. Field of the Invention

The present invention relates to insecticidal compositions comprising at least one cyclic carbonylamidine and at least one activity enhancer selected from the group consisting of ammonium or phosphonium salts and penetrants.

2. Description of Related Art

WO 2010/005692 discloses that certain cyclic carbonylamidines are biologically active and can be used for controlling insects. WO 2010/005692 also describes the preparation of such compounds. The activity of such compounds is good; however, in particular at low application rates and concentrations, it is not always entirely satisfactory.

In view of the constantly increasing environmental and economic demands imposed on modern crop protection compositions, in terms, for example, of selectivity and application rate, and in view of the fact, moreover, that problems with resistances, for example, may occur, a continual task is to develop novel crop protection compositions which, in certain areas at least, offer advantages over the known compositions.

Accordingly, it is an object of the present invention to provide an insecticidal composition which comprises certain cyclic carbonylamidines and has, compared to the known compositions, improved activity and/or a broader activity spectrum.

WO 95/017817 describes that the activity of certain agrochemically active compounds can be improved by addition of surfactants (detergents) comprising various nitrogenous compounds such as quarternary ammonium salts, betaines and amines. WO 95/017817 concerns the provision of optimized activity enhancers and describes compositions comprising at least one nitrogenous salt and a chelate former as particularly advantageous. The nitrogenous salt is preferably a nitrogenous detergent.

The use of nitrogenous or phosphorus-containing salts having relatively long alkyl and/or aryl substituents is also described in EP-A-0 453 086, EP-A-0 664 081, FR-A-2 600 494, U.S. Pat. No. 4,844,734B, U.S. Pat. No. 5,462,912B, U.S. Pat. No. 5,538,937B, US 2003/0224939A, US 2005/0009880A and/or US 2005/0096386A. These salts act as permeabilizers or increase the solubility of the active compound; or they act as a detergent.

U.S. Pat. No. 2,848,476B proposes the use of salts of sulphonic acids for enhancing (increasing) activity. The enhanced activity can be attributed to the fact that for their part the acids used have paralytic action on the insects.

The use of inorganic ammonium salts as formulation auxiliaries and activity enhancers in combination with certain herbicides is also known. WO 92/16108 describes the use of ammonium sulphate as formulation auxiliary in a granular formulation comprising insecticidally active phosphoramidothioates. WO 92/16108 describes that a certain amount of ammonium sulphate is required to ensure the chemical stability of granules comprising phosphoramidothioates. U.S. Pat. No. 6,645,914 B and EP-A-0 036 106 describe the activity enhancement for the herbicides glyphosate and phosphinothricin by addition of ammonium sulphate.

However, it is known that it is not possible to predict a general activity enhancement occurring on addition of known activity enhancers to agrochemically active compounds or classes of active compounds.

### SUMMARY

It has now been found that the activity of cyclic carbonylamidines of the formula (I) can be increased by addition of at least one activity enhancer selected from the group consisting of ammonium and/or phosphonium salts and penetrants.

Accordingly, the present invention provides a composition comprising at least one cyclic carbonylamidine of the formula (I)

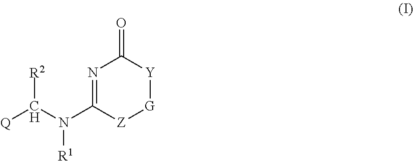

in which
Y represents O, S, NR⁵ or CR³R⁴; preferably, Y represents CH₂ or O;
G represents a saturated or unsaturated bond or represents CR³R⁴;
Z represents O, S, CR³R⁴ or NR⁵; preferably, Z represents CH₂;
R¹ represents hydrogen, C₁-C₃-alkoxy, C(O)R⁶ or SO₂R⁷, or represents one of the radicals below: C₁-C₄-alkyl, C₃-C₄-alkenyl, C₃-C₄-alkynyl, C₃-C₄-cycloalkyl, C₄-C₅-cycloalkylalkyl, C₄-C₅-alkylcycloalkyl or benzyl which are optionally substituted by 1 to 5 halogen atoms;
R² represents hydrogen or C₁-C₂-alkyl;
R³ and R⁴ independently of one another represent hydrogen or ethyl;
R⁵ represents hydrogen, C₁-C₂-alkyl or C₁-C₂-haloalkyl;
R⁶ represents C₁-C₂-alkyl or C₁-C₂-haloalkyl;
R⁷ represents C₁-C₂-alkyl or C₁-C₂-haloalkyl; and
Q represents a 5- or 6-membered unsaturated heterocyclic ring which contains as ring atoms at least one nitrogen atom and other ring atoms from the group consisting of carbon, oxygen and sulphur and which is optionally substituted by 1 to 3 substituents from the group consisting of halogen, cyano, nitro, and C₁-C₄-alkyl, C₁-C₄-alkoxy and C₁-C₄-alkylthio which for their part are optionally substituted by 1 to 5 fluorine atoms or chlorine atoms; or represents 3-tetrahydrofuranyl; preferably, Q represents a heterocyclic ring selected from the group consisting of pyridinyl, pyrimidinyl, pyridazinyl, pyrazinyl, pyrazolyl, oxazolyl, isoxazolyl, oxadiazolyl, thiadiazolyl, isothiazolyl, imidazolyl, pyrrolyl, thiazolyl and triazolyl which is optionally substituted by one or more substituents selected from the group consisting of halogen, cyano, nitro, and C₁-C₄-alkyl (for example methyl), C₁-C₄-alkoxy (for example methoxy) and C₁-C₄-alkylthio which for their part are each optionally substituted by fluorine or chlorine (for example trifluoromethyl); particularly preferably, Q represents 3-pyridinyl or 5-thiazolyl which are optionally substituted by one or more substituents selected from the group consisting of halogen, cyano, nitro, and C₁-C₄-alkyl (for example methyl), C₁-C₄-alkoxy (for example methoxy) and C₁-C₄-alkylthio which for their part are optionally substituted by fluorine or chlorine (for example trifluoromethyl); very particularly preferably, Q represents 6-fluoro-3-pyridinyl, 5,6-difluoro-3-pyridinyl, 5-chloro-6-fluoro-3-pyridinyl, 5-bromo-6-fluoro-3-pyridinyl, 6-chloro-3-pyridinyl, 5-fluoro-6-chloro-3-pyridinyl, 5,6-dichloro-3-pyridinyl, 5-bromo-6-chloro-3-pyridinyl, 6-bromo-3-pyridinyl, 5-fluoro-6-bromo-3-pyridinyl, 5-chloro-6-bromo-3-pyridinyl, 5,6-dibromo-3-pyridinyl, 6-trifluoromethyl-3-pyridinyl, or 2-chloro-5-thiazolyl;
   and at least one activity enhancer selected from the group consisting of penetrants (in particular alkanol alkoxylates of the formula (III) as defined below and/or mineral or vegetable oils and modifications thereof) and ammonium or phosphonium salts of the formula (II)

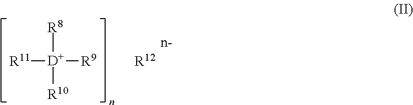

in which
D represents nitrogen or phosphorus; preferably, D represents nitrogen;
n represents 1, 2, 3 or 4; preferably, n represents 1 or 2;
R⁸, R⁹, R¹⁰ and R¹¹ independently of one another represent hydrogen or in each case optionally substituted C₁-C₈-alkyl or mono- or polyunsaturated, optionally substituted C₂-C₈-alkenyl, where the substituents may be selected from the group consisting of halogen, nitro and cyano; preferably, R⁸, R⁹, R¹⁰ and R¹¹ independently of one another represent hydrogen or in each case optionally substituted C₁-C₄-alkyl, where the substituents are selected from the group consisting of halogen, nitro and cyano; particularly preferably, R⁸, R⁹, R¹⁰ and R¹¹ independently of one another represent hydrogen, methyl, ethyl, n-propyl, isopropyl, n-butyl, isobutyl, sec-butyl or tert-butyl; very particularly preferably, R⁸, R⁹, R¹⁰ and R¹¹ independently of one another represent hydrogen, methyl or ethyl;
R¹² represents an inorganic or organic anion; preferably, R¹² represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate; R¹² furthermore preferably represents carbonate, pentaborate, sulphite, benzoate, hydrogenoxalate, hydrogencitrate, methylsulphate or tetrafluoroborate; particularly preferably, R¹² represents lactate, sulphate, nitrate, thiosulphate, thiocyanate, citrate, oxalate, formate, monohydrogenphosphate or dihydrogenphosphate; particularly preferably, R¹² represents monohydrogenphosphate, dihydrogenphosphate or sulphate.

### DETAILED DESCRIPTION OF A PREFERRED EMBODIMENT

Examples of the ammonium salts of the formula (II) mentioned above are ammonium sulphate, ammonium lactate, ammonium nitrate, ammonium thiosulphate, ammonium thiocyanate, ammonium citrate, ammonium oxalate, ammonium formate, ammonium hydrogenphosphate, ammonium dihydrogenphosphate, ammonium carbonate, ammonium benzoate, ammonium sulphite, ammonium benzoate, ammonium hydrogenoxalate, ammonium hydrogencitrate, ammonium acetate, tetramethylammonium sulphate, tetramethylammonium lactate, tetramethylammonium nitrate, tetramethylammonium thiosulphate, tetramethylammonium thiocyanate, tetramethylammonium citrate, tetramethylammonium oxalate, tetramethylammonium formate, tetramethylammonium hydrogenphosphate, tetramethylammonium dihydrogenphosphate, tetraethylammonium sulphate, tetraethylammonium lactate, tetraethylammonium nitrate, tetraethylammonium thiosulphate, tetraethylammonium thiocyanate, tetraethylammonium citrate, tetraethylammonium oxalate, tetraethylammonium formate, tetraethylammonium hydrogenphosphate, and tetraethylammonium dihydrogenphosphate.

In a first embodiment, the invention relates to a composition as defined above which comprises at least one cyclic carbonylamidine of the formula (Ia)

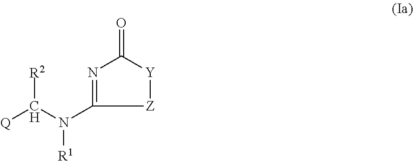

in which
Y-Z represents a grouping O—CR³R⁴ (in particular O—CH₂), S—CR³R⁴, NR⁵—CR³R⁴ or CR³R⁴—O (in particular CH₂—O), O—NR⁵;
R¹ represents hydrogen or C₁-C₃-alkoxy, C₁-C₄-alkyl, C₃-C₄-alkenyl, C₃-C₄-alkynyl, C₃-C₄-cycloalkyl, C₄-C₅-cycloalkylalkyl or C₄-C₅-alkylcycloalkyl, which are optionally substituted by halogen; preferably, R¹ represents hydrogen, CH₂—CF₃, or represents methyl, ethyl, n-, isopropyl, or cyclopropyl which are optionally substituted by halogen;
R² represents hydrogen, methyl, or ethyl; preferably, R² represents hydrogen or methyl;
R³ and R⁴ independently of one another represent hydrogen or methyl,
R⁵ represents hydrogen, C₁-C₂-alkyl or C₁-C₂-haloalkyl,
Q represents a 5- or 6-membered unsaturated heterocyclic ring which contains as ring atoms at least one nitrogen atom and other ring atoms from the group consisting of carbon, oxygen and sulphur and which is optionally substituted by 1 to 3 substituents from the group consisting of halogen, cyano, nitro, and C₁-C₄-alkyl, C₁-C₄-alkoxy and C₁-C₄-alkylthio which for their part are optionally substituted by 1 to 5 fluorine atoms or chlorine atoms; or represents 3-tetrahydrofuranyl; preferably, Q represents a heterocyclic ring selected from the group consisting of pyridinyl, pyrimidinyl, pyridazinyl, pyrazinyl, pyrazolyl, oxazolyl, isoxazolyl, oxadiazolyl, thiadiazolyl, isothiazolyl, imidazolyl, pyrrolyl, thiazolyl and triazolyl which is optionally substituted by one or more substituents selected from the group consisting of halogen, cyano, nitro, and C₁-C₄-alkyl (for example methyl), C₁-C₄-alkoxy (for example methoxy) and C₁-C₄-alkylthio which for their part are each optionally substituted by fluorine or chlorine (for example trifluoromethyl); particularly preferably, Q represents 3-pyridinyl or 5-thiazolyl which are optionally substituted by one or more substituents selected from the group consisting of halogen, cyano, nitro, and C₁-C₄-alkyl (for example methyl), C₁-C₄-alkoxy (for example methoxy) and C₁-C₄-alkylthio which for their part are optionally substituted by fluorine or chlorine (for example trifluoromethyl); very particularly preferably, Q represents 6-fluoro-3-pyridinyl, 5,6-difluoro-3-pyridinyl, 5-chloro-6-fluoro-3-pyridinyl, 5-bromo-6-fluoro-3-pyridinyl, 6-chloro-3-pyridinyl, 5-fluoro-6-chloro-3-pyridinyl, 5,6-dichloro-3-pyridinyl, 5-bromo-6-chloro-3-pyridinyl, 6-bromo-3-pyridinyl, 5-fluoro-6-bromo-3-pyridinyl, 5-chloro-6-bromo-3-pyridinyl, 5,6-dibromo-3-pyridinyl, 6-trifluoromethyl-3-pyridinyl, or 2-chloro-5-thiazolyl.

In a second embodiment, the invention relates to a composition as defined above which comprises at least one cyclic carbonylamidine selected from among the compounds (I-1) to (I-42)
(I-1), 4-[[(6-chloro-3-pyridinyl)methyl]methylamino]-2(5H)-oxazolone,
(I-2), 4-[[(6-chloro-3-pyridinyl)methyl]ethylamino]-2(5H)-oxazolone,
(I-3), 4-[[(6-chloro-3-pyridinyl)methyl]-2-fluoroethylamino]-2(5H)-oxazolone,
(I-4), 4-[[(6-chloro-3-pyridinyl)methyl]-2,2-difluoroethylamino]-2(5H)-oxazolone,
(I-5), 4-[[(6-chloro-3-pyridinyl)methyl]-2,2,2-trifluoroethylamino]-2(5H)-oxazolone,
(I-6), 4-[[(6-chloro-3-pyridinyl)methyl]cyclopropylamino]-2(5H)-oxazolone,
(I-7), 4-[[(6-chloro-3-pyridinyl)methyl]methoxyamino]-2(5H)-oxazolone,
(I-8), 4-[[(6-fluoro-3-pyridinyl)methyl]methylamino]-2(5H)-oxazolone,
(I-9), 4-[[(6-fluoro-3-pyridinyl)methyl]ethylamino]-2(5H)-oxazolone,
(I-10), 4-[[(6-fluoro-3-pyridinyl)methyl]-2-fluoroethylamino]-2(5H)-oxazolone,
(I-11), 4-[[(6-fluoro-3-pyridinyl)methyl]-2,2-difluoroethylamino]-2(5H)-oxazolone,
(I-12), 4-[[(6-fluoro-3-pyridinyl)methyl]-2,2,2-trifluoroethylamino]-2(5H)-oxazolone,
(I-13), 4-[[(6-fluoro-3-pyridinyl)methyl]cyclopropylamino]-2(5H)-oxazolone,
(I-14), 4-[[(6-fluoro-3-pyridinyl)methyl]methoxyamino]-2(5H)-oxazolone,
(I-15), 4-[[(6-bromo-3-pyridinyl)methyl]methylamino]-2(5H)-oxazolone,
(I-16), 4-[[(6-bromo-3-pyridinyl)methyl]ethylamino]-2(5H)-oxazolone,
(I-17), 4-[[(6-bromo-3-pyridinyl)methyl]-2-fluoroethylamino]-2(5H)-oxazolone,
(I-18), 4-[[(6-bromo-3-pyridinyl)methyl]-2,2-difluoroethylamino]-2(5H)-oxazolone,
(I-19), 4-[[(6-bromo-3-pyridinyl)methyl]-2,2,2-trifluoroethylamino]-2(5H)-oxazolone,
(I-20), 4-[[(6-bromo-3-pyridinyl)methyl]cyclopropylamino]-2(5H)-oxazolone,
(I-21), 4-[[(6-bromo-3-pyridinyl)methyl]methoxyamino]-2(5H)-oxazolone,
(I-22), 4-[[(5,6-dichloro-3-pyridinyl)methyl]methylamino]-2(5H)-oxazolone,
(I-23), 4-[[(5,6-dichloro-3-pyridinyl)methyl]ethylamino]-2(5H)-oxazolone,
(I-24), 4-[[(5,6-dichloro-3-pyridinyl)methyl]-2-fluoroethylamino]-2(5H)-oxazolone,
(I-25), 4-[[(5,6-dichloro-3-pyridinyl)methyl]-2,2-difluoroethylamino]-2(5H)-oxazolone,
(I-26), 4-[[(5,6-dichloro-3-pyridinyl)methyl]-2,2,2-trifluoroethylamino]-2(5H)-oxazolone,
(I-27), 4-[[(5,6-dichloro-3-pyridinyl)methyl]cyclopropylamino]-2(5H)-oxazolone,
(I-28), 4-[[(5,6-dichloro-3-pyridinyl)methyl]methoxyamino]-2(5H)-oxazolone,
(I-29), 4-[[(2-chloro-5-thiazolyl)methyl]methylamino]-2(5H)-oxazolone,
(I-30), 4-[[(2-chloro-5-thiazolyl)methyl]ethylamino]-2(5H)-oxazolone,
(I-31), 4-[[(2-chloro-5-thiazolyl)methyl]-2-fluoroethylamino]-2(5H)-oxazolone,
(I-32), 4-[[(2-chloro-5-thiazolyl)methyl]-2,2-difluoroethylamino]-2(5H)-oxazolone,
(I-33), 4-[[(2-chloro-5-thiazolyl)methyl]-2,2,2-trifluoroethylamino]-2(5H)-oxazolone,
(I-34), 4-[[(2-chloro-5-thiazolyl)methyl]cyclopropylamino]-2(5H)-oxazolone,
(I-35), 4-[[(2-chloro-5-thiazolyl)methyl]methoxyamino]-2(5H)-oxazolone,
(I-36), 3-[[(6-chloro-3-pyridinyl)methyl]methylamino]-2-methyl-1,2,4-oxadiazol-5(2H)-one,
(I-37), 3-[[(6-chloro-3-pyridinyl)methyl]ethylamino]-2-methyl-1,2,4-oxadiazol-5(2H)-one,
(I-38), 3-[[(6-chloro-3-pyridinyl)methyl]-2-fluoroethylamino]-2-methyl-1,2,4-oxadiazol-5 (2H)-one,
(I-39), 3-[[(6-chloro-3-pyridinyl)methyl]-2,2-difluoroethylamino]-2-methyl-1,2,4-oxadiazol-5(2H)-one,
(I-40), 3-[[(6-chloro-3-pyridinyl)methyl]-2,2,2-trifluoroethylamino]-2-methyl-1,2,4-oxadiazol-5(2H)-one,
(I-41), 3-[[(6-chloro-3-pyridinyl)methyl]cyclopropylamino]-2-methyl-1,2,4-oxadiazol-5(2H)-one, and
(I-42), 3-[[(6-chloro-3-pyridinyl)methyl]methoxyamino]-2-methyl-1,2,4-oxadiazol-5(2H)-one.

The present invention furthermore provides a composition as defined above which comprises at least one cyclic carbonylamidine of the formula (I) in which
Y represents CR³R⁴, G represents a saturated or unsaturated bond, and Z represents O or S, where the radicals R¹ to R⁴ and Q have the meanings given above.

The present invention furthermore provides a composition as defined above which comprises at least one cyclic carbonylamidine of the formula (I) in which
Y represents O, and G represents a double bond or represents CR³R⁴; CH═CH, where the radicals R¹, R² and Q have the meanings given above.

The present invention furthermore provides a composition as defined above which comprises at least one cyclic carbonylamidine of the formula (I) in which
Y represents O, S, NR⁵ or CR³R⁴, G represents CR³R⁴, and Z represents O, S, NR⁵ or CR³R⁴, where the radicals R¹ to R⁵ and Q have the meanings given above.

The present invention furthermore provides a composition as defined above which comprises at least one cyclic carbonylamidine of the formula (I) in which
Y-G represents CH═CH, and Z represents O, S or NR⁵; where the radicals R¹, R², R⁵ and Q have the meanings given above.

The present invention also provides the use of the activity enhancers according to the invention, i.e. the ammonium and/or phosphonium salts according to the invention, if appropriate in combination with the penetrant according to the invention, for enhancing (increasing) the activity of the carbonylamidines according to the invention.

The activity enhancers can be added to the application solution comprising the active compounds according to the invention (tank-mix application) or be incorporated into a formulation comprising the active compounds according to the invention (formulated product).

The invention thus also provides formulated insecticidal compositions and ready-to-use crop protection compositions (for example spray liquor). Finally, the invention also provides the use of the compositions according to the invention for controlling harmful insects (plant pests) encountered in agriculture.

In the compositions according to the invention, the active compounds can be employed in a broad concentration range. Here, the concentration of the active compounds in the composition is usually 0.1-50% by weight.

In the compositions according to the invention, the ammonium or phosphonium salts of the formula (II) according to the invention can be employed in a broad concentration range.

The ammonium or phosphonium salts according to the invention are added to the composition at such a concentration that they are present in the ready-to-use crop protection composition (in the spray liquor or in tank-mix application) at a concentration of from 0.5 to 80 mmol/l, preferably from 0.75 to 37.5 mmol/l, particularly preferably from 1.5 to 25 mmol/1.

In the case of a formulated product, the ammonium and/or phosphonium salt concentration in the formulation is chosen such that, after dilution of the formulation to the desired active compound concentration, it is in the ranges mentioned above. Here, the concentration of the salt in the formulation is usually 1-50% by weight.

In a preferred embodiment, the composition according to the invention comprises, as activity enhancer, an ammonium and/or phosphonium salt according to the invention and a penetrant according to the invention (in particular alkanol alkoxylates of the formula (III) as defined herein and/or mineral or vegetable oils and modifications thereof).

It has been found that by combining ammonium and phosphonium salts according to the invention and a penetrant according to the invention the activity of the cyclic carbonylamidine is increased to such an extent that it is active even at concentrations so low that without addition of the combination an activity can no longer be found.

Penetrants according to the invention are substances which are usually employed to facilitate the penetration of agrochemically active compounds into plants by penetrating from the appropriate use form (in particular aqueous spray liquor) and/or from the spray coating into the cuticles of the plant, thus increasing the mobility of active compounds in the cuticles. The method described in the literature can be used to determine this property (Baur et al., 1997, Pesticide Science 51, 131-152).

Suitable penetrants according to the invention also include substances which promote the solubility of the compounds according to the invention in the spray liquor. These include, for example, mineral or vegetable oils (oils of vegetable origin, plant oils). Suitable oils are all mineral or vegetable oils—if appropriate modified—customarily used in agrochemical compositions. Sunflower oil, rapeseed oil, olive oil, castor oil, colza oil, corn oil, cottonseed oil and soya bean oil and esters thereof (preferably methyl or ethyl esters) may be mentioned by way of example. Preferred oils are rapeseed oil, sunflower oil and their methyl or ethyl esters (for example rapeseed oil methyl ester).

Penetrants which are suitable according to the invention also include alkanol alkoxylates of the formula (III)

R—O-(AO)_{V}—R′ (III)

in which
R represents straight-chain or branched C₁-C₂₀-alkyl; R preferably represents butyl, isobutyl, n-pentyl, isopentyl, neopentyl, n-hexyl, isohexyl, n-octyl, isooctyl, 2-ethylhexyl, nonyl, isononyl, decyl, n-dodecyl, isododecyl, lauryl, myristyl, isotridecyl, trimethylnonyl, palmityl, stearyl or eicosyl;
R′ represents hydrogen, methyl, ethyl, n-propyl, isopropyl, n-butyl, isobutyl, tert-butyl, n-pentyl or n-hexyl;
AO represents an ethylene oxide radical, a propylene oxide radical, a butylene oxide radical or represents mixtures of ethylene oxide and propylene oxide radicals or butylene oxide radicals; and
v represents a number from 2 to 30.

Penetrants which are suitable according to the invention are in particular alkanol alkoxylates of the formula (IIIa), (IIIb) or (IIIc)

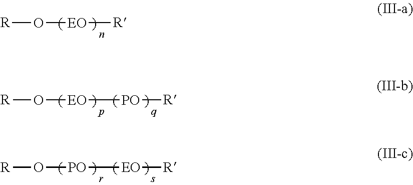

in which
R and R′ have the meanings given above;
EO represents a grouping —CH₂—CH₂—O—;
n represents a number from 2 to 20;
PO represents

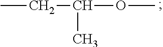

p, q, r, and s each independently of one another represent a number from 1 to 10.

Further penetrants which are suitable according to the invention are in particular alkanol alkoxylate of the formula (III-d)

R—O—(-EO—)ₚ—(—BO—)_{q}—R′ (III-d)

in which
R and R′ have the meanings given above;
EO represents CH₂—CH₂—O—;
BO represents

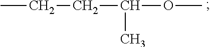

p and q each independently of one another represent a number from 1 to 10.

Further penetrants which are suitable according to the invention are in particular alkanol alkoxylate of the formula (III-e)

R—O—(—BO—)ᵣ-(-EO—)ₛ—R′ (III-e)

in which
R and R′ have the meanings given above;
BO represents

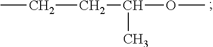

EO represents CH₂—CH₂—O—;
r and s each independently of one another represent a number from 1 to 10.

Further penetrants which are suitable according to the invention are in particular alkanol alkoxylate of the formula (III-f)

CH₃—(CH₂)ₜ—CH₂—O—(—CH₂—CH₂—O—)ᵤ—R′ (III-f)

in which
R′ has the meaning given above;
t represents a number from 8 to 13; preferably, t represents a number from 9 to 12; and
u represents a number from 6 to 17; preferably, u represents a number from 7 to 9.

Preference is given to an alkanol alkoxylate of the formula (III-f-1)

CH₃—(CH₂)ₜ—CH₂—O—(—CH₂—CH₂—O—)ᵤ—H (III-f-1)

in which t represents an average value of 10.5; and u represents an average value of 8.4.

An example of an alkanol alkoxylate of the formula (III-c) is a 2-ethylhexyl alkoxylate of the formula (III-c-1)

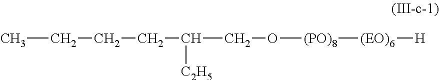

in which EO represents —CH₂—CH₂—O—; PO represents

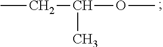

and
the numbers 8 and 6 represent average values.

An example of an alkanol alkoxylate of the formula (III-d) is a compound of the formula (III-d-1)

CH₃—(CH₂)₁₀—O—(-EO-)₆—(—BO—)₂—CH₃ (III-d-1)

in which EO represents CH₂—CH₂—O—; BO represents

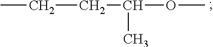

and
the numbers 10, 6 and 2 represent average values.

The formulae above provide general definitions of the alkanol alkoxylates. These substances are mixtures of substances of the type indicated having different chain lengths. Accordingly, average values which may not be integers are calculated for the indices.

The alkanol alkoxylates of the formulae indicated are known, and some are commercially available or can be prepared by known methods (cf. WO 98/035553, WO00/35278 and EP-A 0 681 865).

The concentration of penetrants in the compositions according to the invention can be varied within a wide range.

In a formulated crop protection composition, it is generally from 1 to 95% by weight, preferably from 1 to 55% by weight, particularly preferably from 15 to 40% by weight. In the ready-to-use compositions (for example spray liquors) the concentration is generally between 0.1 and 10 g/l, preferably between 0.5 and 5 g/1.

Combinations emphasized according to the invention of active compound, salt and penetrant are listed in the table below. Here, “penetrant as per test” means that all the compounds which act as a penetrant in the cuticle penetration test according to Baur et al., 1997, Pesticide Science 51, 131-152 are suitable.

| | Active | | |
|---|---|---|---|
| | com- | | |
| # | pound | Salt | Penetrant |
| 1 | (I-1) | ammonium sulphate | as per test |
| 2 | (I-1) | ammonium lactate | as per test |
| 3 | (I-1) | ammonium nitrate | as per test |
| 4 | (I-1) | ammonium thiosulphate | as per test |
| 5 | (I-1) | ammonium thiocyanate | as per test |
| 6 | (I-1) | ammonium citrate | as per test |
| 7 | (I-1) | ammonium oxalate | as per test |
| 8 | (I-1) | ammonium formate | as per test |
| 9 | (I-1) | ammonium hydrogenphosphate | as per test |
| 10 | (I-1) | ammonium dihydrogenphosphate | as per test |
| 11 | (I-1) | ammonium carbonate | as per test |
| 12 | (I-1) | ammonium benzoate | as per test |
| 13 | (I-1) | ammonium sulphite | as per test |
| 14 | (I-1) | ammonium benzoate | as per test |
| 15 | (I-1) | ammonium hydrogenoxalate | as per test |
| 16 | (I-1) | ammonium hydrogencitrate | as per test |
| 17 | (I-1) | ammonium acetate | as per test |
| 18 | (I-1) | tetramethylammonium sulphate | as per test |
| 19 | (I-1) | tetramethylammonium lactate | as per test |
| 20 | (I-1) | tetramethylammonium nitrate | as per test |
| 21 | (I-1) | tetramethylammonium thiosulphate | as per test |
| 22 | (I-1) | tetramethylammonium thiocyanate | as per test |
| 23 | (I-1) | tetramethylammonium citrate | as per test |
| 24 | (I-1) | tetramethylammonium oxalate | as per test |
| 25 | (I-1) | tetramethylammonium formate | as per test |
| 26 | (I-1) | tetramethylammonium hydrogenphosphate | as per test |
| 27 | (I-1) | tetramethylammonium dihydrogenphosphate | as per test |
| 28 | (I-1) | tetraethylammonium sulphate | as per test |
| 29 | (I-1) | tetraethylammonium lactate | as per test |
| 30 | (I-1) | tetraethylammonium nitrate | as per test |
| 31 | (I-1) | tetraethylammonium thiosulphate | as per test |
| 32 | (I-1) | tetraethylammonium thiocyanate | as per test |
| 33 | (I-1) | tetraethylammonium citrate | as per test |
| 34 | (I-1) | tetraethylammonium oxalate | as per test |
| 35 | (I-1) | tetraethylammonium formate | as per test |
| 36 | (I-1) | tetraethylammonium hydrogenphosphate | as per test |
| 37 | (I-1) | tetraethylammonium dihydrogenphosphate | as per test |
| 38 | (I-2) | ammonium sulphate | as per test |
| 39 | (I-2) | ammonium lactate | as per test |
| 40 | (I-2) | ammonium nitrate | as per test |
| 41 | (I-2) | ammonium thiosulphate | as per test |
| 42 | (I-2) | ammonium thiocyanate | as per test |
| 43 | (I-2) | ammonium citrate | as per test |
| 44 | (I-2) | ammonium oxalate | as per test |
| 45 | (I-2) | ammonium formate | as per test |
| 46 | (I-2) | ammonium hydrogenphosphate | as per test |
| 47 | (I-2) | ammonium dihydrogenphosphate | as per test |
| 48 | (I-2) | ammonium carbonate | as per test |
| 49 | (I-2) | ammonium benzoate | as per test |
| 50 | (I-2) | ammonium sulphite | as per test |
| 51 | (I-2) | ammonium benzoate | as per test |
| 52 | (I-2) | ammonium hydrogenoxalate | as per test |
| 53 | (I-2) | ammonium hydrogencitrate | as per test |
| 54 | (I-2) | ammonium acetate | as per test |
| 55 | (I-2) | tetramethylammonium sulphate | as per test |
| 56 | (I-2) | tetramethylammonium lactate | as per test |
| 57 | (I-2) | tetramethylammonium nitrate | as per test |
| 58 | (I-2) | tetramethylammonium thiosulphate | as per test |
| 59 | (I-2) | tetramethylammonium thiocyanate | as per test |
| 60 | (I-2) | tetramethylammonium citrate | as per test |
| 61 | (I-2) | tetramethylammonium oxalate | as per test |
| 62 | (I-2) | tetramethylammonium formate | as per test |
| 63 | (I-2) | tetramethylammonium hydrogenphosphate | as per test |
| 64 | (I-2) | tetramethylammonium dihydrogenphosphate | as per test |
| 65 | (I-2) | tetraethylammonium sulphate | as per test |
| 66 | (I-2) | tetraethylammonium lactate | as per test |
| 67 | (I-2) | tetraethylammonium nitrate | as per test |
| 68 | (I-2) | tetraethylammonium thiosulphate | as per test |
| 69 | (I-2) | tetraethylammonium thiocyanate | as per test |
| 70 | (I-2) | tetraethylammonium citrate | as per test |
| 71 | (I-2) | tetraethylammonium oxalate | as per test |
| 72 | (I-2) | tetraethylammonium formate | as per test |
| 73 | (I-2) | tetraethylammonium hydrogenphosphate | as per test |
| 74 | (I-2) | tetraethylammonium dihydrogenphosphate | as per test |
| 75 | (I-3) | ammonium sulphate | as per test |
| 76 | (I-3) | ammonium lactate | as per test |
| 77 | (I-3) | ammonium nitrate | as per test |
| 78 | (I-3) | ammonium thiosulphate | as per test |
| 79 | (I-3) | ammonium thiocyanate | as per test |
| 80 | (I-3) | ammonium citrate | as per test |
| 81 | (I-3) | ammonium oxalate | as per test |
| 82 | (I-3) | ammonium formate | as per test |
| 83 | (I-3) | ammonium hydrogenphosphate | as per test |
| 84 | (I-3) | ammonium dihydrogenphosphate | as per test |
| 85 | (I-3) | ammonium carbonate | as per test |
| 86 | (I-3) | ammonium benzoate | as per test |
| 87 | (I-3) | ammonium sulphite | as per test |
| 88 | (I-3) | ammonium benzoate | as per test |
| 89 | (I-3) | ammonium hydrogenoxalate | as per test |
| 90 | (I-3) | ammonium hydrogencitrate | as per test |
| 91 | (I-3) | ammonium acetate | as per test |
| 92 | (I-3) | tetramethylammonium sulphate | as per test |
| 93 | (I-3) | tetramethylammonium lactate | as per test |
| 94 | (I-3) | tetramethylammonium nitrate | as per test |
| 95 | (I-3) | tetramethylammonium thiosulphate | as per test |
| 96 | (I-3) | tetramethylammonium thiocyanate | as per test |
| 97 | (I-3) | tetramethylammonium citrate | as per test |
| 98 | (I-3) | tetramethylammonium oxalate | as per test |
| 99 | (I-3) | tetramethylammonium formate | as per test |
| 100 | (I-3) | tetramethylammonium hydrogenphosphate | as per test |
| 101 | (I-3) | tetramethylammonium dihydrogenphosphate | as per test |
| 102 | (I-3) | tetraethylammonium sulphate | as per test |
| 103 | (I-3) | tetraethylammonium lactate | as per test |
| 104 | (I-3) | tetraethylammonium nitrate | as per test |
| 105 | (I-3) | tetraethylammonium thiosulphate | as per test |
| 106 | (I-3) | tetraethylammonium thiocyanate | as per test |
| 107 | (I-3) | tetraethylammonium citrate | as per test |
| 108 | (I-3) | tetraethylammonium oxalate | as per test |
| 109 | (I-3) | tetraethylammonium formate | as per test |
| 110 | (I-3) | tetraethylammonium hydrogenphosphate | as per test |
| 111 | (I-3) | tetraethylammonium dihydrogenphosphate | as per test |
| 112 | (I-4) | ammonium sulphate | as per test |
| 113 | (I-4) | ammonium lactate | as per test |
| 114 | (I-4) | ammonium nitrate | as per test |
| 115 | (I-4) | ammonium thiosulphate | as per test |
| 116 | (I-4) | ammonium thiocyanate | as per test |
| 117 | (I-4) | ammonium citrate | as per test |
| 118 | (I-4) | ammonium oxalate | as per test |
| 119 | (I-4) | ammonium formate | as per test |
| 120 | (I-4) | ammonium hydrogenphosphate | as per test |
| 121 | (I-4) | ammonium dihydrogenphosphate | as per test |
| 122 | (I-4) | ammonium carbonate | as per test |
| 123 | (I-4) | ammonium benzoate | as per test |
| 124 | (I-4) | ammonium sulphite | as per test |
| 125 | (I-4) | ammonium benzoate | as per test |
| 126 | (I-4) | ammonium hydrogenoxalate | as per test |
| 127 | (I-4) | ammonium hydrogencitrate | as per test |
| 128 | (I-4) | ammonium acetate | as per test |
| 129 | (I-4) | tetramethylammonium sulphate | as per test |
| 130 | (I-4) | tetramethylammonium lactate | as per test |
| 131 | (I-4) | tetramethylammonium nitrate | as per test |
| 132 | (I-4) | tetramethylammonium thiosulphate | as per test |
| 133 | (I-4) | tetramethylammonium thiocyanate | as per test |
| 134 | (I-4) | tetramethylammonium citrate | as per test |
| 135 | (I-4) | tetramethylammonium oxalate | as per test |
| 136 | (I-4) | tetramethylammonium formate | as per test |
| 137 | (I-4) | tetramethylammonium hydrogenphosphate | as per test |
| 138 | (I-4) | tetramethylammonium dihydrogenphosphate | as per test |
| 139 | (I-4) | tetraethylammonium sulphate | as per test |
| 140 | (I-4) | tetraethylammonium lactate | as per test |
| 141 | (I-4) | tetraethylammonium nitrate | as per test |
| 142 | (I-4) | tetraethylammonium thiosulphate | as per test |
| 143 | (I-4) | tetraethylammonium thiocyanate | as per test |
| 144 | (I-4) | tetraethylammonium citrate | as per test |
| 145 | (I-4) | tetraethylammonium oxalate | as per test |
| 146 | (I-4) | tetraethylammonium formate | as per test |
| 147 | (I-4) | tetraethylammonium hydrogenphosphate | as per test |
| 148 | (I-4) | tetraethylammonium dihydrogenphosphate | as per test |
| 149 | (I-5) | ammonium sulphate | as per test |
| 150 | (I-5) | ammonium lactate | as per test |
| 151 | (I-5) | ammonium nitrate | as per test |
| 152 | (I-5) | ammonium thiosulphate | as per test |
| 153 | (I-5) | ammonium thiocyanate | as per test |
| 154 | (I-5) | ammonium citrate | as per test |
| 155 | (I-5) | ammonium oxalate | as per test |
| 156 | (I-5) | ammonium formate | as per test |
| 157 | (I-5) | ammonium hydrogenphosphate | as per test |
| 158 | (I-5) | ammonium dihydrogenphosphate | as per test |
| 159 | (I-5) | ammonium carbonate | as per test |
| 160 | (I-5) | ammonium benzoate | as per test |
| 161 | (I-5) | ammonium sulphite | as per test |
| 162 | (I-5) | ammonium benzoate | as per test |
| 163 | (I-5) | ammonium hydrogenoxalate | as per test |
| 164 | (I-5) | ammonium hydrogencitrate | as per test |
| 165 | (I-5) | ammonium acetate | as per test |
| 166 | (I-5) | tetramethylammonium sulphate | as per test |
| 167 | (I-5) | tetramethylammonium lactate | as per test |
| 168 | (I-5) | tetramethylammonium nitrate | as per test |
| 169 | (I-5) | tetramethylammonium thiosulphate | as per test |
| 170 | (I-5) | tetramethylammonium thiocyanate | as per test |
| 171 | (I-5) | tetramethylammonium citrate | as per test |
| 172 | (I-5) | tetramethylammonium oxalate | as per test |
| 173 | (I-5) | tetramethylammonium formate | as per test |
| 174 | (I-5) | tetramethylammonium hydrogenphosphate | as per test |
| 175 | (I-5) | tetramethylammonium dihydrogenphosphate | as per test |
| 176 | (I-5) | tetraethylammonium sulphate | as per test |
| 177 | (I-5) | tetraethylammonium lactate | as per test |
| 178 | (I-5) | tetraethylammonium nitrate | as per test |
| 179 | (I-5) | tetraethylammonium thiosulphate | as per test |
| 180 | (I-5) | tetraethylammonium thiocyanate | as per test |
| 181 | (I-5) | tetraethylammonium citrate | as per test |
| 182 | (I-5) | tetraethylammonium oxalate | as per test |
| 183 | (I-5) | tetraethylammonium formate | as per test |
| 184 | (I-5) | tetraethylammonium hydrogenphosphate | as per test |
| 185 | (I-5) | tetraethylammonium dihydrogenphosphate | as per test |
| 186 | (I-6) | ammonium sulphate | as per test |
| 187 | (I-6) | ammonium lactate | as per test |
| 188 | (I-6) | ammonium nitrate | as per test |
| 189 | (I-6) | ammonium thiosulphate | as per test |
| 190 | (I-6) | ammonium thiocyanate | as per test |
| 191 | (I-6) | ammonium citrate | as per test |
| 192 | (I-6) | ammonium oxalate | as per test |
| 193 | (I-6) | ammonium formate | as per test |
| 194 | (I-6) | ammonium hydrogenphosphate | as per test |
| 195 | (I-6) | ammonium dihydrogenphosphate | as per test |
| 196 | (I-6) | ammonium carbonate | as per test |
| 197 | (I-6) | ammonium benzoate | as per test |
| 198 | (I-6) | ammonium sulphite | as per test |
| 199 | (I-6) | ammonium benzoate | as per test |
| 200 | (I-6) | ammonium hydrogenoxalate | as per test |
| 201 | (I-6) | ammonium hydrogencitrate | as per test |
| 202 | (I-6) | ammonium acetate | as per test |
| 203 | (I-6) | tetramethylammonium sulphate | as per test |
| 204 | (I-6) | tetramethylammonium lactate | as per test |
| 205 | (I-6) | tetramethylammonium nitrate | as per test |
| 206 | (I-6) | tetramethylammonium thiosulphate | as per test |
| 207 | (I-6) | tetramethylammonium thiocyanate | as per test |
| 208 | (I-6) | tetramethylammonium citrate | as per test |
| 209 | (I-6) | tetramethylammonium oxalate | as per test |
| 210 | (I-6) | tetramethylammonium formate | as per test |
| 211 | (I-6) | tetramethylammonium hydrogenphosphate | as per test |
| 212 | (I-6) | tetramethylammonium dihydrogenphosphate | as per test |
| 213 | (I-6) | tetraethylammonium sulphate | as per test |
| 214 | (I-6) | tetraethylammonium lactate | as per test |
| 215 | (I-6) | tetraethylammonium nitrate | as per test |
| 216 | (I-6) | tetraethylammonium thiosulphate | as per test |
| 217 | (I-6) | tetraethylammonium thiocyanate | as per test |
| 218 | (I-6) | tetraethylammonium citrate | as per test |
| 219 | (I-6) | tetraethylammonium oxalate | as per test |
| 220 | (I-6) | tetraethylammonium formate | as per test |
| 221 | (I-6) | tetraethylammonium hydrogenphosphate | as per test |
| 222 | (I-6) | tetraethylammonium dihydrogenphosphate | as per test |
| 223 | (I-7) | ammonium sulphate | as per test |
| 224 | (I-7) | ammonium lactate | as per test |
| 225 | (I-7) | ammonium nitrate | as per test |
| 226 | (I-7) | ammonium thiosulphate | as per test |
| 227 | (I-7) | ammonium thiocyanate | as per test |
| 228 | (I-7) | ammonium citrate | as per test |
| 229 | (I-7) | ammonium oxalate | as per test |
| 230 | (I-7) | ammonium formate | as per test |
| 231 | (I-7) | ammonium hydrogenphosphate | as per test |
| 232 | (I-7) | ammonium dihydrogenphosphate | as per test |
| 233 | (I-7) | ammonium carbonate | as per test |
| 234 | (I-7) | ammonium benzoate | as per test |
| 235 | (I-7) | ammonium sulphite | as per test |
| 236 | (I-7) | ammonium benzoate | as per test |
| 237 | (I-7) | ammonium hydrogenoxalate | as per test |
| 238 | (I-7) | ammonium hydrogencitrate | as per test |
| 239 | (I-7) | ammonium acetate | as per test |
| 240 | (I-7) | tetramethylammonium sulphate | as per test |
| 241 | (I-7) | tetramethylammonium lactate | as per test |
| 242 | (I-7) | tetramethylammonium nitrate | as per test |
| 243 | (I-7) | tetramethylammonium thiosulphate | as per test |
| 244 | (I-7) | tetramethylammonium thiocyanate | as per test |
| 245 | (I-7) | tetramethylammonium citrate | as per test |
| 246 | (I-7) | tetramethylammonium oxalate | as per test |
| 247 | (I-7) | tetramethylammonium formate | as per test |
| 248 | (I-7) | tetramethylammonium hydrogenphosphate | as per test |
| 249 | (I-7) | tetramethylammonium dihydrogenphosphate | as per test |
| 250 | (I-7) | tetraethylammonium sulphate | as per test |
| 251 | (I-7) | tetraethylammonium lactate | as per test |
| 252 | (I-7) | tetraethylammonium nitrate | as per test |
| 253 | (I-7) | tetraethylammonium thiosulphate | as per test |
| 254 | (I-7) | tetraethylammonium thiocyanate | as per test |
| 255 | (I-7) | tetraethylammonium citrate | as per test |
| 256 | (I-7) | tetraethylammonium oxalate | as per test |
| 257 | (I-7) | tetraethylammonium formate | as per test |
| 258 | (I-7) | tetraethylammonium hydrogenphosphate | as per test |
| 259 | (I-7) | tetraethylammonium dihydrogenphosphate | as per test |
| 260 | (I-8) | ammonium sulphate | as per test |
| 261 | (I-8) | ammonium lactate | as per test |
| 262 | (I-8) | ammonium nitrate | as per test |
| 263 | (I-8) | ammonium thiosulphate | as per test |
| 264 | (I-8) | ammonium thiocyanate | as per test |
| 265 | (I-8) | ammonium citrate | as per test |
| 266 | (I-8) | ammonium oxalate | as per test |
| 267 | (I-8) | ammonium formate | as per test |
| 268 | (I-8) | ammonium hydrogenphosphate | as per test |
| 269 | (I-8) | ammonium dihydrogenphosphate | as per test |
| 270 | (I-8) | ammonium carbonate | as per test |
| 271 | (I-8) | ammonium benzoate | as per test |
| 272 | (I-8) | ammonium sulphite | as per test |
| 273 | (I-8) | ammonium benzoate | as per test |
| 274 | (I-8) | ammonium hydrogenoxalate | as per test |
| 275 | (I-8) | ammonium hydrogencitrate | as per test |
| 276 | (I-8) | ammonium acetate | as per test |
| 277 | (I-8) | tetramethylammonium sulphate | as per test |
| 278 | (I-8) | tetramethylammonium lactate | as per test |
| 279 | (I-8) | tetramethylammonium nitrate | as per test |
| 280 | (I-8) | tetramethylammonium thiosulphate | as per test |
| 281 | (I-8) | tetramethylammonium thiocyanate | as per test |
| 282 | (I-8) | tetramethylammonium citrate | as per test |
| 283 | (I-8) | tetramethylammonium oxalate | as per test |
| 284 | (I-8) | tetramethylammonium formate | as per test |
| 285 | (I-8) | tetramethylammonium hydrogenphosphate | as per test |
| 286 | (I-8) | tetramethylammonium dihydrogenphosphate | as per test |
| 287 | (I-8) | tetraethylammonium sulphate | as per test |
| 288 | (I-8) | tetraethylammonium lactate | as per test |
| 289 | (I-8) | tetraethylammonium nitrate | as per test |
| 290 | (I-8) | tetraethylammonium thiosulphate | as per test |
| 291 | (I-8) | tetraethylammonium thiocyanate | as per test |
| 292 | (I-8) | tetraethylammonium citrate | as per test |
| 293 | (I-8) | tetraethylammonium oxalate | as per test |
| 294 | (I-8) | tetraethylammonium formate | as per test |
| 295 | (I-8) | tetraethylammonium hydrogenphosphate | as per test |
| 296 | (I-8) | tetraethylammonium dihydrogenphosphate | as per test |
| 297 | (I-9) | ammonium sulphate | as per test |
| 298 | (I-9) | ammonium lactate | as per test |
| 299 | (I-9) | ammonium nitrate | as per test |
| 300 | (I-9) | ammonium thiosulphate | as per test |
| 301 | (I-9) | ammonium thiocyanate | as per test |
| 302 | (I-9) | ammonium citrate | as per test |
| 303 | (I-9) | ammonium oxalate | as per test |
| 304 | (I-9) | ammonium formate | as per test |
| 305 | (I-9) | ammonium hydrogenphosphate | as per test |
| 306 | (I-9) | ammonium dihydrogenphosphate | as per test |
| 307 | (I-9) | ammonium carbonate | as per test |
| 308 | (I-9) | ammonium benzoate | as per test |
| 309 | (I-9) | ammonium sulphite | as per test |
| 310 | (I-9) | ammonium benzoate | as per test |
| 311 | (I-9) | ammonium hydrogenoxalate | as per test |
| 312 | (I-9) | ammonium hydrogencitrate | as per test |
| 313 | (I-9) | ammonium acetate | as per test |
| 314 | (I-9) | tetramethylammonium sulphate | as per test |
| 315 | (I-9) | tetramethylammonium lactate | as per test |
| 316 | (I-9) | tetramethylammonium nitrate | as per test |
| 317 | (I-9) | tetramethylammonium thiosulphate | as per test |
| 318 | (I-9) | tetramethylammonium thiocyanate | as per test |
| 319 | (I-9) | tetramethylammonium citrate | as per test |
| 320 | (I-9) | tetramethylammonium oxalate | as per test |
| 321 | (I-9) | tetramethylammonium formate | as per test |
| 322 | (I-9) | tetramethylammonium hydrogenphosphate | as per test |
| 323 | (I-9) | tetramethylammonium dihydrogenphosphate | as per test |
| 324 | (I-9) | tetraethylammonium sulphate | as per test |
| 325 | (I-9) | tetraethylammonium lactate | as per test |
| 326 | (I-9) | tetraethylammonium nitrate | as per test |
| 327 | (I-9) | tetraethylammonium thiosulphate | as per test |
| 328 | (I-9) | tetraethylammonium thiocyanate | as per test |
| 329 | (I-9) | tetraethylammonium citrate | as per test |
| 330 | (I-9) | tetraethylammonium oxalate | as per test |
| 331 | (I-9) | tetraethylammonium formate | as per test |
| 332 | (I-9) | tetraethylammonium hydrogenphosphate | as per test |
| 333 | (I-9) | tetraethylammonium dihydrogenphosphate | as per test |
| 334 | (I-10) | ammonium sulphate | as per test |
| 335 | (I-10) | ammonium lactate | as per test |
| 336 | (I-10) | ammonium nitrate | as per test |
| 337 | (I-10) | ammonium thiosulphate | as per test |
| 338 | (I-10) | ammonium thiocyanate | as per test |
| 339 | (I-10) | ammonium citrate | as per test |
| 340 | (I-10) | ammonium oxalate | as per test |
| 341 | (I-10) | ammonium formate | as per test |
| 342 | (I-10) | ammonium hydrogenphosphate | as per test |
| 343 | (I-10) | ammonium dihydrogenphosphate | as per test |
| 344 | (I-10) | ammonium carbonate | as per test |
| 345 | (I-10) | ammonium benzoate | as per test |
| 346 | (I-10) | ammonium sulphite | as per test |
| 347 | (I-10) | ammonium benzoate | as per test |
| 348 | (I-10) | ammonium hydrogenoxalate | as per test |
| 349 | (I-10) | ammonium hydrogencitrate | as per test |
| 350 | (I-10) | ammonium acetate | as per test |
| 351 | (I-10) | tetramethylammonium sulphate | as per test |
| 352 | (I-10) | tetramethylammonium lactate | as per test |
| 353 | (I-10) | tetramethylammonium nitrate | as per test |
| 354 | (I-10) | tetramethylammonium thiosulphate | as per test |
| 355 | (I-10) | tetramethylammonium thiocyanate | as per test |
| 356 | (I-10) | tetramethylammonium citrate | as per test |
| 357 | (I-10) | tetramethylammonium oxalate | as per test |
| 358 | (I-10) | tetramethylammonium formate | as per test |
| 359 | (I-10) | tetramethylammonium hydrogenphosphate | as per test |
| 360 | (I-10) | tetramethylammonium dihydrogenphosphate | as per test |
| 361 | (I-10) | tetraethylammonium sulphate | as per test |
| 362 | (I-10) | tetraethylammonium lactate | as per test |
| 363 | (I-10) | tetraethylammonium nitrate | as per test |
| 364 | (I-10) | tetraethylammonium thiosulphate | as per test |
| 365 | (I-10) | tetraethylammonium thiocyanate | as per test |
| 366 | (I-10) | tetraethylammonium citrate | as per test |
| 367 | (I-10) | tetraethylammonium oxalate | as per test |
| 368 | (I-10) | tetraethylammonium formate | as per test |
| 369 | (I-10) | tetraethylammonium hydrogenphosphate | as per test |
| 370 | (I-10) | tetraethylammonium dihydrogenphosphate | as per test |
| 371 | (I-11) | ammonium sulphate | as per test |
| 372 | (I-11) | ammonium lactate | as per test |
| 373 | (I-11) | ammonium nitrate | as per test |
| 374 | (I-11) | ammonium thiosulphate | as per test |
| 375 | (I-11) | ammonium thiocyanate | as per test |
| 376 | (I-11) | ammonium citrate | as per test |
| 377 | (I-11) | ammonium oxalate | as per test |
| 378 | (I-11) | ammonium formate | as per test |
| 379 | (I-11) | ammonium hydrogenphosphate | as per test |
| 380 | (I-11) | ammonium dihydrogenphosphate | as per test |
| 381 | (I-11) | ammonium carbonate | as per test |
| 382 | (I-11) | ammonium benzoate | as per test |
| 383 | (I-11) | ammonium sulphite | as per test |
| 384 | (I-11) | ammonium benzoate | as per test |
| 385 | (I-11) | ammonium hydrogenoxalate | as per test |
| 386 | (I-11) | ammonium hydrogencitrate | as per test |
| 387 | (I-11) | ammonium acetate | as per test |
| 388 | (I-11) | tetramethylammonium sulphate | as per test |
| 389 | (I-11) | tetramethylammonium lactate | as per test |
| 390 | (I-11) | tetramethylammonium nitrate | as per test |
| 391 | (I-11) | tetramethylammonium thiosulphate | as per test |
| 392 | (I-11) | tetramethylammonium thiocyanate | as per test |
| 393 | (I-11) | tetramethylammonium citrate | as per test |
| 394 | (I-11) | tetramethylammonium oxalate | as per test |
| 395 | (I-11) | tetramethylammonium formate | as per test |
| 396 | (I-11) | tetramethylammonium hydrogenphosphate | as per test |
| 397 | (I-11) | tetramethylammonium dihydrogenphosphate | as per test |
| 398 | (I-11) | tetraethylammonium sulphate | as per test |
| 399 | (I-11) | tetraethylammonium lactate | as per test |
| 400 | (I-11) | tetraethylammonium nitrate | as per test |
| 401 | (I-11) | tetraethylammonium thiosulphate | as per test |
| 402 | (I-11) | tetraethylammonium thiocyanate | as per test |
| 403 | (I-11) | tetraethylammonium citrate | as per test |
| 404 | (I-11) | tetraethylammonium oxalate | as per test |
| 405 | (I-11) | tetraethylammonium formate | as per test |
| 406 | (I-11) | tetraethylammonium hydrogenphosphate | as per test |
| 407 | (I-11) | tetraethylammonium dihydrogenphosphate | as per test |
| 408 | (I-12) | ammonium sulphate | as per test |
| 409 | (I-12) | ammonium lactate | as per test |
| 410 | (I-12) | ammonium nitrate | as per test |
| 411 | (I-12) | ammonium thiosulphate | as per test |
| 412 | (I-12) | ammonium thiocyanate | as per test |
| 413 | (I-12) | ammonium citrate | as per test |
| 414 | (I-12) | ammonium oxalate | as per test |
| 415 | (I-12) | ammonium formate | as per test |
| 416 | (I-12) | ammonium hydrogenphosphate | as per test |
| 417 | (I-12) | ammonium dihydrogenphosphate | as per test |
| 418 | (I-12) | ammonium carbonate | as per test |
| 419 | (I-12) | ammonium benzoate | as per test |
| 420 | (I-12) | ammonium sulphite | as per test |
| 421 | (I-12) | ammonium benzoate | as per test |
| 422 | (I-12) | ammonium hydrogenoxalate | as per test |
| 423 | (I-12) | ammonium hydrogencitrate | as per test |
| 424 | (I-12) | ammonium acetate | as per test |
| 425 | (I-12) | tetramethylammonium sulphate | as per test |
| 426 | (I-12) | tetramethylammonium lactate | as per test |
| 427 | (I-12) | tetramethylammonium nitrate | as per test |
| 428 | (I-12) | tetramethylammonium thiosulphate | as per test |
| 429 | (I-12) | tetramethylammonium thiocyanate | as per test |
| 430 | (I-12) | tetramethylammonium citrate | as per test |
| 431 | (I-12) | tetramethylammonium oxalate | as per test |
| 432 | (I-12) | tetramethylammonium formate | as per test |
| 433 | (I-12) | tetramethylammonium hydrogenphosphate | as per test |
| 434 | (I-12) | tetramethylammonium dihydrogenphosphate | as per test |
| 435 | (I-12) | tetraethylammonium sulphate | as per test |
| 436 | (I-12) | tetraethylammonium lactate | as per test |
| 437 | (I-12) | tetraethylammonium nitrate | as per test |
| 438 | (I-12) | tetraethylammonium thiosulphate | as per test |
| 439 | (I-12) | tetraethylammonium thiocyanate | as per test |
| 440 | (I-12) | tetraethylammonium citrate | as per test |
| 441 | (I-12) | tetraethylammonium oxalate | as per test |
| 442 | (I-12) | tetraethylammonium formate | as per test |
| 443 | (I-12) | tetraethylammonium hydrogenphosphate | as per test |
| 444 | (I-12) | tetraethylammonium dihydrogenphosphate | as per test |
| 445 | (I-13) | ammonium sulphate | as per test |
| 446 | (I-13) | ammonium lactate | as per test |
| 447 | (I-13) | ammonium nitrate | as per test |
| 448 | (I-13) | ammonium thiosulphate | as per test |
| 449 | (I-13) | ammonium thiocyanate | as per test |
| 450 | (I-13) | ammonium citrate | as per test |
| 451 | (I-13) | ammonium oxalate | as per test |
| 452 | (I-13) | ammonium formate | as per test |
| 453 | (I-13) | ammonium hydrogenphosphate | as per test |
| 454 | (I-13) | ammonium dihydrogenphosphate | as per test |
| 455 | (I-13) | ammonium carbonate | as per test |
| 456 | (I-13) | ammonium benzoate | as per test |
| 457 | (I-13) | ammonium sulphite | as per test |
| 458 | (I-13) | ammonium benzoate | as per test |
| 459 | (I-13) | ammonium hydrogenoxalate | as per test |
| 460 | (I-13) | ammonium hydrogencitrate | as per test |
| 461 | (I-13) | ammonium acetate | as per test |
| 462 | (I-13) | tetramethylammonium sulphate | as per test |
| 463 | (I-13) | tetramethylammonium lactate | as per test |
| 464 | (I-13) | tetramethylammonium nitrate | as per test |
| 465 | (I-13) | tetramethylammonium thiosulphate | as per test |
| 466 | (I-13) | tetramethylammonium thiocyanate | as per test |
| 467 | (I-13) | tetramethylammonium citrate | as per test |
| 468 | (I-13) | tetramethylammonium oxalate | as per test |
| 469 | (I-13) | tetramethylammonium formate | as per test |
| 470 | (I-13) | tetramethylammonium hydrogenphosphate | as per test |
| 471 | (I-13) | tetramethylammonium dihydrogenphosphate | as per test |
| 472 | (I-13) | tetraethylammonium sulphate | as per test |
| 473 | (I-13) | tetraethylammonium lactate | as per test |
| 474 | (I-13) | tetraethylammonium nitrate | as per test |
| 475 | (I-13) | tetraethylammonium thiosulphate | as per test |
| 476 | (I-13) | tetraethylammonium thiocyanate | as per test |
| 477 | (I-13) | tetraethylammonium citrate | as per test |
| 478 | (I-13) | tetraethylammonium oxalate | as per test |
| 479 | (I-13) | tetraethylammonium formate | as per test |
| 480 | (I-13) | tetraethylammonium hydrogenphosphate | as per test |
| 481 | (I-13) | tetraethylammonium dihydrogenphosphate | as per test |
| 482 | (I-14) | ammonium sulphate | as per test |
| 483 | (I-14) | ammonium lactate | as per test |
| 484 | (I-14) | ammonium nitrate | as per test |
| 485 | (I-14) | ammonium thiosulphate | as per test |
| 486 | (I-14) | ammonium thiocyanate | as per test |
| 487 | (I-14) | ammonium citrate | as per test |
| 488 | (I-14) | ammonium oxalate | as per test |
| 489 | (I-14) | ammonium formate | as per test |
| 490 | (I-14) | ammonium hydrogenphosphate | as per test |
| 491 | (I-14) | ammonium dihydrogenphosphate | as per test |
| 492 | (I-14) | ammonium carbonate | as per test |
| 493 | (I-14) | ammonium benzoate | as per test |
| 494 | (I-14) | ammonium sulphite | as per test |
| 495 | (I-14) | ammonium benzoate | as per test |
| 496 | (I-14) | ammonium hydrogenoxalate | as per test |
| 497 | (I-14) | ammonium hydrogencitrate | as per test |
| 498 | (I-14) | ammonium acetate | as per test |
| 499 | (I-14) | tetramethylammonium sulphate | as per test |
| 500 | (I-14) | tetramethylammonium lactate | as per test |
| 501 | (I-14) | tetramethylammonium nitrate | as per test |
| 502 | (I-14) | tetramethylammonium thiosulphate | as per test |
| 503 | (I-14) | tetramethylammonium thiocyanate | as per test |
| 504 | (I-14) | tetramethylammonium citrate | as per test |
| 505 | (I-14) | tetramethylammonium oxalate | as per test |
| 506 | (I-14) | tetramethylammonium formate | as per test |
| 507 | (I-14) | tetramethylammonium hydrogenphosphate | as per test |
| 508 | (I-14) | tetramethylammonium dihydrogenphosphate | as per test |
| 509 | (I-14) | tetraethylammonium sulphate | as per test |
| 510 | (I-14) | tetraethylammonium lactate | as per test |
| 511 | (I-14) | tetraethylammonium nitrate | as per test |
| 512 | (I-14) | tetraethylammonium thiosulphate | as per test |
| 513 | (I-14) | tetraethylammonium thiocyanate | as per test |
| 514 | (I-14) | tetraethylammonium citrate | as per test |
| 515 | (I-14) | tetraethylammonium oxalate | as per test |
| 516 | (I-14) | tetraethylammonium formate | as per test |
| 517 | (I-14) | tetraethylammonium hydrogenphosphate | as per test |
| 518 | (I-14) | tetraethylammonium dihydrogenphosphate | as per test |
| 519 | (I-15) | ammonium sulphate | as per test |
| 520 | (I-15) | ammonium lactate | as per test |
| 521 | (I-15) | ammonium nitrate | as per test |
| 522 | (I-15) | ammonium thiosulphate | as per test |
| 523 | (I-15) | ammonium thiocyanate | as per test |
| 524 | (I-15) | ammonium citrate | as per test |
| 525 | (I-15) | ammonium oxalate | as per test |
| 526 | (I-15) | ammonium formate | as per test |
| 527 | (I-15) | ammonium hydrogenphosphate | as per test |
| 528 | (I-15) | ammonium dihydrogenphosphate | as per test |
| 529 | (I-15) | ammonium carbonate | as per test |
| 530 | (I-15) | ammonium benzoate | as per test |
| 531 | (I-15) | ammonium sulphite | as per test |
| 532 | (I-15) | ammonium benzoate | as per test |
| 533 | (I-15) | ammonium hydrogenoxalate | as per test |
| 534 | (I-15) | ammonium hydrogencitrate | as per test |
| 535 | (I-15) | ammonium acetate | as per test |
| 536 | (I-15) | tetramethylammonium sulphate | as per test |
| 537 | (I-15) | tetramethylammonium lactate | as per test |
| 538 | (I-15) | tetramethylammonium nitrate | as per test |
| 539 | (I-15) | tetramethylammonium thiosulphate | as per test |
| 540 | (I-15) | tetramethylammonium thiocyanate | as per test |
| 541 | (I-15) | tetramethylammonium citrate | as per test |
| 542 | (I-15) | tetramethylammonium oxalate | as per test |
| 543 | (I-15) | tetramethylammonium formate | as per test |
| 544 | (I-15) | tetramethylammonium hydrogenphosphate | as per test |
| 545 | (I-15) | tetramethylammonium dihydrogenphosphate | as per test |
| 546 | (I-15) | tetraethylammonium sulphate | as per test |
| 547 | (I-15) | tetraethylammonium lactate | as per test |
| 548 | (I-15) | tetraethylammonium nitrate | as per test |
| 549 | (I-15) | tetraethylammonium thiosulphate | as per test |
| 550 | (I-15) | tetraethylammonium thiocyanate | as per test |
| 551 | (I-15) | tetraethylammonium citrate | as per test |
| 552 | (I-15) | tetraethylammonium oxalate | as per test |
| 553 | (I-15) | tetraethylammonium formate | as per test |
| 554 | (I-15) | tetraethylammonium hydrogenphosphate | as per test |
| 555 | (I-15) | tetraethylammonium dihydrogenphosphate | as per test |
| 556 | (I-16) | ammonium sulphate | as per test |
| 557 | (I-16) | ammonium lactate | as per test |
| 558 | (I-16) | ammonium nitrate | as per test |
| 559 | (I-16) | ammonium thiosulphate | as per test |
| 560 | (I-16) | ammonium thiocyanate | as per test |
| 561 | (I-16) | ammonium citrate | as per test |
| 562 | (I-16) | ammonium oxalate | as per test |
| 563 | (I-16) | ammonium formate | as per test |
| 564 | (I-16) | ammonium hydrogenphosphate | as per test |
| 565 | (I-16) | ammonium dihydrogenphosphate | as per test |
| 566 | (I-16) | ammonium carbonate | as per test |
| 567 | (I-16) | ammonium benzoate | as per test |
| 568 | (I-16) | ammonium sulphite | as per test |
| 569 | (I-16) | ammonium benzoate | as per test |
| 570 | (I-16) | ammonium hydrogenoxalate | as per test |
| 571 | (I-16) | ammonium hydrogencitrate | as per test |
| 572 | (I-16) | ammonium acetate | as per test |
| 573 | (I-16) | tetramethylammonium sulphate | as per test |
| 574 | (I-16) | tetramethylammonium lactate | as per test |
| 575 | (I-16) | tetramethylammonium nitrate | as per test |
| 576 | (I-16) | tetramethylammonium thiosulphate | as per test |
| 577 | (I-16) | tetramethylammonium thiocyanate | as per test |
| 578 | (I-16) | tetramethylammonium citrate | as per test |
| 579 | (I-16) | tetramethylammonium oxalate | as per test |
| 580 | (I-16) | tetramethylammonium formate | as per test |
| 581 | (I-16) | tetramethylammonium hydrogenphosphate | as per test |
| 582 | (I-16) | tetramethylammonium dihydrogenphosphate | as per test |
| 583 | (I-16) | tetraethylammonium sulphate | as per test |
| 584 | (I-16) | tetraethylammonium lactate | as per test |
| 585 | (I-16) | tetraethylammonium nitrate | as per test |
| 586 | (I-16) | tetraethylammonium thiosulphate | as per test |
| 587 | (I-16) | tetraethylammonium thiocyanate | as per test |
| 588 | (I-16) | tetraethylammonium citrate | as per test |
| 589 | (I-16) | tetraethylammonium oxalate | as per test |
| 590 | (I-16) | tetraethylammonium formate | as per test |
| 591 | (I-16) | tetraethylammonium hydrogenphosphate | as per test |
| 592 | (I-16) | tetraethylammonium dihydrogenphosphate | as per test |
| 593 | (I-17) | ammonium sulphate | as per test |
| 594 | (I-17) | ammonium lactate | as per test |
| 595 | (I-17) | ammonium nitrate | as per test |
| 596 | (I-17) | ammonium thiosulphate | as per test |
| 597 | (I-17) | ammonium thiocyanate | as per test |
| 598 | (I-17) | ammonium citrate | as per test |
| 599 | (I-17) | ammonium oxalate | as per test |
| 600 | (I-17) | ammonium formate | as per test |
| 601 | (I-17) | ammonium hydrogenphosphate | as per test |
| 602 | (I-17) | ammonium dihydrogenphosphate | as per test |
| 603 | (I-17) | ammonium carbonate | as per test |
| 604 | (I-17) | ammonium benzoate | as per test |
| 605 | (I-17) | ammonium sulphite | as per test |
| 606 | (I-17) | ammonium benzoate | as per test |
| 607 | (I-17) | ammonium hydrogenoxalate | as per test |
| 608 | (I-17) | ammonium hydrogencitrate | as per test |
| 609 | (I-17) | ammonium acetate | as per test |
| 610 | (I-17) | tetramethylammonium sulphate | as per test |
| 611 | (I-17) | tetramethylammonium lactate | as per test |
| 612 | (I-17) | tetramethylammonium nitrate | as per test |
| 613 | (I-17) | tetramethylammonium thiosulphate | as per test |
| 614 | (I-17) | tetramethylammonium thiocyanate | as per test |
| 615 | (I-17) | tetramethylammonium citrate | as per test |
| 616 | (I-17) | tetramethylammonium oxalate | as per test |
| 617 | (I-17) | tetramethylammonium formate | as per test |
| 618 | (I-17) | tetramethylammonium hydrogenphosphate | as per test |
| 619 | (I-17) | tetramethylammonium dihydrogenphosphate | as per test |
| 620 | (I-17) | tetraethylammonium sulphate | as per test |
| 621 | (I-17) | tetraethylammonium lactate | as per test |
| 622 | (I-17) | tetraethylammonium nitrate | as per test |
| 623 | (I-17) | tetraethylammonium thiosulphate | as per test |
| 624 | (I-17) | tetraethylammonium thiocyanate | as per test |
| 625 | (I-17) | tetraethylammonium citrate | as per test |
| 626 | (I-17) | tetraethylammonium oxalate | as per test |
| 627 | (I-17) | tetraethylammonium formate | as per test |
| 628 | (I-17) | tetraethylammonium hydrogenphosphate | as per test |
| 629 | (I-17) | tetraethylammonium dihydrogenphosphate | as per test |
| 630 | (I-18) | ammonium sulphate | as per test |
| 631 | (I-18) | ammonium lactate | as per test |
| 632 | (I-18) | ammonium nitrate | as per test |
| 633 | (I-18) | ammonium thiosulphate | as per test |
| 634 | (I-18) | ammonium thiocyanate | as per test |
| 635 | (I-18) | ammonium citrate | as per test |
| 636 | (I-18) | ammonium oxalate | as per test |
| 637 | (I-18) | ammonium formate | as per test |
| 638 | (I-18) | ammonium hydrogenphosphate | as per test |
| 639 | (I-18) | ammonium dihydrogenphosphate | as per test |
| 640 | (I-18) | ammonium carbonate | as per test |
| 641 | (I-18) | ammonium benzoate | as per test |
| 642 | (I-18) | ammonium sulphite | as per test |
| 643 | (I-18) | ammonium benzoate | as per test |
| 644 | (I-18) | ammonium hydrogenoxalate | as per test |
| 645 | (I-18) | ammonium hydrogencitrate | as per test |
| 646 | (I-18) | ammonium acetate | as per test |
| 647 | (I-18) | tetramethylammonium sulphate | as per test |
| 648 | (I-18) | tetramethylammonium lactate | as per test |
| 649 | (I-18) | tetramethylammonium nitrate | as per test |
| 650 | (I-18) | tetramethylammonium thiosulphate | as per test |
| 651 | (I-18) | tetramethylammonium thiocyanate | as per test |
| 652 | (I-18) | tetramethylammonium citrate | as per test |
| 653 | (I-18) | tetramethylammonium oxalate | as per test |
| 654 | (I-18) | tetramethylammonium formate | as per test |
| 655 | (I-18) | tetramethylammonium hydrogenphosphate | as per test |
| 656 | (I-18) | tetramethylammonium dihydrogenphosphate | as per test |
| 657 | (I-18) | tetraethylammonium sulphate | as per test |
| 658 | (I-18) | tetraethylammonium lactate | as per test |
| 659 | (I-18) | tetraethylammonium nitrate | as per test |
| 660 | (I-18) | tetraethylammonium thiosulphate | as per test |
| 661 | (I-18) | tetraethylammonium thiocyanate | as per test |
| 662 | (I-18) | tetraethylammonium citrate | as per test |
| 663 | (I-18) | tetraethylammonium oxalate | as per test |
| 664 | (I-18) | tetraethylammonium formate | as per test |
| 665 | (I-18) | tetraethylammonium hydrogenphosphate | as per test |
| 666 | (I-18) | tetraethylammonium dihydrogenphosphate | as per test |
| 667 | (I-19) | ammonium sulphate | as per test |
| 668 | (I-19) | ammonium lactate | as per test |
| 669 | (I-19) | ammonium nitrate | as per test |
| 670 | (I-19) | ammonium thiosulphate | as per test |
| 671 | (I-19) | ammonium thiocyanate | as per test |
| 672 | (I-19) | ammonium citrate | as per test |
| 673 | (I-19) | ammonium oxalate | as per test |
| 674 | (I-19) | ammonium formate | as per test |
| 675 | (I-19) | ammonium hydrogenphosphate | as per test |
| 676 | (I-19) | ammonium dihydrogenphosphate | as per test |
| 677 | (I-19) | ammonium carbonate | as per test |
| 678 | (I-19) | ammonium benzoate | as per test |
| 679 | (I-19) | ammonium sulphite | as per test |
| 680 | (I-19) | ammonium benzoate | as per test |
| 681 | (I-19) | ammonium hydrogenoxalate | as per test |
| 682 | (I-19) | ammonium hydrogencitrate | as per test |
| 683 | (I-19) | ammonium acetate | as per test |
| 684 | (I-19) | tetramethylammonium sulphate | as per test |
| 685 | (I-19) | tetramethylammonium lactate | as per test |
| 686 | (I-19) | tetramethylammonium nitrate | as per test |
| 687 | (I-19) | tetramethylammonium thiosulphate | as per test |
| 688 | (I-19) | tetramethylammonium thiocyanate | as per test |
| 689 | (I-19) | tetramethylammonium citrate | as per test |
| 690 | (I-19) | tetramethylammonium oxalate | as per test |
| 691 | (I-19) | tetramethylammonium formate | as per test |
| 692 | (I-19) | tetramethylammonium hydrogenphosphate | as per test |
| 693 | (I-19) | tetramethylammonium dihydrogenphosphate | as per test |
| 694 | (I-19) | tetraethylammonium sulphate | as per test |
| 695 | (I-19) | tetraethylammonium lactate | as per test |
| 696 | (I-19) | tetraethylammonium nitrate | as per test |
| 697 | (I-19) | tetraethylammonium thiosulphate | as per test |
| 698 | (I-19) | tetraethylammonium thiocyanate | as per test |
| 699 | (I-19) | tetraethylammonium citrate | as per test |
| 700 | (I-19) | tetraethylammonium oxalate | as per test |
| 701 | (I-19) | tetraethylammonium formate | as per test |
| 702 | (I-19) | tetraethylammonium hydrogenphosphate | as per test |
| 703 | (I-19) | tetraethylammonium dihydrogenphosphate | as per test |
| 704 | (I-20) | ammonium sulphate | as per test |
| 705 | (I-20) | ammonium lactate | as per test |
| 706 | (I-20) | ammonium nitrate | as per test |
| 707 | (I-20) | ammonium thiosulphate | as per test |
| 708 | (I-20) | ammonium thiocyanate | as per test |
| 709 | (I-20) | ammonium citrate | as per test |
| 710 | (I-20) | ammonium oxalate | as per test |
| 711 | (I-20) | ammonium formate | as per test |
| 712 | (I-20) | ammonium hydrogenphosphate | as per test |
| 713 | (I-20) | ammonium dihydrogenphosphate | as per test |
| 714 | (I-20) | ammonium carbonate | as per test |
| 715 | (I-20) | ammonium benzoate | as per test |
| 716 | (I-20) | ammonium sulphite | as per test |
| 717 | (I-20) | ammonium benzoate | as per test |
| 718 | (I-20) | ammonium hydrogenoxalate | as per test |
| 719 | (I-20) | ammonium hydrogencitrate | as per test |
| 720 | (I-20) | ammonium acetate | as per test |
| 721 | (I-20) | tetramethylammonium sulphate | as per test |
| 722 | (I-20) | tetramethylammonium lactate | as per test |
| 723 | (I-20) | tetramethylammonium nitrate | as per test |
| 724 | (I-20) | tetramethylammonium thiosulphate | as per test |
| 725 | (I-20) | tetramethylammonium thiocyanate | as per test |
| 726 | (I-20) | tetramethylammonium citrate | as per test |
| 727 | (I-20) | tetramethylammonium oxalate | as per test |
| 728 | (I-20) | tetramethylammonium formate | as per test |
| 729 | (I-20) | tetramethylammonium hydrogenphosphate | as per test |
| 730 | (I-20) | tetramethylammonium dihydrogenphosphate | as per test |
| 731 | (I-20) | tetraethylammonium sulphate | as per test |
| 732 | (I-20) | tetraethylammonium lactate | as per test |
| 733 | (I-20) | tetraethylammonium nitrate | as per test |
| 734 | (I-20) | tetraethylammonium thiosulphate | as per test |
| 735 | (I-20) | tetraethylammonium thiocyanate | as per test |
| 736 | (I-20) | tetraethylammonium citrate | as per test |
| 737 | (I-20) | tetraethylammonium oxalate | as per test |
| 738 | (I-20) | tetraethylammonium formate | as per test |
| 739 | (I-20) | tetraethylammonium hydrogenphosphate | as per test |
| 740 | (I-20) | tetraethylammonium dihydrogenphosphate | as per test |
| 741 | (I-21) | ammonium sulphate | as per test |
| 742 | (I-21) | ammonium lactate | as per test |
| 743 | (I-21) | ammonium nitrate | as per test |
| 744 | (I-21) | ammonium thiosulphate | as per test |
| 745 | (I-21) | ammonium thiocyanate | as per test |
| 746 | (I-21) | ammonium citrate | as per test |
| 747 | (I-21) | ammonium oxalate | as per test |
| 748 | (I-21) | ammonium formate | as per test |
| 749 | (I-21) | ammonium hydrogenphosphate | as per test |
| 750 | (I-21) | ammonium dihydrogenphosphate | as per test |
| 751 | (I-21) | ammonium carbonate | as per test |
| 752 | (I-21) | ammonium benzoate | as per test |
| 753 | (I-21) | ammonium sulphite | as per test |
| 754 | (I-21) | ammonium benzoate | as per test |
| 755 | (I-21) | ammonium hydrogenoxalate | as per test |
| 756 | (I-21) | ammonium hydrogencitrate | as per test |
| 757 | (I-21) | ammonium acetate | as per test |
| 758 | (I-21) | tetramethylammonium sulphate | as per test |
| 759 | (I-21) | tetramethylammonium lactate | as per test |
| 760 | (I-21) | tetramethylammonium nitrate | as per test |
| 761 | (I-21) | tetramethylammonium thiosulphate | as per test |
| 762 | (I-21) | tetramethylammonium thiocyanate | as per test |
| 763 | (I-21) | tetramethylammonium citrate | as per test |
| 764 | (I-21) | tetramethylammonium oxalate | as per test |
| 765 | (I-21) | tetramethylammonium formate | as per test |
| 767 | (I-21) | tetramethylammonium hydrogenphosphate | as per test |
| 768 | (I-21) | tetramethylammonium dihydrogenphosphate | as per test |
| 769 | (I-21) | tetraethylammonium sulphate | as per test |
| 770 | (I-21) | tetraethylammonium lactate | as per test |
| 771 | (I-21) | tetraethylammonium nitrate | as per test |
| 772 | (I-21) | tetraethylammonium thiosulphate | as per test |
| 773 | (I-21) | tetraethylammonium thiocyanate | as per test |
| 774 | (I-21) | tetraethylammonium citrate | as per test |
| 775 | (I-21) | tetraethylammonium oxalate | as per test |
| 776 | (I-21) | tetraethylammonium formate | as per test |
| 777 | (I-21) | tetraethylammonium hydrogenphosphate | as per test |
| 778 | (I-21) | tetraethylammonium dihydrogenphosphate | as per test |
| 779 | (I-22) | ammonium sulphate | as per test |
| 780 | (I-22) | ammonium lactate | as per test |
| 781 | (I-22) | ammonium nitrate | as per test |
| 782 | (I-22) | ammonium thiosulphate | as per test |
| 783 | (I-22) | ammonium thiocyanate | as per test |
| 784 | (I-22) | ammonium citrate | as per test |
| 785 | (I-22) | ammonium oxalate | as per test |
| 786 | (I-22) | ammonium formate | as per test |
| 787 | (I-22) | ammonium hydrogenphosphate | as per test |
| 788 | (I-22) | ammonium dihydrogenphosphate | as per test |
| 789 | (I-22) | ammonium carbonate | as per test |
| 790 | (I-22) | ammonium benzoate | as per test |
| 791 | (I-22) | ammonium sulphite | as per test |
| 792 | (I-22) | ammonium benzoate | as per test |
| 793 | (I-22) | ammonium hydrogenoxalate | as per test |
| 794 | (I-22) | ammonium hydrogencitrate | as per test |
| 795 | (I-22) | ammonium acetate | as per test |
| 796 | (I-22) | tetramethylammonium sulphate | as per test |
| 797 | (I-22) | tetramethylammonium lactate | as per test |
| 798 | (I-22) | tetramethylammonium nitrate | as per test |
| 799 | (I-22) | tetramethylammonium thiosulphate | as per test |
| 800 | (I-22) | tetramethylammonium thiocyanate | as per test |
| 801 | (I-22) | tetramethylammonium citrate | as per test |
| 802 | (I-22) | tetramethylammonium oxalate | as per test |
| 803 | (I-22) | tetramethylammonium formate | as per test |
| 804 | (I-22) | tetramethylammonium hydrogenphosphate | as per test |
| 805 | (I-22) | tetramethylammonium dihydrogenphosphate | as per test |
| 806 | (I-22) | tetraethylammonium sulphate | as per test |
| 807 | (I-22) | tetraethylammonium lactate | as per test |
| 808 | (I-22) | tetraethylammonium nitrate | as per test |
| 809 | (I-22) | tetraethylammonium thiosulphate | as per test |
| 810 | (I-22) | tetraethylammonium thiocyanate | as per test |
| 811 | (I-22) | tetraethylammonium citrate | as per test |
| 812 | (I-22) | tetraethylammonium oxalate | as per test |
| 813 | (I-22) | tetraethylammonium formate | as per test |
| 814 | (I-22) | tetraethylammonium hydrogenphosphate | as per test |
| 815 | (I-22) | tetraethylammonium dihydrogenphosphate | as per test |
| 816 | (I-23) | ammonium sulphate | as per test |
| 817 | (I-23) | ammonium lactate | as per test |
| 818 | (I-23) | ammonium nitrate | as per test |
| 819 | (I-23) | ammonium thiosulphate | as per test |
| 820 | (I-23) | ammonium thiocyanate | as per test |
| 821 | (I-23) | ammonium citrate | as per test |
| 822 | (I-23) | ammonium oxalate | as per test |
| 823 | (I-23) | ammonium formate | as per test |
| 824 | (I-23) | ammonium hydrogenphosphate | as per test |
| 825 | (I-23) | ammonium dihydrogenphosphate | as per test |
| 826 | (I-23) | ammonium carbonate | as per test |
| 827 | (I-23) | ammonium benzoate | as per test |
| 828 | (I-23) | ammonium sulphite | as per test |
| 829 | (I-23) | ammonium benzoate | as per test |
| 830 | (I-23) | ammonium hydrogenoxalate | as per test |
| 831 | (I-23) | ammonium hydrogencitrate | as per test |
| 832 | (I-23) | ammonium acetate | as per test |
| 833 | (I-23) | tetramethylammonium sulphate | as per test |
| 834 | (I-23) | tetramethylammonium lactate | as per test |
| 835 | (I-23) | tetramethylammonium nitrate | as per test |
| 836 | (I-23) | tetramethylammonium thiosulphate | as per test |
| 837 | (I-23) | tetramethylammonium thiocyanate | as per test |
| 838 | (I-23) | tetramethylammonium citrate | as per test |
| 839 | (I-23) | tetramethylammonium oxalate | as per test |
| 840 | (I-23) | tetramethylammonium formate | as per test |
| 841 | (I-23) | tetramethylammonium hydrogenphosphate | as per test |
| 842 | (I-23) | tetramethylammonium dihydrogenphosphate | as per test |
| 843 | (I-23) | tetraethylammonium sulphate | as per test |
| 844 | (I-23) | tetraethylammonium lactate | as per test |
| 845 | (I-23) | tetraethylammonium nitrate | as per test |
| 846 | (I-23) | tetraethylammonium thiosulphate | as per test |
| 847 | (I-23) | tetraethylammonium thiocyanate | as per test |
| 848 | (I-23) | tetraethylammonium citrate | as per test |
| 849 | (I-23) | tetraethylammonium oxalate | as per test |
| 850 | (I-23) | tetraethylammonium formate | as per test |
| 851 | (I-23) | tetraethylammonium hydrogenphosphate | as per test |
| 852 | (I-23) | tetraethylammonium dihydrogenphosphate | as per test |
| 853 | (I-24) | ammonium sulphate | as per test |
| 854 | (I-24) | ammonium lactate | as per test |
| 855 | (I-24) | ammonium nitrate | as per test |
| 856 | (I-24) | ammonium thiosulphate | as per test |
| 857 | (I-24) | ammonium thiocyanate | as per test |
| 858 | (I-24) | ammonium citrate | as per test |
| 859 | (I-24) | ammonium oxalate | as per test |
| 860 | (I-24) | ammonium formate | as per test |
| 861 | (I-24) | ammonium hydrogenphosphate | as per test |
| 862 | (I-24) | ammonium dihydrogenphosphate | as per test |
| 863 | (I-24) | ammonium carbonate | as per test |
| 864 | (I-24) | ammonium benzoate | as per test |
| 865 | (I-24) | ammonium sulphite | as per test |
| 866 | (I-24) | ammonium benzoate | as per test |
| 867 | (I-24) | ammonium hydrogenoxalate | as per test |
| 868 | (I-24) | ammonium hydrogencitrate | as per test |
| 869 | (I-24) | ammonium acetate | as per test |
| 870 | (I-24) | tetramethylammonium sulphate | as per test |
| 871 | (I-24) | tetramethylammonium lactate | as per test |
| 872 | (I-24) | tetramethylammonium nitrate | as per test |
| 873 | (I-24) | tetramethylammonium thiosulphate | as per test |
| 874 | (I-24) | tetramethylammonium thiocyanate | as per test |
| 875 | (I-24) | tetramethylammonium citrate | as per test |
| 876 | (I-24) | tetramethylammonium oxalate | as per test |
| 877 | (I-24) | tetramethylammonium formate | as per test |
| 878 | (I-24) | tetramethylammonium hydrogenphosphate | as per test |
| 879 | (I-24) | tetramethylammonium dihydrogenphosphate | as per test |
| 880 | (I-24) | tetraethylammonium sulphate | as per test |
| 881 | (I-24) | tetraethylammonium lactate | as per test |
| 882 | (I-24) | tetraethylammonium nitrate | as per test |
| 883 | (I-24) | tetraethylammonium thiosulphate | as per test |
| 884 | (I-24) | tetraethylammonium thiocyanate | as per test |
| 885 | (I-24) | tetraethylammonium citrate | as per test |
| 886 | (I-24) | tetraethylammonium oxalate | as per test |
| 887 | (I-24) | tetraethylammonium formate | as per test |
| 888 | (I-24) | tetraethylammonium hydrogenphosphate | as per test |
| 889 | (I-24) | tetraethylammonium dihydrogenphosphate | as per test |
| 890 | (I-25) | ammonium sulphate | as per test |
| 891 | (I-25) | ammonium lactate | as per test |
| 892 | (I-25) | ammonium nitrate | as per test |
| 893 | (I-25) | ammonium thiosulphate | as per test |
| 894 | (I-25) | ammonium thiocyanate | as per test |
| 895 | (I-25) | ammonium citrate | as per test |
| 896 | (I-25) | ammonium oxalate | as per test |
| 897 | (I-25) | ammonium formate | as per test |
| 898 | (I-25) | ammonium hydrogenphosphate | as per test |
| 899 | (I-25) | ammonium dihydrogenphosphate | as per test |
| 900 | (I-25) | ammonium carbonate | as per test |
| 901 | (I-25) | ammonium benzoate | as per test |
| 902 | (I-25) | ammonium sulphite | as per test |
| 903 | (I-25) | ammonium benzoate | as per test |
| 904 | (I-25) | ammonium hydrogenoxalate | as per test |
| 905 | (I-25) | ammonium hydrogencitrate | as per test |
| 906 | (I-25) | ammonium acetate | as per test |
| 907 | (I-25) | tetramethylammonium sulphate | as per test |
| 908 | (I-25) | tetramethylammonium lactate | as per test |
| 909 | (I-25) | tetramethylammonium nitrate | as per test |
| 910 | (I-25) | tetramethylammonium thiosulphate | as per test |
| 911 | (I-25) | tetramethylammonium thiocyanate | as per test |
| 912 | (I-25) | tetramethylammonium citrate | as per test |
| 913 | (I-25) | tetramethylammonium oxalate | as per test |
| 914 | (I-25) | tetramethylammonium formate | as per test |
| 915 | (I-25) | tetramethylammonium hydrogenphosphate | as per test |
| 916 | (I-25) | tetramethylammonium dihydrogenphosphate | as per test |
| 917 | (I-25) | tetraethylammonium sulphate | as per test |
| 918 | (I-25) | tetraethylammonium lactate | as per test |
| 919 | (I-25) | tetraethylammonium nitrate | as per test |
| 920 | (I-25) | tetraethylammonium thiosulphate | as per test |
| 921 | (I-25) | tetraethylammonium thiocyanate | as per test |
| 922 | (I-25) | tetraethylammonium citrate | as per test |
| 923 | (I-25) | tetraethylammonium oxalate | as per test |
| 924 | (I-25) | tetraethylammonium formate | as per test |
| 925 | (I-25) | tetraethylammonium hydrogenphosphate | as per test |
| 926 | (I-25) | tetraethylammonium dihydrogenphosphate | as per test |
| 927 | (I-26) | ammonium sulphate | as per test |
| 928 | (I-26) | ammonium lactate | as per test |
| 929 | (I-26) | ammonium nitrate | as per test |
| 930 | (I-26) | ammonium thiosulphate | as per test |
| 931 | (I-26) | ammonium thiocyanate | as per test |
| 932 | (I-26) | ammonium citrate | as per test |
| 933 | (I-26) | ammonium oxalate | as per test |
| 934 | (I-26) | ammonium formate | as per test |
| 935 | (I-26) | ammonium hydrogenphosphate | as per test |
| 936 | (I-26) | ammonium dihydrogenphosphate | as per test |
| 937 | (I-26) | ammonium carbonate | as per test |
| 938 | (I-26) | ammonium benzoate | as per test |
| 939 | (I-26) | ammonium sulphite | as per test |
| 940 | (I-26) | ammonium benzoate | as per test |
| 941 | (I-26) | ammonium hydrogenoxalate | as per test |
| 942 | (I-26) | ammonium hydrogencitrate | as per test |
| 943 | (I-26) | ammonium acetate | as per test |
| 944 | (I-26) | tetramethylammonium sulphate | as per test |
| 945 | (I-26) | tetramethylammonium lactate | as per test |
| 946 | (I-26) | tetramethylammonium nitrate | as per test |
| 947 | (I-26) | tetramethylammonium thiosulphate | as per test |
| 948 | (I-26) | tetramethylammonium thiocyanate | as per test |
| 949 | (I-26) | tetramethylammonium citrate | as per test |
| 950 | (I-26) | tetramethylammonium oxalate | as per test |
| 951 | (I-26) | tetramethylammonium formate | as per test |
| 952 | (I-26) | tetramethylammonium hydrogenphosphate | as per test |
| 953 | (I-26) | tetramethylammonium dihydrogenphosphate | as per test |
| 954 | (I-26) | tetraethylammonium sulphate | as per test |
| 955 | (I-26) | tetraethylammonium lactate | as per test |
| 956 | (I-26) | tetraethylammonium nitrate | as per test |
| 957 | (I-26) | tetraethylammonium thiosulphate | as per test |
| 958 | (I-26) | tetraethylammonium thiocyanate | as per test |
| 959 | (I-26) | tetraethylammonium citrate | as per test |
| 960 | (I-26) | tetraethylammonium oxalate | as per test |
| 961 | (I-26) | tetraethylammonium formate | as per test |
| 962 | (I-26) | tetraethylammonium hydrogenphosphate | as per test |
| 963 | (I-26) | tetraethylammonium dihydrogenphosphate | as per test |
| 964 | (I-27) | ammonium sulphate | as per test |
| 965 | (I-27) | ammonium lactate | as per test |
| 966 | (I-27) | ammonium nitrate | as per test |
| 967 | (I-27) | ammonium thiosulphate | as per test |
| 968 | (I-27) | ammonium thiocyanate | as per test |
| 969 | (I-27) | ammonium citrate | as per test |
| 970 | (I-27) | ammonium oxalate | as per test |
| 971 | (I-27) | ammonium formate | as per test |
| 972 | (I-27) | ammonium hydrogenphosphate | as per test |
| 973 | (I-27) | ammonium dihydrogenphosphate | as per test |
| 974 | (I-27) | ammonium carbonate | as per test |
| 975 | (I-27) | ammonium benzoate | as per test |
| 976 | (I-27) | ammonium sulphite | as per test |
| 977 | (I-27) | ammonium benzoate | as per test |
| 978 | (I-27) | ammonium hydrogenoxalate | as per test |
| 979 | (I-27) | ammonium hydrogencitrate | as per test |
| 980 | (I-27) | ammonium acetate | as per test |
| 981 | (I-27) | tetramethylammonium sulphate | as per test |
| 982 | (I-27) | tetramethylammonium lactate | as per test |
| 983 | (I-27) | tetramethylammonium nitrate | as per test |
| 984 | (I-27) | tetramethylammonium thiosulphate | as per test |
| 985 | (I-27) | tetramethylammonium thiocyanate | as per test |
| 986 | (I-27) | tetramethylammonium citrate | as per test |
| 987 | (I-27) | tetramethylammonium oxalate | as per test |
| 988 | (I-27) | tetramethylammonium formate | as per test |
| 989 | (I-27) | tetramethylammonium hydrogenphosphate | as per test |
| 990 | (I-27) | tetramethylammonium dihydrogenphosphate | as per test |
| 991 | (I-27) | tetraethylammonium sulphate | as per test |
| 992 | (I-27) | tetraethylammonium lactate | as per test |
| 993 | (I-27) | tetraethylammonium nitrate | as per test |
| 994 | (I-27) | tetraethylammonium thiosulphate | as per test |
| 995 | (I-27) | tetraethylammonium thiocyanate | as per test |
| 996 | (I-27) | tetraethylammonium citrate | as per test |
| 997 | (I-27) | tetraethylammonium oxalate | as per test |
| 998 | (I-27) | tetraethylammonium formate | as per test |
| 999 | (I-27) | tetraethylammonium hydrogenphosphate | as per test |
| 1000 | (I-27) | tetraethylammonium dihydrogenphosphate | as per test |
| 1001 | (I-28) | ammonium sulphate | as per test |
| 1002 | (I-28) | ammonium lactate | as per test |
| 1003 | (I-28) | ammonium nitrate | as per test |
| 1004 | (I-28) | ammonium thiosulphate | as per test |
| 1005 | (I-28) | ammonium thiocyanate | as per test |
| 1006 | (I-28) | ammonium citrate | as per test |
| 1007 | (I-28) | ammonium oxalate | as per test |
| 1008 | (I-28) | ammonium formate | as per test |
| 1009 | (I-28) | ammonium hydrogenphosphate | as per test |
| 1010 | (I-28) | ammonium dihydrogenphosphate | as per test |
| 1011 | (I-28) | ammonium carbonate | as per test |
| 1012 | (I-28) | ammonium benzoate | as per test |
| 1013 | (I-28) | ammonium sulphite | as per test |
| 1014 | (I-28) | ammonium benzoate | as per test |
| 1015 | (I-28) | ammonium hydrogenoxalate | as per test |
| 1016 | (I-28) | ammonium hydrogencitrate | as per test |
| 1017 | (I-28) | ammonium acetate | as per test |
| 1018 | (I-28) | tetramethylammonium sulphate | as per test |
| 1019 | (I-28) | tetramethylammonium lactate | as per test |
| 1020 | (I-28) | tetramethylammonium nitrate | as per test |
| 1021 | (I-28) | tetramethylammonium thiosulphate | as per test |
| 1022 | (I-28) | tetramethylammonium thiocyanate | as per test |
| 1023 | (I-28) | tetramethylammonium citrate | as per test |
| 1024 | (I-28) | tetramethylammonium oxalate | as per test |
| 1025 | (I-28) | tetramethylammonium formate | as per test |
| 1026 | (I-28) | tetramethylammonium hydrogenphosphate | as per test |
| 1027 | (I-28) | tetramethylammonium dihydrogenphosphate | as per test |
| 1028 | (I-28) | tetraethylammonium sulphate | as per test |
| 1029 | (I-28) | tetraethylammonium lactate | as per test |
| 1030 | (I-28) | tetraethylammonium nitrate | as per test |
| 1031 | (I-28) | tetraethylammonium thiosulphate | as per test |
| 1032 | (I-28) | tetraethylammonium thiocyanate | as per test |
| 1033 | (I-28) | tetraethylammonium citrate | as per test |
| 1034 | (I-28) | tetraethylammonium oxalate | as per test |
| 1035 | (I-28) | tetraethylammonium formate | as per test |
| 1036 | (I-28) | tetraethylammonium hydrogenphosphate | as per test |
| 1037 | (I-28) | tetraethylammonium dihydrogenphosphate | as per test |
| 1038 | (I-29) | ammonium sulphate | as per test |
| 1039 | (I-29) | ammonium lactate | as per test |
| 1040 | (I-29) | ammonium nitrate | as per test |
| 1041 | (I-29) | ammonium thiosulphate | as per test |
| 1042 | (I-29) | ammonium thiocyanate | as per test |
| 1043 | (I-29) | ammonium citrate | as per test |
| 1044 | (I-29) | ammonium oxalate | as per test |
| 1045 | (I-29) | ammonium formate | as per test |
| 1046 | (I-29) | ammonium hydrogenphosphate | as per test |
| 1047 | (I-29) | ammonium dihydrogenphosphate | as per test |
| 1048 | (I-29) | ammonium carbonate | as per test |
| 1049 | (I-29) | ammonium benzoate | as per test |
| 1050 | (I-29) | ammonium sulphite | as per test |
| 1051 | (I-29) | ammonium benzoate | as per test |
| 1052 | (I-29) | ammonium hydrogenoxalate | as per test |
| 1053 | (I-29) | ammonium hydrogencitrate | as per test |
| 1054 | (I-29) | ammonium acetate | as per test |
| 1055 | (I-29) | tetramethylammonium sulphate | as per test |
| 1056 | (I-29) | tetramethylammonium lactate | as per test |
| 1057 | (I-29) | tetramethylammonium nitrate | as per test |
| 1058 | (I-29) | tetramethylammonium thiosulphate | as per test |
| 1059 | (I-29) | tetramethylammonium thiocyanate | as per test |
| 1060 | (I-29) | tetramethylammonium citrate | as per test |
| 1061 | (I-29) | tetramethylammonium oxalate | as per test |
| 1062 | (I-29) | tetramethylammonium formate | as per test |
| 1063 | (I-29) | tetramethylammonium hydrogenphosphate | as per test |
| 1064 | (I-29) | tetramethylammonium dihydrogenphosphate | as per test |
| 1065 | (I-29) | tetraethylammonium sulphate | as per test |
| 1066 | (I-29) | tetraethylammonium lactate | as per test |
| 1067 | (I-29) | tetraethylammonium nitrate | as per test |
| 1068 | (I-29) | tetraethylammonium thiosulphate | as per test |
| 1069 | (I-29) | tetraethylammonium thiocyanate | as per test |
| 1070 | (I-29) | tetraethylammonium citrate | as per test |
| 1071 | (I-29) | tetraethylammonium oxalate | as per test |
| 1072 | (I-29) | tetraethylammonium formate | as per test |
| 1072 | (I-29) | tetraethylammonium hydrogenphosphate | as per test |
| 1073 | (I-29) | tetraethylammonium dihydrogenphosphate | as per test |
| 1074 | (I-30) | ammonium sulphate | as per test |
| 1075 | (I-30) | ammonium lactate | as per test |
| 1076 | (I-30) | ammonium nitrate | as per test |
| 1077 | (I-30) | ammonium thiosulphate | as per test |
| 1078 | (I-30) | ammonium thiocyanate | as per test |
| 1079 | (I-30) | ammonium citrate | as per test |
| 1080 | (I-30) | ammonium oxalate | as per test |
| 1081 | (I-30) | ammonium formate | as per test |
| 1082 | (I-30) | ammonium hydrogenphosphate | as per test |
| 1083 | (I-30) | ammonium dihydrogenphosphate | as per test |
| 1084 | (I-30) | ammonium carbonate | as per test |
| 1085 | (I-30) | ammonium benzoate | as per test |
| 1086 | (I-30) | ammonium sulphite | as per test |
| 1087 | (I-30) | ammonium benzoate | as per test |
| 1088 | (I-30) | ammonium hydrogenoxalate | as per test |
| 1089 | (I-30) | ammonium hydrogencitrate | as per test |
| 1090 | (I-30) | ammonium acetate | as per test |
| 1091 | (I-30) | tetramethylammonium sulphate | as per test |
| 1092 | (I-30) | tetramethylammonium lactate | as per test |
| 1093 | (I-30) | tetramethylammonium nitrate | as per test |
| 1094 | (I-30) | tetramethylammonium thiosulphate | as per test |
| 1095 | (I-30) | tetramethylammonium thiocyanate | as per test |
| 1096 | (I-30) | tetramethylammonium citrate | as per test |
| 1097 | (I-30) | tetramethylammonium oxalate | as per test |
| 1098 | (I-30) | tetramethylammonium formate | as per test |
| 1099 | (I-30) | tetramethylammonium hydrogenphosphate | as per test |
| 1100 | (I-30) | tetramethylammonium dihydrogenphosphate | as per test |
| 1101 | (I-30) | tetraethylammonium sulphate | as per test |
| 1102 | (I-30) | tetraethylammonium lactate | as per test |
| 1103 | (I-30) | tetraethylammonium nitrate | as per test |
| 1104 | (I-30) | tetraethylammonium thiosulphate | as per test |
| 1105 | (I-30) | tetraethylammonium thiocyanate | as per test |
| 1106 | (I-30) | tetraethylammonium citrate | as per test |
| 1107 | (I-30) | tetraethylammonium oxalate | as per test |
| 1108 | (I-30) | tetraethylammonium formate | as per test |
| 1109 | (I-30) | tetraethylammonium hydrogenphosphate | as per test |
| 1110 | (I-30) | tetraethylammonium dihydrogenphosphate | as per test |
| 1111 | (I-31) | ammonium sulphate | as per test |
| 1112 | (I-31) | ammonium lactate | as per test |
| 1113 | (I-31) | ammonium nitrate | as per test |
| 1114 | (I-31) | ammonium thiosulphate | as per test |
| 1115 | (I-31) | ammonium thiocyanate | as per test |
| 1116 | (I-31) | ammonium citrate | as per test |
| 1117 | (I-31) | ammonium oxalate | as per test |
| 1118 | (I-31) | ammonium formate | as per test |
| 1119 | (I-31) | ammonium hydrogenphosphate | as per test |
| 1120 | (I-31) | ammonium dihydrogenphosphate | as per test |
| 1121 | (I-31) | ammonium carbonate | as per test |
| 1122 | (I-31) | ammonium benzoate | as per test |
| 1123 | (I-31) | ammonium sulphite | as per test |
| 1124 | (I-31) | ammonium benzoate | as per test |
| 1125 | (I-31) | ammonium hydrogenoxalate | as per test |
| 1126 | (I-31) | ammonium hydrogencitrate | as per test |
| 1127 | (I-31) | ammonium acetate | as per test |
| 1128 | (I-31) | tetramethylammonium sulphate | as per test |
| 1129 | (I-31) | tetramethylammonium lactate | as per test |
| 1130 | (I-31) | tetramethylammonium nitrate | as per test |
| 1131 | (I-31) | tetramethylammonium thiosulphate | as per test |
| 1132 | (I-31) | tetramethylammonium thiocyanate | as per test |
| 1133 | (I-31) | tetramethylammonium citrate | as per test |
| 1134 | (I-31) | tetramethylammonium oxalate | as per test |
| 1135 | (I-31) | tetramethylammonium formate | as per test |
| 1136 | (I-31) | tetramethylammonium hydrogenphosphate | as per test |
| 1137 | (I-31) | tetramethylammonium dihydrogenphosphate | as per test |
| 1138 | (I-31) | tetraethylammonium sulphate | as per test |
| 1130 | (I-31) | tetraethylammonium lactate | as per test |
| 1140 | (I-31) | tetraethylammonium nitrate | as per test |
| 1141 | (I-31) | tetraethylammonium thiosulphate | as per test |
| 1142 | (I-31) | tetraethylammonium thiocyanate | as per test |
| 1143 | (I-31) | tetraethylammonium citrate | as per test |
| 1144 | (I-31) | tetraethylammonium oxalate | as per test |
| 1145 | (I-31) | tetraethylammonium formate | as per test |
| 1146 | (I-31) | tetraethylammonium hydrogenphosphate | as per test |
| 1147 | (I-31) | tetraethylammonium dihydrogenphosphate | as per test |
| 1148 | (I-32) | ammonium sulphate | as per test |
| 1149 | (I-32) | ammonium lactate | as per test |
| 1150 | (I-32) | ammonium nitrate | as per test |
| 1151 | (I-32) | ammonium thiosulphate | as per test |
| 1152 | (I-32) | ammonium thiocyanate | as per test |
| 1153 | (I-32) | ammonium citrate | as per test |
| 1154 | (I-32) | ammonium oxalate | as per test |
| 1155 | (I-32) | ammonium formate | as per test |
| 1156 | (I-32) | ammonium hydrogenphosphate | as per test |
| 1157 | (I-32) | ammonium dihydrogenphosphate | as per test |
| 1158 | (I-32) | ammonium carbonate | as per test |
| 1159 | (I-32) | ammonium benzoate | as per test |
| 1160 | (I-32) | ammonium sulphite | as per test |
| 1161 | (I-32) | ammonium benzoate | as per test |
| 1162 | (I-32) | ammonium hydrogenoxalate | as per test |
| 1163 | (I-32) | ammonium hydrogencitrate | as per test |
| 1164 | (I-32) | ammonium acetate | as per test |
| 1165 | (I-32) | tetramethylammonium sulphate | as per test |
| 1166 | (I-32) | tetramethylammonium lactate | as per test |
| 1167 | (I-32) | tetramethylammonium nitrate | as per test |
| 1168 | (I-32) | tetramethylammonium thiosulphate | as per test |
| 1169 | (I-32) | tetramethylammonium thiocyanate | as per test |
| 1170 | (I-32) | tetramethylammonium citrate | as per test |
| 1171 | (I-32) | tetramethylammonium oxalate | as per test |
| 1172 | (I-32) | tetramethylammonium formate | as per test |
| 1173 | (I-32) | tetramethylammonium hydrogenphosphate | as per test |
| 1174 | (I-32) | tetramethylammonium dihydrogenphosphate | as per test |
| 1175 | (I-32) | tetraethylammonium sulphate | as per test |
| 1176 | (I-32) | tetraethylammonium lactate | as per test |
| 1177 | (I-32) | tetraethylammonium nitrate | as per test |
| 1178 | (I-32) | tetraethylammonium thiosulphate | as per test |
| 1179 | (I-32) | tetraethylammonium thiocyanate | as per test |
| 1180 | (I-32) | tetraethylammonium citrate | as per test |
| 1181 | (I-32) | tetraethylammonium oxalate | as per test |
| 1182 | (I-32) | tetraethylammonium formate | as per test |
| 1183 | (I-32) | tetraethylammonium hydrogenphosphate | as per test |
| 1184 | (I-32) | tetraethylammonium dihydrogenphosphate | as per test |
| 1185 | (I-33) | ammonium sulphate | as per test |
| 1186 | (I-33) | ammonium lactate | as per test |
| 1187 | (I-33) | ammonium nitrate | as per test |
| 1188 | (I-33) | ammonium thiosulphate | as per test |
| 1189 | (I-33) | ammonium thiocyanate | as per test |
| 1190 | (I-33) | ammonium citrate | as per test |
| 1191 | (I-33) | ammonium oxalate | as per test |
| 1192 | (I-33) | ammonium formate | as per test |
| 1193 | (I-33) | ammonium hydrogenphosphate | as per test |
| 1194 | (I-33) | ammonium dihydrogenphosphate | as per test |
| 1195 | (I-33) | ammonium carbonate | as per test |
| 1196 | (I-33) | ammonium benzoate | as per test |
| 1197 | (I-33) | ammonium sulphite | as per test |
| 1198 | (I-33) | ammonium benzoate | as per test |
| 1199 | (I-33) | ammonium hydrogenoxalate | as per test |
| 1200 | (I-33) | ammonium hydrogencitrate | as per test |
| 1201 | (I-33) | ammonium acetate | as per test |
| 1202 | (I-33) | tetramethylammonium sulphate | as per test |
| 1203 | (I-33) | tetramethylammonium lactate | as per test |
| 1204 | (I-33) | tetramethylammonium nitrate | as per test |
| 1205 | (I-33) | tetramethylammonium thiosulphate | as per test |
| 1206 | (I-33) | tetramethylammonium thiocyanate | as per test |
| 1207 | (I-33) | tetramethylammonium citrate | as per test |
| 1208 | (I-33) | tetramethylammonium oxalate | as per test |
| 1209 | (I-33) | tetramethylammonium formate | as per test |
| 1210 | (I-33) | tetramethylammonium hydrogenphosphate | as per test |
| 1211 | (I-33) | tetramethylammonium dihydrogenphosphate | as per test |
| 1212 | (I-33) | tetraethylammonium sulphate | as per test |
| 1213 | (I-33) | tetraethylammonium lactate | as per test |
| 1214 | (I-33) | tetraethylammonium nitrate | as per test |
| 1215 | (I-33) | tetraethylammonium thiosulphate | as per test |
| 1216 | (I-33) | tetraethylammonium thiocyanate | as per test |
| 1217 | (I-33) | tetraethylammonium citrate | as per test |
| 1218 | (I-33) | tetraethylammonium oxalate | as per test |
| 1219 | (I-33) | tetraethylammonium formate | as per test |
| 1220 | (I-33) | tetraethylammonium hydrogenphosphate | as per test |
| 1221 | (I-33) | tetraethylammonium dihydrogenphosphate | as per test |
| 1222 | (I-34) | ammonium sulphate | as per test |
| 1223 | (I-34) | ammonium lactate | as per test |
| 1224 | (I-34) | ammonium nitrate | as per test |
| 1225 | (I-34) | ammonium thiosulphate | as per test |
| 1226 | (I-34) | ammonium thiocyanate | as per test |
| 1227 | (I-34) | ammonium citrate | as per test |
| 1228 | (I-34) | ammonium oxalate | as per test |
| 1229 | (I-34) | ammonium formate | as per test |
| 1230 | (I-34) | ammonium hydrogenphosphate | as per test |
| 1231 | (I-34) | ammonium dihydrogenphosphate | as per test |
| 1232 | (I-34) | ammonium carbonate | as per test |
| 1233 | (I-34) | ammonium benzoate | as per test |
| 1234 | (I-34) | ammonium sulphite | as per test |
| 1235 | (I-34) | ammonium benzoate | as per test |
| 1236 | (I-34) | ammonium hydrogenoxalate | as per test |
| 1237 | (I-34) | ammonium hydrogencitrate | as per test |
| 1238 | (I-34) | ammonium acetate | as per test |
| 1239 | (I-34) | tetramethylammonium sulphate | as per test |
| 1240 | (I-34) | tetramethylammonium lactate | as per test |
| 1241 | (I-34) | tetramethylammonium nitrate | as per test |
| 1242 | (I-34) | tetramethylammonium thiosulphate | as per test |
| 1243 | (I-34) | tetramethylammonium thiocyanate | as per test |
| 1244 | (I-34) | tetramethylammonium citrate | as per test |
| 1245 | (I-34) | tetramethylammonium oxalate | as per test |
| 1246 | (I-34) | tetramethylammonium formate | as per test |
| 1247 | (I-34) | tetramethylammonium hydrogenphosphate | as per test |
| 1248 | (I-34) | tetramethylammonium dihydrogenphosphate | as per test |
| 1249 | (I-34) | tetraethylammonium sulphate | as per test |
| 1250 | (I-34) | tetraethylammonium lactate | as per test |
| 1251 | (I-34) | tetraethylammonium nitrate | as per test |
| 1252 | (I-34) | tetraethylammonium thiosulphate | as per test |
| 1253 | (I-34) | tetraethylammonium thiocyanate | as per test |
| 1254 | (I-34) | tetraethylammonium citrate | as per test |
| 1255 | (I-34) | tetraethylammonium oxalate | as per test |
| 1256 | (I-34) | tetraethylammonium formate | as per test |
| 1257 | (I-34) | tetraethylammonium hydrogenphosphate | as per test |
| 1258 | (I-34) | tetraethylammonium dihydrogenphosphate | as per test |
| 1259 | (I-35) | ammonium sulphate | as per test |
| 1260 | (I-35) | ammonium lactate | as per test |
| 1261 | (I-35) | ammonium nitrate | as per test |
| 1262 | (I-35) | ammonium thiosulphate | as per test |
| 1263 | (I-35) | ammonium thiocyanate | as per test |
| 1264 | (I-35) | ammonium citrate | as per test |
| 1265 | (I-35) | ammonium oxalate | as per test |
| 1266 | (I-35) | ammonium formate | as per test |
| 1267 | (I-35) | ammonium hydrogenphosphate | as per test |
| 1268 | (I-35) | ammonium dihydrogenphosphate | as per test |
| 1269 | (I-35) | ammonium carbonate | as per test |
| 1270 | (I-35) | ammonium benzoate | as per test |
| 1271 | (I-35) | ammonium sulphite | as per test |
| 1272 | (I-35) | ammonium benzoate | as per test |
| 1273 | (I-35) | ammonium hydrogenoxalate | as per test |
| 1274 | (I-35) | ammonium hydrogencitrate | as per test |
| 1275 | (I-35) | ammonium acetate | as per test |
| 1276 | (I-35) | tetramethylammonium sulphate | as per test |
| 1277 | (I-35) | tetramethylammonium lactate | as per test |
| 1278 | (I-35) | tetramethylammonium nitrate | as per test |
| 1279 | (I-35) | tetramethylammonium thiosulphate | as per test |
| 1280 | (I-35) | tetramethylammonium thiocyanate | as per test |
| 1281 | (I-35) | tetramethylammonium citrate | as per test |
| 1282 | (I-35) | tetramethylammonium oxalate | as per test |
| 1283 | (I-35) | tetramethylammonium formate | as per test |
| 1284 | (I-35) | tetramethylammonium hydrogenphosphate | as per test |
| 1285 | (I-35) | tetramethylammonium dihydrogenphosphate | as per test |
| 1286 | (I-35) | tetraethylammonium sulphate | as per test |
| 1287 | (I-35) | tetraethylammonium lactate | as per test |
| 1288 | (I-35) | tetraethylammonium nitrate | as per test |
| 1289 | (I-35) | tetraethylammonium thiosulphate | as per test |
| 1290 | (I-35) | tetraethylammonium thiocyanate | as per test |
| 1291 | (I-35) | tetraethylammonium citrate | as per test |
| 1292 | (I-35) | tetraethylammonium oxalate | as per test |
| 1293 | (I-35) | tetraethylammonium formate | as per test |
| 1294 | (I-35) | tetraethylammonium hydrogenphosphate | as per test |
| 1295 | (I-35) | tetraethylammonium dihydrogenphosphate | as per test |
| 1296 | (I-36) | ammonium sulphate | as per test |
| 1297 | (I-36) | ammonium lactate | as per test |
| 1298 | (I-36) | ammonium nitrate | as per test |
| 1299 | (I-36) | ammonium thiosulphate | as per test |
| 1300 | (I-36) | ammonium thiocyanate | as per test |
| 1301 | (I-36) | ammonium citrate | as per test |
| 1302 | (I-36) | ammonium oxalate | as per test |
| 1303 | (I-36) | ammonium formate | as per test |
| 1304 | (I-36) | ammonium hydrogenphosphate | as per test |
| 1305 | (I-36) | ammonium dihydrogenphosphate | as per test |
| 1306 | (I-36) | ammonium carbonate | as per test |
| 1307 | (I-36) | ammonium benzoate | as per test |
| 1308 | (I-36) | ammonium sulphite | as per test |
| 1309 | (I-36) | ammonium benzoate | as per test |
| 1310 | (I-36) | ammonium hydrogenoxalate | as per test |
| 1311 | (I-36) | ammonium hydrogencitrate | as per test |
| 1312 | (I-36) | ammonium acetate | as per test |
| 1313 | (I-36) | tetramethylammonium sulphate | as per test |
| 1314 | (I-36) | tetramethylammonium lactate | as per test |
| 1315 | (I-36) | tetramethylammonium nitrate | as per test |
| 1316 | (I-36) | tetramethylammonium thiosulphate | as per test |
| 1317 | (I-36) | tetramethylammonium thiocyanate | as per test |
| 1318 | (I-36) | tetramethylammonium citrate | as per test |
| 1319 | (I-36) | tetramethylammonium oxalate | as per test |
| 1320 | (I-36) | tetramethylammonium formate | as per test |
| 1321 | (I-36) | tetramethylammonium hydrogenphosphate | as per test |
| 1322 | (I-36) | tetramethylammonium dihydrogenphosphate | as per test |
| 1323 | (I-36) | tetraethylammonium sulphate | as per test |
| 1324 | (I-36) | tetraethylammonium lactate | as per test |
| 1325 | (I-36) | tetraethylammonium nitrate | as per test |
| 1326 | (I-36) | tetraethylammonium thiosulphate | as per test |
| 1327 | (I-36) | tetraethylammonium thiocyanate | as per test |
| 1328 | (I-36) | tetraethylammonium citrate | as per test |
| 1329 | (I-36) | tetraethylammonium oxalate | as per test |
| 1330 | (I-36) | tetraethylammonium formate | as per test |
| 1331 | (I-36) | tetraethylammonium hydrogenphosphate | as per test |
| 1332 | (I-36) | tetraethylammonium dihydrogenphosphate | as per test |
| 1333 | (I-37) | ammonium sulphate | as per test |
| 1334 | (I-37) | ammonium lactate | as per test |
| 1335 | (I-37) | ammonium nitrate | as per test |
| 1336 | (I-37) | ammonium thiosulphate | as per test |
| 1337 | (I-37) | ammonium thiocyanate | as per test |
| 1338 | (I-37) | ammonium citrate | as per test |
| 1339 | (I-37) | ammonium oxalate | as per test |
| 1340 | (I-37) | ammonium formate | as per test |
| 1341 | (I-37) | ammonium hydrogenphosphate | as per test |
| 1342 | (I-37) | ammonium dihydrogenphosphate | as per test |
| 1343 | (I-37) | ammonium carbonate | as per test |
| 1344 | (I-37) | ammonium benzoate | as per test |
| 1345 | (I-37) | ammonium sulphite | as per test |
| 1346 | (I-37) | ammonium benzoate | as per test |
| 1347 | (I-37) | ammonium hydrogenoxalate | as per test |
| 1348 | (I-37) | ammonium hydrogencitrate | as per test |
| 1349 | (I-37) | ammonium acetate | as per test |
| 1350 | (I-37) | tetramethylammonium sulphate | as per test |
| 1351 | (I-37) | tetramethylammonium lactate | as per test |
| 1352 | (I-37) | tetramethylammonium nitrate | as per test |
| 1353 | (I-37) | tetramethylammonium thiosulphate | as per test |
| 1354 | (I-37) | tetramethylammonium thiocyanate | as per test |
| 1355 | (I-37) | tetramethylammonium citrate | as per test |
| 1356 | (I-37) | tetramethylammonium oxalate | as per test |
| 1357 | (I-37) | tetramethylammonium formate | as per test |
| 1358 | (I-37) | tetramethylammonium hydrogenphosphate | as per test |
| 1359 | (I-37) | tetramethylammonium dihydrogenphosphate | as per test |
| 1360 | (I-37) | tetraethylammonium sulphate | as per test |
| 1361 | (I-37) | tetraethylammonium lactate | as per test |
| 1362 | (I-37) | tetraethylammonium nitrate | as per test |
| 1363 | (I-37) | tetraethylammonium thiosulphate | as per test |
| 1364 | (I-37) | tetraethylammonium thiocyanate | as per test |
| 1365 | (I-37) | tetraethylammonium citrate | as per test |
| 1366 | (I-37) | tetraethylammonium oxalate | as per test |
| 1367 | (I-37) | tetraethylammonium formate | as per test |
| 1368 | (I-37) | tetraethylammonium hydrogenphosphate | as per test |
| 1369 | (I-37) | tetraethylammonium dihydrogenphosphate | as per test |
| 1370 | (I-38) | ammonium sulphate | as per test |
| 1371 | (I-38) | ammonium lactate | as per test |
| 1372 | (I-38) | ammonium nitrate | as per test |
| 1373 | (I-38) | ammonium thiosulphate | as per test |
| 1374 | (I-38) | ammonium thiocyanate | as per test |
| 1375 | (I-38) | ammonium citrate | as per test |
| 1376 | (I-38) | ammonium oxalate | as per test |
| 1377 | (I-38) | ammonium formate | as per test |
| 1378 | (I-38) | ammonium hydrogenphosphate | as per test |
| 1379 | (I-38) | ammonium dihydrogenphosphate | as per test |
| 1380 | (I-38) | ammonium carbonate | as per test |
| 1381 | (I-38) | ammonium benzoate | as per test |
| 1382 | (I-38) | ammonium sulphite | as per test |
| 1383 | (I-38) | ammonium benzoate | as per test |
| 1384 | (I-38) | ammonium hydrogenoxalate | as per test |
| 1385 | (I-38) | ammonium hydrogencitrate | as per test |
| 1386 | (I-38) | ammonium acetate | as per test |
| 1387 | (I-38) | tetramethylammonium sulphate | as per test |
| 1388 | (I-38) | tetramethylammonium lactate | as per test |
| 1389 | (I-38) | tetramethylammonium nitrate | as per test |
| 1390 | (I-38) | tetramethylammonium thiosulphate | as per test |
| 1391 | (I-38) | tetramethylammonium thiocyanate | as per test |
| 1392 | (I-38) | tetramethylammonium citrate | as per test |
| 1393 | (I-38) | tetramethylammonium oxalate | as per test |
| 1394 | (I-38) | tetramethylammonium formate | as per test |
| 1395 | (I-38) | tetramethylammonium hydrogenphosphate | as per test |
| 1396 | (I-38) | tetramethylammonium dihydrogenphosphate | as per test |
| 1397 | (I-38) | tetraethylammonium sulphate | as per test |
| 1398 | (I-38) | tetraethylammonium lactate | as per test |
| 1399 | (I-38) | tetraethylammonium nitrate | as per test |
| 1400 | (I-38) | tetraethylammonium thiosulphate | as per test |
| 1401 | (I-38) | tetraethylammonium thiocyanate | as per test |
| 1402 | (I-38) | tetraethylammonium citrate | as per test |
| 1403 | (I-38) | tetraethylammonium oxalate | as per test |
| 1404 | (I-38) | tetraethylammonium formate | as per test |
| 1405 | (I-38) | tetraethylammonium hydrogenphosphate | as per test |
| 1406 | (I-38) | tetraethylammonium dihydrogenphosphate | as per test |
| 1407 | (I-39) | ammonium sulphate | as per test |
| 1408 | (I-39) | ammonium lactate | as per test |
| 1409 | (I-39) | ammonium nitrate | as per test |
| 1410 | (I-39) | ammonium thiosulphate | as per test |
| 1411 | (I-39) | ammonium thiocyanate | as per test |
| 1412 | (I-39) | ammonium citrate | as per test |
| 1413 | (I-39) | ammonium oxalate | as per test |
| 1414 | (I-39) | ammonium formate | as per test |
| 1415 | (I-39) | ammonium hydrogenphosphate | as per test |
| 1416 | (I-39) | ammonium dihydrogenphosphate | as per test |
| 1417 | (I-39) | ammonium carbonate | as per test |
| 1418 | (I-39) | ammonium benzoate | as per test |
| 1419 | (I-39) | ammonium sulphite | as per test |
| 1420 | (I-39) | ammonium benzoate | as per test |
| 1421 | (I-39) | ammonium hydrogenoxalate | as per test |
| 1422 | (I-39) | ammonium hydrogencitrate | as per test |
| 1423 | (I-39) | ammonium acetate | as per test |
| 1424 | (I-39) | tetramethylammonium sulphate | as per test |
| 1425 | (I-39) | tetramethylammonium lactate | as per test |
| 1426 | (I-39) | tetramethylammonium nitrate | as per test |
| 1427 | (I-39) | tetramethylammonium thiosulphate | as per test |
| 1428 | (I-39) | tetramethylammonium thiocyanate | as per test |
| 1429 | (I-39) | tetramethylammonium citrate | as per test |
| 1430 | (I-39) | tetramethylammonium oxalate | as per test |
| 1431 | (I-39) | tetramethylammonium formate | as per test |
| 1432 | (I-39) | tetramethylammonium hydrogenphosphate | as per test |
| 1433 | (I-39) | tetramethylammonium dihydrogenphosphate | as per test |
| 1434 | (I-39) | tetraethylammonium sulphate | as per test |
| 1435 | (I-39) | tetraethylammonium lactate | as per test |
| 1436 | (I-39) | tetraethylammonium nitrate | as per test |
| 1437 | (I-39) | tetraethylammonium thiosulphate | as per test |
| 1438 | (I-39) | tetraethylammonium thiocyanate | as per test |
| 1439 | (I-39) | tetraethylammonium citrate | as per test |
| 1440 | (I-39) | tetraethylammonium oxalate | as per test |
| 1441 | (I-39) | tetraethylammonium formate | as per test |
| 1442 | (I-39) | tetraethylammonium hydrogenphosphate | as per test |
| 1443 | (I-39) | tetraethylammonium dihydrogenphosphate | as per test |
| 1444 | (I-40) | ammonium sulphate | as per test |
| 1445 | (I-40) | ammonium lactate | as per test |
| 1446 | (I-40) | ammonium nitrate | as per test |
| 1447 | (I-40) | ammonium thiosulphate | as per test |
| 1448 | (I-40) | ammonium thiocyanate | as per test |
| 1449 | (I-40) | ammonium citrate | as per test |
| 1450 | (I-40) | ammonium oxalate | as per test |
| 1451 | (I-40) | ammonium formate | as per test |
| 1452 | (I-40) | ammonium hydrogenphosphate | as per test |
| 1453 | (I-40) | ammonium dihydrogenphosphate | as per test |
| 1454 | (I-40) | ammonium carbonate | as per test |
| 1455 | (I-40) | ammonium benzoate | as per test |
| 1456 | (I-40) | ammonium sulphite | as per test |
| 1457 | (I-40) | ammonium benzoate | as per test |
| 1458 | (I-40) | ammonium hydrogenoxalate | as per test |
| 1459 | (I-40) | ammonium hydrogencitrate | as per test |
| 1460 | (I-40) | ammonium acetate | as per test |
| 1461 | (I-40) | tetramethylammonium sulphate | as per test |
| 1462 | (I-40) | tetramethylammonium lactate | as per test |
| 1463 | (I-40) | tetramethylammonium nitrate | as per test |
| 1464 | (I-40) | tetramethylammonium thiosulphate | as per test |
| 1465 | (I-40) | tetramethylammonium thiocyanate | as per test |
| 1466 | (I-40) | tetramethylammonium citrate | as per test |
| 1467 | (I-40) | tetramethylammonium oxalate | as per test |
| 1468 | (I-40) | tetramethylammonium formate | as per test |
| 1469 | (I-40) | tetramethylammonium hydrogenphosphate | as per test |
| 1470 | (I-40) | tetramethylammonium dihydrogenphosphate | as per test |
| 1471 | (I-40) | tetraethylammonium sulphate | as per test |
| 1472 | (I-40) | tetraethylammonium lactate | as per test |
| 1473 | (I-40) | tetraethylammonium nitrate | as per test |
| 1474 | (I-40) | tetraethylammonium thiosulphate | as per test |
| 1475 | (I-40) | tetraethylammonium thiocyanate | as per test |
| 1476 | (I-40) | tetraethylammonium citrate | as per test |
| 1477 | (I-40) | tetraethylammonium oxalate | as per test |
| 1478 | (I-40) | tetraethylammonium formate | as per test |
| 1479 | (I-40) | tetraethylammonium hydrogenphosphate | as per test |
| 1480 | (I-40) | tetraethylammonium dihydrogenphosphate | as per test |
| 1481 | (I-41) | ammonium sulphate | as per test |
| 1482 | (I-41) | ammonium lactate | as per test |
| 1483 | (I-41) | ammonium nitrate | as per test |
| 1484 | (I-41) | ammonium thiosulphate | as per test |
| 1485 | (I-41) | ammonium thiocyanate | as per test |
| 1486 | (I-41) | ammonium citrate | as per test |
| 1487 | (I-41) | ammonium oxalate | as per test |
| 1488 | (I-41) | ammonium formate | as per test |
| 1489 | (I-41) | ammonium hydrogenphosphate | as per test |
| 1490 | (I-41) | ammonium dihydrogenphosphate | as per test |
| 1491 | (I-41) | ammonium carbonate | as per test |
| 1492 | (I-41) | ammonium benzoate | as per test |
| 1493 | (I-41) | ammonium sulphite | as per test |
| 1494 | (I-41) | ammonium benzoate | as per test |
| 1495 | (I-41) | ammonium hydrogenoxalate | as per test |
| 1496 | (I-41) | ammonium hydrogencitrate | as per test |
| 1497 | (I-41) | ammonium acetate | as per test |
| 1498 | (I-41) | tetramethylammonium sulphate | as per test |
| 1499 | (I-41) | tetramethylammonium lactate | as per test |
| 1500 | (I-41) | tetramethylammonium nitrate | as per test |
| 1501 | (I-41) | tetramethylammonium thiosulphate | as per test |
| 1502 | (I-41) | tetramethylammonium thiocyanate | as per test |
| 1503 | (I-41) | tetramethylammonium citrate | as per test |
| 1504 | (I-41) | tetramethylammonium oxalate | as per test |
| 1505 | (I-41) | tetramethylammonium formate | as per test |
| 1506 | (I-41) | tetramethylammonium hydrogenphosphate | as per test |
| 1507 | (I-41) | tetramethylammonium dihydrogenphosphate | as per test |
| 1508 | (I-41) | tetraethylammonium sulphate | as per test |
| 1509 | (I-41) | tetraethylammonium lactate | as per test |
| 1510 | (I-41) | tetraethylammonium nitrate | as per test |
| 1511 | (I-41) | tetraethylammonium thiosulphate | as per test |
| 1512 | (I-41) | tetraethylammonium thiocyanate | as per test |
| 1513 | (I-41) | tetraethylammonium citrate | as per test |
| 1514 | (I-41) | tetraethylammonium oxalate | as per test |
| 1515 | (I-41) | tetraethylammonium formate | as per test |
| 1516 | (I-41) | tetraethylammonium hydrogenphosphate | as per test |
| 1517 | (I-41) | tetraethylammonium dihydrogenphosphate | as per test |
| 1518 | (I-42) | ammonium sulphate | as per test |
| 1519 | (I-42) | ammonium lactate | as per test |
| 1520 | (I-42) | ammonium nitrate | as per test |
| 1521 | (I-42) | ammonium thiosulphate | as per test |
| 1522 | (I-42) | ammonium thiocyanate | as per test |
| 1523 | (I-42) | ammonium citrate | as per test |
| 1524 | (I-42) | ammonium oxalate | as per test |
| 1525 | (I-42) | ammonium formate | as per test |
| 1526 | (I-42) | ammonium hydrogenphosphate | as per test |
| 1527 | (I-42) | ammonium dihydrogenphosphate | as per test |
| 1528 | (I-42) | ammonium carbonate | as per test |
| 1529 | (I-42) | ammonium benzoate | as per test |
| 1530 | (I-42) | ammonium sulphite | as per test |
| 1531 | (I-42) | ammonium benzoate | as per test |
| 1532 | (I-42) | ammonium hydrogenoxalate | as per test |
| 1533 | (I-42) | ammonium hydrogencitrate | as per test |
| 1534 | (I-42) | ammonium acetate | as per test |
| 1535 | (I-42) | tetramethylammonium sulphate | as per test |
| 1536 | (I-42) | tetramethylammonium lactate | as per test |
| 1537 | (I-42) | tetramethylammonium nitrate | as per test |
| 1538 | (I-42) | tetramethylammonium thiosulphate | as per test |
| 1539 | (I-42) | tetramethylammonium thiocyanate | as per test |
| 1540 | (I-42) | tetramethylammonium citrate | as per test |
| 1541 | (I-42) | tetramethylammonium oxalate | as per test |
| 1542 | (I-42) | tetramethylammonium formate | as per test |
| 1543 | (I-42) | tetramethylammonium hydrogenphosphate | as per test |
| 1544 | (I-42) | tetramethylammonium dihydrogenphosphate | as per test |
| 1545 | (I-42) | tetraethylammonium sulphate | as per test |
| 1546 | (I-42) | tetraethylammonium lactate | as per test |
| 1547 | (I-42) | tetraethylammonium nitrate | as per test |
| 1548 | (I-42) | tetraethylammonium thiosulphate | as per test |
| 1549 | (I-42) | tetraethylammonium thiocyanate | as per test |
| 1550 | (I-42) | tetraethylammonium citrate | as per test |
| 1551 | (I-42) | tetraethylammonium oxalate | as per test |
| 1552 | (I-42) | tetraethylammonium formate | as per test |
| 1553 | (I-42) | tetraethylammonium hydrogenphosphate | as per test |
| 1554 | (I-42) | tetraethylammonium dihydrogenphosphate | as per test |

The compositions according to the invention may also comprise further components, for example surfactants (non-ionic or anionic) or dispersants or emulsifiers.

Suitable non-ionic surfactants or dispersants are all substances of this type which are customarily used in agrochemical compositions. Polyethylene oxide/polypropylene oxide block copolymers, polyethylene glycol ethers of straight-chain alcohols, reaction products of fatty acids with ethylene oxide and/or propylene oxide, furthermore polyvinyl alcohol, polyvinylpyrrolidone, mixed polymers of polyvinyl alcohol and polyvinylpyrrolidone and copolymers of (meth)acrylic acid and (meth)acrylic esters, furthermore alkyl ethoxylates and alkylaryl ethoxylates which may optionally be phosphated and may optionally be neutralized with bases, by way of example sorbitol ethoxylates, and also polyoxyalkyleneamine derivatives may be mentioned as being preferred.

Suitable anionic surfactants are all substances of this type which are customarily used in agrochemical compositions. Alkali metal and alkaline earth metal salts of alkylsulphonic acids or alkylarylsulphonic acids are preferred.

A further preferred group of anionic surfactants or dispersants are sparingly vegetable oil-soluble salts of polystyrenesulphonic acids, salts of polyvinylsulphonic acids, salts of naphthalenesulphonic acid/formaldehyde condensates, salts of condensates of naphthalenesulphonic acid, phenolsulphonic acid and formaldehyde and also salts of lignosulphonic acid.

Additives which may be present in the formulations according to the invention are emulsifiers, antifoams, preservatives, antioxidants, colorants and inert fillers.

Preferred emulsifiers are ethoxylated nonylphenol, reactants of alkylphenols with ethylene oxide and/or propylene oxide, ethoxylated arylalkylphenols, furthermore ethoxylated and propoxylated arylalkylphenols, and also sulphated or phosphated arylalkyl ethoxylates or arylalkyl ethoxypropoxylates, examples being sorbitan derivatives such as polyethylene oxide/sorbitan fatty esters and sorbitan fatty esters.

In addition to the cyclic carbonylamidine derivatives according to the invention, the composition according to the invention may comprise further active compounds including synergists and fertilizers. Synergists are compounds which increase the activity of the active compounds, without it being necessary for the synergist added to be active itself. Suitable active compounds include insecticides, attractants, sterilants, bactericides, acaricides, nematicides, fungicides, growth regulators, herbicides, safeners and messengers (=semiochemicals, for example pheromones, allomones, or kairomones).

Compounds which are suitable according to the invention are, for example, the following insecticides, acaricides or nematicides:

(In1) Acetylcholinesterase (AChE) inhibitors, such as, for example, carbamates, for example alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, for example acephate, azamethiphos, azinphos (-methyl, -ethyl), cadusafos, chlorethoxyfos, chlorfenvinphos, chlormephos, chlorpyrifos (-methyl), coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion (-methyl), phenthoate, phorate, phosalone, phosmet, phosphamidon, phoxim, pirimiphos (-methyl), profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(In2) GABA-gated chloride channel antagonists, such as, for example, organochlorines, for example chlordane and endosulfan (alpha-); or fiproles (phenylpyrazoles), for example ethiprole, fipronil, pyrafluprole and pyriprole.

(In3) Sodium channel modulators/voltage-gated sodium channel blockers, such as, for example, pyrethroids, for example acrinathrin, allethrin (d-cis-trans, d-trans), bifenthrin, bioallethrin, bioallethrin-S-cyclopentenyl, bioresmethrin, cycloprothrin, cyfluthrin (beta-), cyhalothrin (gamma-, lambda-), cypermethrin (alpha-, beta-, theta-, zeta-), cyphenothrin [(1R)-trans-isomers], deltamethrin, dimefluthrin, empenthrin [(EZ)-(1R)-isomers], esfenvalerate, etofenprox, fenpropathrin, fenvalerate, flucythrinate, flumethrin, fluvalinate (tau-), halfenprox, imiprothrin, metofluthrin, permethrin, phenothrin [(1R)-trans-isomer], prallethrin, profluthrin, pyrethrins (pyrethrum), resmethrin, RU 15525, silafluofen, tefluthrin, tetramethrin [(1R)-isomers], tralomethrin, transfluthrin and ZXI 8901; or DDT; or methoxychlor.

(In4) Nicotinergic acetylcholine receptor agonists, such as, for example, neonicotinoids, for example acetamiprid, clothianidin, dinotefuran, imidacloprid, nitenpyram, thiacloprid, thiamethoxam; or nicotine.

(In5) Allosteric acetylcholine receptor modulators (agonists), such as, for example, spinosyns, for example spinetoram and spinosad.

(In6) Chloride channel activators, such as, for example, avermectins/milbemycins, for example abamectin, emamectin benzoate, lepimectin and milbemectin.

(In7) Juvenile hormone mimics, for example, hydroprene, kinoprene, methoprene; or fenoxycarb; pyriproxyfen.

(In8) Active compounds having an unknown or unspecific mechanism of action, such as, for example, fumigants, for example methyl bromide and other alkyl halides; or chloropicrin; sulphuryl fluoride; borax; tartar emetic.

(In9) Selective antifeedants, for example pymetrozine; or flonicamid.

(In10) Mite growth inhibitors, for example clofentezine, diflovidazin, hexythiazox, etoxazole.

(In11) Microbial disruptors of the insect gut membrane, such as, for example, Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins, for example Cry1Ab, Cry1Ac, Cry1Fa, Cry2Ab, mCry3A, Cry3Ab, Cry3Bb, Cry34/35Ab1.

(In12) Oxidative phosphorylation inhibitors, ATP disruptors, such as, for example, diafenthiuron; or organotin compounds, for example azocyclotin, cyhexatin, fenbutatin oxide; or propargite; tetradifon.

(In13) Oxidative phosphorylation decouplers acting by interrupting the H proton gradient, such as, for example, chlorfenapyr and DNOC.

(In14) Nicotinergic acetylcholine receptor antagonists, such as, for example, bensultap, cartap (hydrochloride), thiocylam, and hiosultap (-sodium).

(I15) Chitin biosynthesis inhibitors, type 0, such as, for example, benzoylureas, for example bistrifluoron, chlorfluazuron, diflubenzuron, flucycloxuron, flufenoxuron, hexaflumuron, lufenuron, novaluron, noviflumuron, teflubenzuron and triflumuron.

(In16) Chitin biosynthesis inhibitors, type 1, such as, for example, buprofezin.

(In17) Moulting disruptors, such as, for example, cyromazine.

(In18) Ecdysone agonists/disruptors, such as, for example, diacylhydrazines, for example chromafenozide, halofenozide, methoxyfenozide and tebufenozide.

(In19) Octopaminergic agonists, such as, for example, amitraz.

(In20) Complex-III electron transport inhibitors, such as, for example, hydramethylnon; acequinocyl; fluacrypyrim.

(In21) Complex-I electron transport inhibitors, for example from the group of the METI acaricides, for example fenazaquin, fenpyroximate, pyrimidifen, pyridaben, tebufenpyrad, tolfenpyrad; or rotenone (Derris).

(In22) Voltage-gated sodium channel blockers, for example indoxacarb; metaflumizone.

(In23) Inhibitors of acetyl-CoA carboxylase, such as, for example, tetronic acid derivatives, for example spirodiclofen and spiromesifen; or tetramic acid derivatives, for example spirotetramat.

(In24) Complex-IV electron transport inhibitors, such as, for example, phosphines, for example aluminium phosphide, calcium phosphide, phosphine, zinc phosphide; or cyanide.

(In25) Complex-II electron transport inhibitors, such as, for example, cyenopyrafen.

(In28) Ryanodine receptor effectors, such as, for example, diamides, for example flubendiamide, chlorantraniliprole (Rynaxypyr), cyantraniliprole (Cyazypyr) and also 3-bromo-N-{2-bromo-4-chloro-6-[(1-cyclopropylethyl)carbamoyl]phenyl}-1-(3-chloropyridin-2-yl)-1H-pyrazole-5-carboxamide (known from WO2005/077934) or methyl 2-[3,5-dibromo-2-({[3-bromo-1-(3-chloropyridin-2-yl)-1H-pyrazol-5-yl]carbonyl}amino)benzoyl]-1,2-dimethylhydrazinecarboxylate (known from WO2007/043677).

(In29) Further active compounds with an unknown mechanism of action, such as, for example, azadirachtin, amidoflumet, benzoximate, bifenazate, chinomethionat, cryolite, cyflumetofen, dicofol, fluensulfone (5-chloro-2-[(3,4,4-trifluorobut-3-en-1-yl)sulphonyl]-1,3-thiazole), flufenerim, pyridalyl and pyrifluquinazon; furthermore products based on Bacillus firmus (I-1582, BioNeem, Votivo) and also the following known active compounds: 4-{[(6-bromopyrid-3-yl)methyl](2-fluoro-ethyl)amino}furan-2(5H)-one (known from WO 2007/115644), 4-{[(6-fluoropyrid-3-yl)methyl](2,2-difluoroethyl)amino}furan-2(5H)-one (known from WO 2007/115644), 4-{[(2-chloro-1,3-thiazol-5-yl)methyl](2-fluoroethyl)amino}furan-2(5H)-one (known from WO 2007/115644), 4-{[(6-chloropyrid-3-yl)methyl](2-fluoroethyl)amino}furan-2(5H)-one (known from WO 2007/115644), 4-{[(6-chloropyrid-3-yl)methyl](2,2-difluoroethyl)amino}furan-2(5H)-one (known from WO 2007/115644), 4-{[(6-chloro-5-fluoropyrid-3-yl)methyl](methyl)amino}furan-2(5H)-one (known from WO 2007/115643), 4-{[(5,6-dichloropyrid-3-yl)methyl](2-fluoroethyl)amino}furan-2(5H)-one (known from WO 2007/115646), 4-{[(6-chloro-5-fluoropyrid-3-yl)methyl](cyclopropyl)amino}furan-2(5H)-one (known from WO 2007/115643), 4-{[(6-chloropyrid-3-yl)methyl](cyclopropyl)amino}furan-2(5H)-one (known from EP-A-0 539 588), 4-{[(6-chloropyrid-3-yl)methyl](methyl)amino}furan-2(5H)-one (known from EP-A-0 539 588), {[1-(6-chloropyridin-3-yl)ethyl](methyl)oxido-λ4-sulphanylidenecyanamide (known from WO 2007/149134) and its diastereomers {[(1R)-1-(6-chloropyridin-3-yl)ethyl](methyl)oxido-λ⁴-sulfanyliden}cyanamide (A) and {[(1S)-1-(6-chloropyridin-3-yl)ethyl](methyl)oxido-λ⁴-sulfanyliden}cyanamide (B)

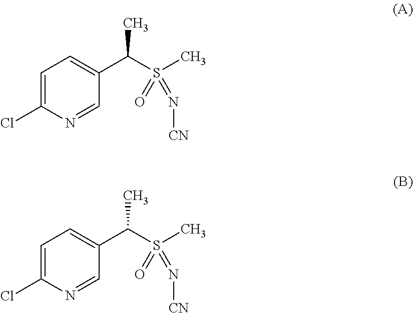

(likewise known from WO 2007/149134), as well as sulfoxaflor (likewise known from WO 2007/149134) and its diastereomers [(R)-methyl(oxido) {(1R)-1-[6-(trifluoromethyl)pyridin-3-yl]ethyl}-λ⁴-sulfanyliden]cyanamide (A1) and [(S)-methyl(oxido){(1S)-1-[6-(trifluoromethyl)pyridin-3-yl]ethyl}-λ⁴-sulfanyliden]cyanamide (A2), named as group of diastereomers A (known from WO 2010/074747, WO 2010/074751), [(R)-methyl(oxido) {(1S)-1-[6-(trifluoromethyl)pyridin-3-yl]ethyl}-λ⁴-sulfanyliden]cyanamide (B1) and [(S)-methyl(oxido) {(1R)-1-[6-(trifluoromethyl)pyridin-3-yl]ethyl}-λ⁴-sulfanyliden]cyanamide (B2), named as group of diastereomers B (likewise known from WO 2010/074751) and 11-(4-chloro-2,6-dimethylphenyl)-12-hydroxy-1,4-dioxa-9-azadispiro[4.2.4.2]tetradec-11-en-10-one (known from WO 2006/089633), 3-(4′-fluoro-2,4-dimethylbiphenyl-3-yl)-4-hydroxy-8-oxa-1-azaspiro[4.5]dec-3-en-2-one (known from WO 2008/067911), 1-[2-fluoro-4-methyl-5-[(2,2,2-trifluoroethyl)sulphinyl]phenyl]-3-(trifluoromethyl)-1H-1,2,4-triazole-5-amine (known from WO 2006/043635), [(3S,4aR,12R,12aS,12bS)-3-[(cyclopropylcarbonyl)oxy]-6,12-dihydroxy-4,12b-dimethyl-11-oxo-9-(pyridin-3-yl)-1,3,4,4a,5,6,6a,12,12a,12b-decahydro-2H,11H-benzo[f]pyrano[4,3-b]chromen-4-yl]methylcyclopropane carboxylate (known from WO 2006/129714), 2-cyano-3-(difluoromethoxy)-N,N-dimethylbenzenesulphonamide (known from WO2006/056433), 2-cyano-3-(difluoromethoxy)-N-methylbenzenesulphonamide (known from WO2006/100288), 2-cyano-3-(difluoromethoxy)-N-ethylbenzenesulphonamide (known from WO2005/035486), 4-(difluoromethoxy)-N-ethyl-N-methyl-1,2-benzothiazole-3-amine 1,1-dioxide (known from WO2007/057407) and N-[1-(2,3-dimethylphenyl)-2-(3,5-dimethylphenyl)ethyl]-4,5-dihydro-1,3-thiazole-2-amine (known from WO2008/104503).

Compounds which are suitable according to the invention are, for example, the following fungicides:

(F1) Ergosterol biosynthesis inhibitors, such as, for example, aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulphate, imibenconazole, ipconazole, metconazole, myclobutanil, naftifine, nuarimol, oxpoconazole, paclobutrazol, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, uniconazole-p, viniconazole, voriconazole, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N′-{5-(difluoromethyl)-2-methyl-4-[3-(trimethylsilyl)propoxy]phenyl}-N-ethyl-N-methylimidoformamide, N-ethyl-N-methyl-N′-{2-methyl-5-(trifluoromethyl)-4-[3-(trimethylsilyl)propoxy]phenyl}imidoformamide and O-[1-(4-methoxyphenoxy)-3,3-dimethylbutan-2-yl]-1H-imidazole-1-carbothioate.

(F2) Respiration inhibitors (respiratory-chain inhibitors), such as, for example, bixafen, boscalid, carboxin, diflumetorim, fenfuram, fluopyram, flutolanil, fluxapyroxad, furametpyr, furmecyclox, isopyrazam mixture of the syn-epimeric racemate 1RS,4SR,9RS and of the anti-epimeric racemate 1RS,4SR,9SR, isopyrazam (anti-epimeric racemate), isopyrazam (anti-epimeric enantiomer 1R,4S,9S), isopyrazam (anti-epimeric enantiomer 1S,4R,9R), isopyrazam (syn-epimeric racemate 1RS,4SR,9RS), isopyrazam (syn-epimeric enantiomer 1R,4S,9R), isopyrazam (syn-epimeric enantiomer 1S,4R,9S), mepronil, oxycarboxin, penflufen, penthiopyrad, sedaxane, thifluzamid, 1-methyl-N-[2-(1,1,2,2-tetrafluoroethoxy)phenyl]-3-(trifluoromethyl)-1H-pyrazole-4-carboxamide, 3-(difluoromethyl)-1-methyl-N-[2-(1,1,2,2-tetrafluoroethoxy)phenyl]-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide and N-[1-(2,4-dichlorophenyl)-1-methoxypropan-2-yl]-3-(difluoromethyl)-1-methyl-1H-pyrazole-4-carboxamide.

(F3) Respiration inhibitors (respiratory-chain inhibitors) on the complex III of the respiratory chain, such as, for example, ametoctradin, amisulbrom, azoxystrobin, cyazofamid, dimoxystrobin, enestroburin, famoxadon, fenamidon, fluoxastrobin, kresoxim-methyl, metominostrobin, orysastrobin, picoxystrobin, pyraclostrobin, pyrametostrobin, pyraoxystrobin, pyribencarb, trifloxystrobin, (2E)-2-(2-{[6-(3-chloro-2-methylphenoxy)-5-fluoropyrimidin-4-yl]oxy}phenyl)-2-(methoxyimino)-N-methylethanamide, (2E)-2-(methoxyimino)-N-methyl-2-(2-{[({(1E)-1-[3-(trifluoromethyl)phenyl]-ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, (2E)-2-{2-[({[(2E,3E)-4-(2,6-dichlorophenyl)but-3-en-2-ylidene]amino}-oxy)methyl]phenyl}-2-(methoxyimino)-N-methylethanamide, 2-chloro-N-(1,1,3-trimethyl-2,3-dihydro-1H-inden-4-yl)pyridine-3-carboxamide, 5-methoxy-2-methyl-4-(2-{[({(1E)-1-[3-(trifluoro-methyl)phenyl]ethylidene}amino)oxy]methyl}phenyl)-2,4-dihydro-3H-1,2,4-triazol-3-one, methyl (2E)-2-{2-[({cyclopropyl[(4-methoxyphenyl)imino]methyl}sulphanyl)methyl]phenyl}-3-methoxy-prop-2-enoate, N-(3-ethyl-3,5,5-trimethylcyclohexyl)-3-(formylamino)-2-hydroxybenzamide, 2-{2-[(2,5-dimethylphenoxy)methyl]phenyl}-2-methoxy-N-methylacetamide and (2R)-2-{2-[(2,5-dimethylphenoxy)methyl]phenyl}-2-methoxy-N-methylacetamide.

(F4) Mitosis and cell division inhibitors, such as, for example, benomyl, carbendazim, chlorfenazole, diethofencarb, ethaboxam, fluopicolid, fuberidazole, pencycuron, thiabendazole, thiophanate-methyl, thiophanate, zoxamide, 5-chloro-7-(4-methylpiperidin-1-yl)-6-(2,4,6-trifluorophenyl) [1,2,4]triazolo[1,5-a]pyrimidine and 3-chloro-5-(6-chloropyridin-3-yl)-6-methyl-4-(2,4,6-trifluorophenyl)pyridazine.

(F5) Compounds with multi-site activity, such as, for example, Bordeaux mixture, captafol, captan, chlorothalonil, copper preparations such as copper hydroxide, copper naphthenate, copper oxide, copper oxychloride, copper sulphate, dichlofluanid, dithianon, dodine, dodine free base, ferbam, fluorofolpet, folpet, guazatine, guazatine acetate, iminoctadine, iminoctadine albesilate, iminoctadine triacetate, man copper, mancozeb, maneb, metiram, metiram-zinc, oxine-copper, propamidine, propineb, sulphur and sulphur preparations such as, for example, calcium polysulphide, thiram, tolylfluanid, zineb and ziram.

(F6) Resistance inductors, such as, for example, acibenzolar-S-methyl, isotianil, probenazole and tiadinil.

(F7) Amino acid and protein biosynthesis inhibitors, such as, for example, andoprim, blasticidin-S, cyprodinil, kasugamycin, kasugamycin hydrochloride hydrate, mepanipyrim and pyrimethanil.

(F8) ATP production inhibitors, such as, for example, fentin acetate, fentin chloride, fentin hydroxide and silthiofam.

(F9) Cell wall synthesis inhibitors, such as, for example, benthiavalicarb, dimethomorph, flumorph, iprovalicarb, mandipropamid, polyoxins, polyoxorim, validamycin A and valifenalate.

(F10) Lipid and membrane synthesis inhibitors, such as, for example, biphenyl, chloroneb, dicloran, edifenphos, etridiazole, iodocarb, iprobenfos, isoprothiolane, propamocarb, propamocarb hydrochloride, prothiocarb, pyrazophos, quintozene, tecnazene and tolclofos-methyl.

(F11) Melanin biosynthesis inhibitors, such as, for example, carpropamid, diclocymet, fenoxanil, fthalide, pyroquilon and tricyclazole.

(F12) Nucleic acid synthesis inhibitors, such as, for example, benalaxyl, benalaxyl M (kiralaxyl), bupirimate, clozylacon, dimethirimol, ethirimol, furalaxyl, hymexazol, metalaxyl, metalaxyl-M (mefenoxam), ofurace, oxadixyl and oxolinic acid.

(F13) Signal transduction inhibitors, such as, for example, chlozolinate, fenpiclonil, fludioxonil, iprodione, procymidon, quinoxyfen and vinclozoline.

(F14) Decouplers, such as, for example, binapacryl, dinocap, ferimzone, fluazinam and meptyldinocap.

(F15) Further compounds, such as, for example, benthiazole, bethoxazin, capsimycin, carvone, chinomethionat, chlazafenon, cufraneb, cyflufenamid, cymoxanil, cyprosulfamide, dazomet, debacarb, dichlorophen, diclomezine, difenzoquat, difenzoquat methylsulphate, diphenylamine, ecomat, fenpyrazamine, flumetover, fluoromid, flusulfamide, flutianil, fosetyl-aluminium, fosetyl-calcium, fosetyl-sodium, hexachlorobenzene, irumamycin, methasulphocarb, methyl isothiocyanate, metrafenone, mildiomycin, natamycin, nickel dimethyldithiocarbamate, nitrothal-isopropyl, octhilinone, oxamocarb, oxyfenthiin, pentachlorophenol and its salts, phenothrin, phosphoric acid and its salts, propamocarb-fosetylate, propanosine-sodium, proquinazid, pyrroInitrin, tebufloquin, tecloftalam, tolnifanid, triazoxide, trichlamide, zarilamide, 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-methoxyphenoxy)-3,3-dimethylbutan-2-yl 1H-imidazole-1-carboxylate, 2,3,5,6-tetrachloro-4-(methylsulphonyl)pyridine, 2,3-dibutyl-6-chlorothieno[2,3-d]pyrimidin-4(3H)-one, 2-[5-methyl-3-(trifluoromethyl)-1H-pyrazol-1-yl]-1-(4-{4-[(5R)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone, 2-butoxy-6-iodo-3-propyl-4H-chromen-4-one, 2-chloro-5-[2-chloro-1-(2,6-difluoro-4-methoxyphenyl)-4-methyl-1H-imidazol-5-yl]pyridine, 2-phenylphenol and its salts, 3,4,5-trichloropyridine-2,6-dicarbonitrile, 3-[5-(4-chlorophenyl)-2,3-dimethyl-1,2-oxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 5-amino-1,3,4-thiadiazole-2-thiol, 5-chloro-N′-phenyl-N′-(prop-2-yn-1-yl)thiophene-2-sulphonohydrazide, 5-methyl-6-octyl[1,2,4]triazolo[1,5-a]pyrimidin-7-amine, ethyl (2Z)-3-amino-2-cyano-3-phenylprop-2-enoate, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(E)-[(cyclopropylmethoxy)imino][6-(difluoromethoxy)-2,3-difluorophenyl]methyl}-2-phenylacetamide, N-{(Z)-[(cyclopropylmethoxy)imino][6-(difluoromethoxy)-2,3-difluorophenyl]methyl}-2-phenylacet-amide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoromethyl)-1H-pyrazol-1-yl]acetyl}piperidin-4-yl)-N-[(1S)-1,2,3,4-tetrahydronaphthalen-1-yl]-1,3-thiazole-4-carboxamide, pentyl {6-[({[(1-methyl-1H-tetrazol-5-yl)(phenyl)methylidene]amino}oxy)methyl]pyridin-2-yl}carbamate, phenazine-1-carboxylic acid, quinolin-8-ol and quinolin-8-ol sulphate (2:1).

(F16) Further compounds, such as, for example, 1-methyl-3-(trifluoromethyl)-N-[2′-(trifluoromethyl)biphenyl-2-yl]-1H-pyrazole-4-carboxamide, N-(4′-chlorobiphenyl-2-yl)-3-(difluoro-methyl)-1-methyl-1H-pyrazole-4-carboxamide, N-(2′,4′-dichlorobiphenyl-2-yl)-3-(difluoromethyl)-1-methyl-1H-pyrazole-4-carboxamide, 3-(difluoromethyl)-1-methyl-N-[4′-(trifluoromethyl)biphenyl-2-yl]-1H-pyrazole-4-carboxamide, N-(2′,5′-difluorobiphenyl-2-yl)-1-methyl-3-(trifluoromethyl)-1H-pyrazole-4-carboxamide, 3-(difluoromethyl)-1-methyl-N-[4′-(prop-1-yn-1-yl)biphenyl-2-yl]-1H-pyrazole-4-carboxamide, 5-fluoro-1,3-dimethyl-N-[4′-(prop-1-yn-1-yl)biphenyl-2-yl]-1H-pyrazole-4-carboxamide, 2-chloro-N-[4′-(prop-1-yn-1-yl)biphenyl-2-yl]pyridine-3-carboxamide, 3-(difluoromethyl)-N-[4′-(3,3-dimethylbut-1-yn-1-yl)biphenyl-2-yl]-1-methyl-1H-pyrazole-4-carboxamide, N-[4′-(3,3-dimethylbut-1-yn-1-yl)biphenyl-2-yl]-5-fluoro-1,3-dimethyl-1H-pyrazole-4-carboxamide, 3-(difluoromethyl)-N-(4′-ethynylbiphenyl-2-yl)-1-methyl-1H-pyrazole-4-carboxamide, N-(4′-ethynylbiphenyl-2-yl)-5-fluoro-1,3-dimethyl-1H-pyrazole-4-carboxamide, 2-chloro-N-(4′-ethynylbiphenyl-2-yl)pyridine-3-carboxamide, 2-chloro-N-[4′-(3,3-dimethylbut-1-yn-1-yl)biphenyl-2-yl]pyridine-3-carboxamide, 4-(difluoromethyl)-2-methyl-N-[4′-(trifluoromethyl)biphenyl-2-yl]-1,3-thiazole-5-carboxamide, 5-fluoro-N-[4′-(3-hydroxy-3-methylbut-1-yn-1-yl)biphenyl-2-yl]-1,3-dimethyl-1H-pyrazole-4-carboxamide, 2-chloro-N-[4′-(3-hydroxy-3-methylbut-1-yn-1-yl)biphenyl-2-yl]pyridine-3-carboxamide, 3-(difluoromethyl)-N-[4′-(3-methoxy-3-methylbut-1-yn-1-yl)biphenyl-2-yl]-1-methyl-1H-pyrazole-4-carboxamide, 5-fluoro-N-[4′-(3-methoxy-3-methylbut-1-yn-1-yl)biphenyl-2-yl]-1,3-dimethyl-1H-pyrazole-4-carboxamide, 2-chloro-N-[4′-(3-methoxy-3-methylbut-1-yn-1-yl)biphenyl-2-yl]pyridine-3-carboxamide, (5-bromo-2-methoxy-4-methylpyridin-3-yl)(2,3,4-trimethoxy-6-methylphenyl)methanone and N-[2-(4-{[3-(4-chlorophenyl)prop-2-yn-1-yl]oxy}-3-methoxyphenyl)ethyl]-N2-(methylsulphonyl)valinamide.

If it makes sense chemically, the active compounds mentioned above may be able to form salts with suitable bases or acids. The active compounds identified here by their common name are known and are described, for example, in the pesticide handbook (“The Pesticide Manual” 14th Ed., British Crop Protection Council 2006) or can be found on the Internet (e.g. http://www.alanwood.net/pesticides).

All plants and plant parts can be treated in accordance with the invention. By plants are understood here all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant varieties which can or cannot be protected by varietal property rights. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. The plant parts also include harvested material and also vegetative and generative propagation material, for example cuttings, tubers, rhizomes, slips and seed.

Treatment according to the invention of the plants and plant parts with the composition according to the invention is carried out directly or by allowing the composition to act on their surroundings, environment or storage space by the customary treatment methods, for example by immersion, spraying, evaporation, fogging, scattering, painting on, injection and, in the case of propagation material, in particular in the case of seeds, also by applying one or more coats.

The composition according to the invention is particularly suitable for the treatment of seeds. The combinations according to the invention mentioned above as being preferred or particularly preferred may be mentioned as being preferred here. Thus, most of the damage to crop plants which is caused by pests occurs as early as when the seed is infested during storage and after the seed is introduced into the soil, and during and immediately after germination of the plants. This phase is particularly critical since the roots and shoots of the growing plants are particularly sensitive and even minor damage can lead to the death of the whole plant. Protecting the seed and the germinating plant by the use of suitable compositions is therefore of particularly great interest.

The control of plant pests by treating the seed of plants has been known for a long time and is the subject of continuous improvements. However, the treatment of seed entails a series of problems which cannot always be solved in a satisfactory manner. Thus, it is desirable to develop methods for protecting the seed and the germinating plant which dispense with the additional application of crop protection products after planting or after emergence of the plants. It is furthermore desirable to optimize the amount of active compound employed in such a way as to provide optimum protection for the seed and the germinating plant from attack by pests, but without damaging the plant itself by the active compound employed. In particular, methods for the treatment of seed should also take into consideration the intrinsic insecticidal properties of transgenic plants in order to achieve optimum protection of the seed and also of the germinating plant with a minimum of crop protection products being employed.

The present invention therefore in particular also relates to a method for the protection of seed and germinating plants, from attack by pests, by treating the seed with the composition according to the invention.

The invention also relates to the use of the composition according to the invention for controlling plant pests by applying the composition to the seed of conventional or transgenic plants. Furthermore, the invention relates to seed which, for protection against plant pests, has been treated with the composition according to the invention.

Plant pests are in particular insects, arachnids, helminths, nematodes and molluscs encountered in agriculture, in horticulture, in forests, in gardens and in leisure facilities. The compositions according to the invention are active against normally sensitive and resistant species and against all or some stages of development. The plant pests include:

Pests from the phylum: Arthropoda, in particular from the class of the arachnids, for example Acarus spp., Aceria sheldoni, Aculops spp., Aculus spp., Amblyomma spp., Amphitetranychus viennensis, Argas spp., Boophilus spp., Brevipalpus spp., Bryobia praetiosa, Centruroides spp., Chorioptes spp., Dermanyssus gallinae, Dermatophagoides pteronyssius, Dermatophagoides farinae, Dermacentor spp., Eotetranychus spp., Epitrimerus pyri, Eutetranychus spp., Eriophyes spp., Halotydeus destructor, Hemitarsonemus spp., Hyalomma spp., Ixodes spp., Latrodectus spp., Loxosceles spp., Metatetranychus spp., Nuphersa spp., Oligonychus spp., Ornithodorus spp., Ornithonyssus spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vaejovis spp., Vasates lycopersici.

From the order of the Anoplura (Phthiraptera), for example, Damalinia spp., Haematopinus spp., Linognathus spp., Pediculus spp., Ptirus pubis, Trichodectes spp.

From the order of the Chilopoda, for example, Geophilus spp., Scutigera spp.

From the order of the Coleoptera, for example, Acalymma vittatum, Acanthoscelides obtectus, Adoretus spp., Agelastica alni, Agriotes spp., Alphitobius diaperinus, Amphimallon solstitialis, Anobium punctatum, Anoplophora spp., Anthonomus spp., Anthrenus spp., Apion spp., Apogonia spp., Atomaria spp., Attagenus spp., Bruchidius obtectus, Bruchus spp., Cassida spp., Cerotoma trifurcata, Ceutorrhynchus spp., Chaetocnema spp., Cleonus mendicus, Conoderus spp., Cosmopolites spp., Costelytra zealandica, Ctenicera spp., Curculio spp., Cryptorhynchus lapathi, Cylindrocopturus spp., Dermestes spp., Diabrotica spp., Dichocrocis spp., Diloboderus spp., Epilachna spp., Epitrix spp., Faustinus spp., Gibbium psylloides, Hellula undalis, Heteronychus arator, Heteronyx spp., Hylamorpha elegans, Hylotrupes bajulus, Hypera postica, Hypothenemus spp., Lachnosterna consanguinea, Lema spp., Leptinotarsa decemlineata, Leucoptera spp., Lissorhoptrus oryzophilus, Lixus spp., Luperodes spp., Lyctus spp., Megascelis spp., Melanotus spp., Meligethes aeneus, Melolontha spp., Migdolus spp., Monochamus spp., Naupactus xanthographus, Niptus hololeucus, Oryctes rhinoceros, Oryzaephilus surinamensis, Oryzaphagus oryzae, Otiorrhynchus spp., Oxycetonia jucunda, Phaedon cochleariae, Phyllophaga spp., Phyllotreta spp., Popillia japonica, Premnotrypes spp., Prostephanus truncatus, Psylliodes spp., Ptinus spp., Rhizobius ventralis, Rhizopertha dominica, Sitophilus spp., Sphenophorus spp., Stegobium paniceum, Sternechus spp., Symphyletes spp., Tanymecus spp., Tenebrio molitor, Tribolium spp., Trogoderma spp., Tychius spp., Xylotrechus spp., Zabrus spp.

From the order of the Collembola, for example, Onychiurus armatus.

From the order of the Diplopoda, for example, Blaniulus guttulatus.

From the order of the Diptera, for example, Aedes spp., Agromyza spp., Anastrepha spp., Anopheles spp., Asphondylia spp., Bactrocera spp., Bibio hortulanus, Calliphora erythrocephala, Ceratitis capitata, Chironomus spp., Chrysomyia spp., Chrysops spp., Cochliomyia spp., Contarinia spp., Cordylobia anthropophaga, Culex spp., Culicoides spp., Culiseta spp., Cuterebra spp., Dacus oleae, Dasyneura spp., Delia spp., Dermatobia hominis, Drosophila spp., Echinocnemus spp., Fannia spp., Gasterophilus spp., Glossina spp., Haematopota spp., Hydrellia spp., Hylemyia spp., Hyppobosca spp., Hypoderma spp., Liriomyza spp., Lucilia spp., Lutzomia spp., Mansonia spp., Musca spp., Nezara spp., Oestrus spp., Oscinella frit, Pegomyia spp., Phlebotomus spp., Phorbia spp., Phormia spp., Prodiplosis spp., Psila rosae, Rhagoletis spp., Sarcophaga spp., Simulium spp., Stomoxys spp., Tabanus spp., Tannia spp., Tetanops spp., Tipula spp.

From the order of the Heteroptera, for example, Anasa tristis, Antestiopsis spp., Boisea spp., Blissus spp., Calocoris spp., Campylomma livida, Cavelerius spp., Cimex spp., Collaria spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Monalonion atratum, Nezara spp., Oebalus spp., Pentomidae, Piesma quadrata, Piezodorus spp., Psallus spp., Pseudacysta persea, Rhodnius spp., Sahlbergella singularis, Scaptocoris castanea, Scotinophora spp., Stephanitis nashi, Tibraca spp., Triatoma spp.

From the order of the Homoptera, for example, Acyrthosipon spp., Acrogonia spp., Aeneolamia spp., Agonoscena spp., Aleurodes spp., Aleurolobus barodensis, Aleurothrixus spp., Amrasca spp., Anuraphis cardui, Aonidiella spp., Aphanostigma pin, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Drosicha spp., Dysaphis spp., Dysmicoccus spp., Empoasca spp., Eriosoma spp., Erythroneura spp., Euscelis bilobatus, Ferrisia spp., Geococcus coffeae, Hieroglyphus spp., Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva spp., Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes spp., Trioza spp., Typhlocyba spp., Unaspis spp., Viteus vitifolii, Zygina spp.

From the order of the Hymenoptera, for example, Acromyrmex spp., Athalia spp., Atta spp., Diprion spp., Hoplocampa spp., Lasius spp., Monomorium pharaonis, Solenopsis invicta, Tapinoma spp., Vespa spp.

From the order of the Isopoda, for example, Armadillidium vulgare, Oniscus asellus, Porcellio scaber.

From the order of the Isoptera, for example, Coptotermes spp., Cornitermes cumulans, Cryptotermes spp., Incisitermes spp., Microtermes obesi, Odontotermes spp., Reticulitermes spp.

From the order of the Lepidoptera, for example, Acronicta major, Adoxophyes spp., Aedia leucomelas, Agrotis spp., Alabama spp., Amyelois transitella, Anarsia spp., Anticarsia spp., Argyroploce spp., Barathra brassicae, Borbo cinnara, Bucculatrix thurberiella, Bupalus piniarius, Busseola spp., Cacoecia spp., Caloptilia theivora, Capua reticulana, Carpocapsa pomonella, Carposina niponensis, Chematobia brumata, Chilo spp., Choristoneura spp., Clysia ambiguella, Cnaphalocerus spp., Cnephasia spp., Conopomorpha spp., Conotrachelus spp., Copitarsia spp., Cydia spp., Dalaca noctuides, Diaphania spp., Diatraea saccharalis, Earias spp., Ecdytolopha aurantium, Elasmopalpus lignosellus, Eldana saccharina, Ephestia spp., Epinotia spp., Epiphyas postvittana, Etiella spp., Eulia spp., Eupoecilia ambiguella, Euproctis spp., Euxoa spp., Feltia spp., Galleria mellonella, Gracillaria spp., Grapholitha spp., Hedylepta spp., Helicoverpa spp., Heliothis spp., Hofmannophila pseudospretella, Homoeosoma spp., Homona spp., Hyponomeuta padella, Kakivoria flavofasciata, Laphygma spp., Laspeyresia molesta, Leucinodes orbonalis, Leucoptera spp., Lithocolletis spp., Lithophane antennata, Lobesia spp., Loxagrotis albicosta, Lymantria spp., Lyonetia spp., Malacosoma neustria, Maruca testulalis, Mamestra brassicae, Mocis spp., Mythimna separata, Nymphula spp., Oiketicus spp., Oria spp., Orthaga spp., Ostrinia spp., Oulema oryzae, Panolis flammea, Parnara spp., Pectinophora spp., Perileucoptera spp., Phthorimaea spp., Phyllocnistis citrella, Phyllonorycter spp., Pieris spp., Platynota stultana, Plodia interpunctella, Plusia spp., Plutella xylostella, Prays spp., Prodenia spp., Protoparce spp., Pseudaletia spp., Pseudoplusia includens, Pyrausta nubilalis, Rachiplusia nu, Schoenobius spp., Scirpophaga spp., Scotia segetum, Sesamia spp., Sparganothis spp., Spodoptera spp., Stathmopoda spp., Stomopteryx subsecivella, Synanthedon spp., Tecia solanivora, Thermesia gemmatalis, Tinea pellionella, Tineola bisselliella, Tortrix spp., Trichophaga tapetzella, Trichoplusia spp., Tuta absoluta, Virachola spp.

From the order of the Orthoptera, for example, Acheta domesticus, Blatta orientalis, Blattella germanica, Dichroplus spp., Gryllotalpa spp., Leucophaea maderae, Locusta spp., Melanoplus spp., Periplaneta spp., Pulex irritans, Schistocerca gregaria, Supella longipalpa.

From the order of the Siphonaptera, for example, Ceratophyllus spp., Ctenocephalides spp., Tunga penetrans, Xenopsylla cheopis.

From the order of the Symphyla, for example, Scutigerella spp.

From the order of the Thysanoptera, for example, Anaphothrips obscurus, Baliothrips biformis, Drepanothris reuteri, Enneothrips flavens, Frankliniella spp., Heliothrips spp., Hercinothrips femoralis, Rhipiphorothrips cruentatus, Scirtothrips spp., Taeniothrips cardamoni, Thrips spp.

From the order of the Zygentoma (=Thysanura), for example, Lepisma saccharina, Thermobia domestica. for example Lepisma saccharina, Thermobia domestica.

Pests of the phylum: Mollusca, in particular from the class of the Bivalvia, for example Dreissena spp.

From the class of the Gastropoda, for example, Anion spp., Biomphalaria spp., Bulinus spp., Deroceras spp., Galba spp., Lymnaea spp., Oncomelania spp., Pomacea spp., Succinea spp.

Plant pests of the phylum: Nematoda, i.e. phytoparasitic nematodes, in particular Aphelenchoides spp., Bursaphelenchus spp., Ditylenchus spp., Globodera spp., Heterodera spp., Longidorus spp., Meloidogyne spp., Pratylenchus spp., Radopholus similis, Trichodorus spp., Tylenchulus semipenetrans, Xiphinema spp.

Subphylum: Protozoa. It is furthermore possible to control protozoa, such as Eimeria.

One of the advantages of the present invention is that the particular systemic properties of the composition according to the invention mean that treatment of the seed with these active compound combinations not only protects the seed itself, but also the resulting plants after emergence, from pests. In this manner, the immediate treatment of the crop at the time of sowing or shortly thereafter can be dispensed with.

A further advantage is the synergistically increased insecticidal activity of the composition according to the invention in comparison with the individual insecticidally active compound, which exceeds the expected activity of the two active compounds when applied individually. This makes possible an optimization of the amount of active compounds employed.

Furthermore, it must be considered as advantageous that the composition according to the invention can also be employed in particular in transgenic plants and transgenic seed, the plants arising from this seed being capable of expressing a protein directed against pests. By treating such seed with the active compound combinations according to the invention, certain pests can be controlled merely by the expression of the, for example, insecticidal protein, and additionally damage to the seed may be averted by the compositions according to the invention.

The composition according to the invention is suitable for protecting seed of any plant variety as already mentioned above which is employed in agriculture, in the greenhouse, in forests or in horticulture. In particular, this takes the form of seed of maize, peanut, canola, oilseed rape, poppy, soya beans, cotton, beet (for example sugar beet and fodder beet), rice, millet, wheat, barley, oats, rye, sunflower, tobacco, potatoes or vegetables (for example tomatoes, cabbage species). The active compound combinations according to the invention are likewise suitable for treating the seed of fruit plants and vegetables as already mentioned above. The treatment of the seed of maize, soya beans, cotton, wheat and canola or oilseed rape is of particular importance.

Transgenic plants or seeds of transgenic plants generally comprise at least one heterologous gene which governs the expression of a polypeptide with in particular insecticidal properties. In this context, the heterologous genes in transgenic plants or in seeds of transgenic plants may be derived from microorganisms such as Bacillus, Rhizobium, Pseudomonas, Serratia, Trichoderma, Clavibacter, Glomus or Gliocladium. The present invention is particularly suitable for the treatment of transgenic plants or seeds which comprise at least one heterologous gene originating from Bacillus sp. and whose gene product shows activity against the European corn borer and/or the corn root worm. It is particularly preferably a heterologous gene derived from Bacillus thuringiensis.

In the treatment of seed, the composition according to the invention is applied alone or in a suitable formulation to the seed of transgenic or conventional plants. Preferably, the seed is treated in a state in which it is stable enough to avoid damage during treatment. In general, the seed may be treated at any point in time between harvest and sowing. The seed usually used has been separated from the plant and freed from cobs, shells, stalks, coats, hairs or the flesh of the fruits.

When treating the seed, care must generally be taken that the amount of the composition according to the invention applied to the seed and/or the amount of further additives is chosen in such a way that the germination of the seed is not adversely affected, or that the resulting plant is not damaged. This must be borne in mind in particular in the case of active compounds which can have phytotoxic effects at certain application rates.

As already mentioned above, it is possible to treat all plants and their parts according to the invention. In a preferred embodiment, wild plant species and plant cultivars, or those obtained by conventional biological breeding methods, such as crossing or protoplast fusion, (conventional plants) and parts thereof, are treated. In a further preferred embodiment, transgenic plants and plant cultivars obtained by genetic engineering methods, if appropriate in combination with conventional methods (Genetically Modified Organisms), and parts thereof are treated.

Plant cultivars are to be understood as meaning plants having novel properties (“traits”) which have been obtained by conventional breeding, by mutagenesis or by recombinant DNA techniques. These can be cultivars, bio- or genotypes.

The transgenic plants or plant cultivars (obtained by genetic engineering) which are preferably to be treated according to the invention include all plants which, by virtue of the genetic modification, received genetic material which imparted particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products. Further and particularly emphasized examples of such traits are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, sugar beet, tomatoes, peas and other vegetable varieties, cotton, tobacco, oilseed rape and also fruit plants (with the fruits apples, pears, citrus fruits and grapes), and particular emphasis is given to maize, soya beans, potatoes, cotton, tobacco and oilseed rape. Traits that are particularly emphasized are increased defence of the plants against insects, arachnids, nematodes and slugs and snails by virtue of toxins formed in the plants, in particular those formed in the plants by the genetic material from Bacillus thuringiensis (for example by the genes CryIA(a), CryIA(b), CryIA(c), CrylIA, CryIIIA, CrylIIB2, Cry9c, Cry2Ab, Cry3Bb and CryIF and also combinations thereof) (referred to hereinbelow as “Bt plants”). Traits that are also particularly emphasized are the increased defence of the plants against fungi, bacteria and viruses by systemic acquired resistance (SAR), systemin, phytoalexins, elicitors and resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these genetic traits or genetic traits still to be developed, which plant cultivars will be developed and/or marketed in the future.

Depending on the plant species or plant cultivars, their location and growth conditions (soils, climate, vegetation period, nutrition), the treatment with the composition according to the invention may also result in superadditive (“synergistic”) effects. Thus possible are, for example, reduced application rates and/or a widening of the activity spectrum and/or an increase of the activity of the compounds and compositions usable according to the invention, better plant growth, increased tolerance to high or low temperatures, increased tolerance to drought or to water or soil salt content, increased flowering, easier harvesting, accelerated maturation, higher harvest yields, higher quality and/or higher nutritional value of the harvested products, increased storability and/or processability of the harvested products, which exceed the effects normally to be expected.

The invention is illustrated in more detail by the examples below, without being limited thereby. In the examples below, the abbreviations have the following meaning: RME=rapeseed oil methyl ester; AMS=ammonium sulphate; EW=oil-in-water emulsion; ppm=parts per million.

### Example 1

### Foliar Application Myzus persicae/Bell Peppers

| | |
|---|---|
| Solvent: | 7 parts by weight of dimethylformamide |
| Emulsifier: | 1 part by weight of alkylaryl polyglycol ether |

To produce a suitable active compound preparation, 1 part by weight of active compound is mixed with the stated amounts of solvent and emulsifier, and the concentrate is diluted with emulsifier-containing water to the desired concentration. For application with ammonium salts and penetrants (rapeseed oil methyl ester 500 EW), these ingredients are each added to the spray liquor in a concentration of 1000 ppm.

Bell pepper plants (Capsicum annuum) heavily infested by the green peach aphid (Myzus persicae) are treated by spraying with the active compound preparation of the desired concentration. After 6 days, the kill in % is determined. 100% means that all aphids have been killed; 0% means that no aphids have been killed.

TABLE A
Myzus persicae test

| Active compound | Concentration in ppm | Kill in % after 6^{d} |
|---|---|---|
| I-6 | 4 | 15 |
| I-6 + AMS | 4 | 30 |
| I-6 + RME | 4 | 60 |
| I-6 + RME + AMS | 4 | 100 |
| I-1 | 0.8 | 0 |
| I-1 + AMS | 0.8 | 0 |
| I-1 + RME | 0.8 | 45 |
| I-1 + AMS + RME | 0.8 | 65 |

### Example 2

### Foliar Application Aphis gossypii/Cotton

| | |
|---|---|
| Solvent: | 7 parts by weight of dimethylformamide |
| Emulsifier: | 1 part by weight of alkylaryl polyglycol ether |

To produce a suitable active compound preparation, 1 part by weight of active compound is mixed with the stated amounts of solvent and emulsifier, and the concentrate is diluted with emulsifier-containing water to the desired concentration. For application with ammonium salts and penetrants (rapeseed oil methyl ester 500 EW), these ingredients are each added to the spray liquor in a concentration of 1000 ppm.

Cotton plants (Gossypium hirsutum) heavily infested by the cotton aphid (Aphis gossypii) are treated by spraying with the active compound preparation of the desired concentration. After 6 days, the kill in % is determined 100% means that all aphids have been killed; 0% means that no aphids have been killed.

TABLE B-1
Aphis gossypii test

| Active compound | Concentration in ppm | Kill in % after 6^{d} |
|---|---|---|
| I-6 | 0.8 | 0 |
| I-6 + AMS | 0.8 | 0 |
| I-6 + RME | 0.8 | 0 |
| I-6 + RME + AMS | 0.8 | 45 |
| I-1 | 0.8 | 35 |
| I-1 + AMS | 0.8 | 55 |
| I-1 + RME + AMS | 0.8 | 90 |

TABLE B-2
Aphis gossypii test

| Active compound | Concentration in ppm | Kill in % after 6^{d} |
|---|---|---|
| I-6 | 4 | 40 |
| I-6 + RME | 4 | 90 |

### Example 3

### Bemisia tabaci (BEMITA Spray Treatment)

| | |
|---|---|
| Solvents: | 78.0 parts by weight of acetone |
| | 1.5 parts by weight of dimethylformamide |
| Emulsifier: | 0.5 part by weight of alkylaryl polyglycol ether |

To produce a suitable active compound preparation, 1 part by weight of active compound is mixed with the stated amounts of solvents and emulsifier, and the concentrate is diluted with emulsifier-containing water to the desired concentration.

Discs of cotton leaves (Gossypium hirsutum) infested by whitefly (Bemisia tabaci) larvae are sprayed with an active compound preparation of the desired concentration.

After 7 days, the effects in % is determined 100% means that all whiteflies have been killed; 0% means that none of the whiteflies have been killed.

TABLE C
Bemisia tabaci test

| Active compound | Concentration in ppm | Kill in % after 7^{d} |
|---|---|---|
| I-6 | 0.8 | 40 |
| I-6 + RME | 0.8 | 90 |

1. A composition comprising at least one cyclic carbonylamidine of formula (I) 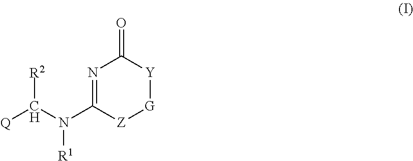
in which
Y represents O, S, NR⁵ or CR³R⁴;
G represents a saturated or unsaturated bond or represents CR³R⁴;
Z represents O, S, CR³R⁴ or NR⁵;
R¹ represents hydrogen, C₁-C₃-alkoxy, C(O)R⁶ or SO₂R⁷, or represents one of the radicals below: C₁-C₄-alkyl, C₃-C₄-alkenyl, C₃-C₄-alkynyl, C₃-C₄-cycloalkyl, C₄-C₅-cycloalkylalkyl, C₄-C₅-alkylcycloalkyl or benzyl which are optionally substituted by 1 to 5 halogen atoms;
R² represents hydrogen or C₁-C₂-alkyl;
R³ and R⁴ independently of one another represent hydrogen or methyl;
R⁵ represents hydrogen, C₁-C₂-alkyl or C₁-C₂-haloalkyl;
R⁶ represents C₁-C₂-alkyl or C₁-C₂-haloalkyl;
R⁷ represents C₁-C₂-alkyl or C₁-C₂-haloalkyl; and
Q represents a 5- or 6-membered unsaturated heterocyclic ring which contains as ring atoms at least one nitrogen atom and other ring atoms from the group consisting of carbon, oxygen and sulphur and which is optionally substituted by 1 to 3 substituents from the group consisting of halogen, cyano, nitro, and C₁-C₄-alkyl, C₁-C₄-alkoxy and C₁-C₄-alkylthio which for their part are optionally substituted by 1 to 5 fluorine atoms or chlorine atoms; or represents 3-tetrahydrofuranyl;
and at least one activity enhancer selected from the group consisting of penetrants and ammonium or phosphonium salts of formula (II) 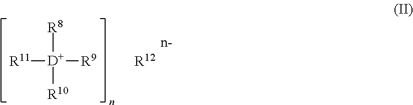
in which
D represents nitrogen or phosphorus;
n represents 1, 2, 3 or 4;
R⁸, R⁹, R¹⁰ and R¹¹ independently of one another represent hydrogen or in each case optionally substituted C₁-C₈-alkyl or mono- or polyunsaturated, optionally substituted C₂-C₈-alkenyl, where the substituents may be selected from the group consisting of halogen, nitro and cyano;
R¹² represents an inorganic or organic anion.

2. A composition according to claim 1 comprising a cyclic carbonylamidine of formula (I) in which
Y represents CH₂ or O;
G represents a saturated or unsaturated bond;
Z represents CH₂;
R¹ represents hydrogen, C₁-C₃-alkoxy, C(O)R⁶ or SO₂R⁷, or represents one of the radicals below: C₁-C₄-alkyl, C₃-C₄-alkenyl, C₃-C₄-alkynyl, C₃-C₄-cycloalkyl, C₄-C₅-cycloalkylalkyl, C₄-C₅-alkylcycloalkyl or benzyl which are optionally substituted by 1 to 5 halogen atoms;
R² represents hydrogen or C₁-C₂-alkyl;
R³ and R⁴ independently of one another represent hydrogen or methyl;
R⁵ represents hydrogen, C₁-C₂-alkyl or C₁-C₂-haloalkyl;
R⁶ represents C₁-C₂-alkyl or C₁-C₂-haloalkyl;
R⁷ represents C₁-C₂-alkyl or C₁-C₂-haloalkyl; and
Q represents a heterocyclic ring selected from the group consisting of pyridinyl, pyrimidinyl, pyridazinyl, pyrazinyl, pyrazolyl, oxazolyl, isoxazolyl, oxadiazolyl, thiadiazolyl, isothiazolyl, imidazolyl, pyrrolyl, thiazolyl and triazolyl which is optionally substituted by one or more substituents selected from the group consisting of halogen, cyano, nitro, and C₁-C₄-alkyl, C₁-C₄-alkoxy and C₁-C₄-alkylthio which for their part are each optionally substituted by fluorine or chlorine.

3. A composition according to claim 1 comprising a cyclic carbonylamidine of formula (Ia) 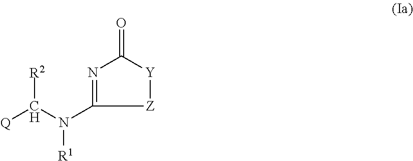
in which
Y-Z represents a grouping O—CR³R⁴, S—CR³R⁴, NR⁵—CR³R⁴ or CR³R⁴—O, O—NR⁵;
R¹ represents hydrogen or C₁-C₃-alkoxy, C₁-C₄-alkyl, C₃-C₄-alkenyl, C₃-C₄-alkynyl, C₃-C₄-cycloalkyl, C₄-C₅-cycloalkylalkyl or C₄-C₅-alkylcycloalkyl, which are optionally substituted by halogen;
R² represents hydrogen, methyl, or ethyl;
R³ and R⁴ independently of one another represent hydrogen or methyl,
R⁵ represents hydrogen, C₁-C₂-alkyl or C₁-C₂-haloalkyl,
Q represents a 5- or 6-membered unsaturated heterocyclic ring which contains as ring atoms at least one nitrogen atom and other ring atoms from the group consisting of carbon, oxygen and sulphur and which is optionally substituted by 1 to 3 substituents from the group consisting of halogen, cyano, nitro, and C₁-C₄-alkyl, C₁-C₄-alkoxy and C₁-C₄-alkylthio which for their part are optionally substituted by 1 to 5 fluorine atoms or chlorine atoms; or represents 3-tetrahydrofuranyl.

4. A composition according to claim 3 comprising a cyclic carbonylamidine of formula (Ia) in which
Y-Z represents a grouping O—CR³R⁴, S—CR³R⁴, NR⁵—CR³R⁴ or CR³R⁴—O, O—NR⁵;
R¹ represents hydrogen, CH₂—CF₃, or represents methyl, ethyl, n-, isopropyl, or cyclopropyl which are optionally substituted by halogen;
R² represents hydrogen or methyl;
R³ and R⁴ independently of one another represent hydrogen or methyl,
R⁵ represents hydrogen, C₁-C₂-alkyl or C₁-C₂-haloalkyl,
Q represents a heterocyclic ring selected from the group consisting of pyridinyl, pyrimidinyl, pyridazinyl, pyrazinyl, pyrazolyl, oxazolyl, isoxazolyl, oxadiazolyl, thiadiazolyl, isothiazolyl, imidazolyl, pyrrolyl, thiazolyl and triazolyl which is optionally substituted by one or more substituents selected from the group consisting of halogen, cyano, nitro, and C₁-C₄-alkyl (for example methyl), C₁-C₄-alkoxy (for example methoxy) and C₁-C₄-alkylthio which for their part are each optionally substituted by fluorine or chlorine.

5. A composition according to claim 1 comprising a cyclic carbonylamidine selected from the following compounds (1-1) to (1-42):
(I-1), 4-[[(6-chloro-3-pyridinyl)methyl]methylamino]-2(5H)-oxazolone,
(I-2), 4-[[(6-chloro-3-pyridinyl)methyl]ethylamino]-2(5H)-oxazolone,
(I-3), 4-[[(6-chloro-3-pyridinyl)methyl]-2-fluoroethylamino]-2(5H)-oxazolone,
(I-4), 4-[[(6-chloro-3-pyridinyl)methyl]-2,2-difluoroethylamino]-2(5H)-oxazolone,
(I-5), 4-[[(6-chloro-3-pyridinyl)methyl]-2,2,2-trifluoroethylamino]-2(5H)-oxazolone,
(I-6), 4-[[(6-chloro-3-pyridinyl)methyl]cyclopropylamino]-2(5H)-oxazolone,
(I-7), 4-[[(6-chloro-3-pyridinyl)methyl]methoxyamino]-2(5H)-oxazolone,
(I-8), 4-[[(6-fluoro-3-pyridinyl)methyl]methylamino]-2(5H)-oxazolone,
(I-9), 4-[[(6-fluoro-3-pyridinyl)methyl]ethylamino]-2(5H)-oxazolone,
(I-10), 4-[[(6-fluoro-3-pyridinyl)methyl]-2-fluoroethylamino]-2(5H)-oxazolone,
(I-11), 4-[[(6-fluoro-3-pyridinyl)methyl]-2,2-difluoroethylamino]-2(5H)-oxazolone,
(I-12), 4-[[(6-fluoro-3-pyridinyl)methyl]-2,2,2-trifluoroethylamino]-2(5H)-oxazolone,
(I-13), 4-[[(6-fluoro-3-pyridinyl)methyl]cyclopropylamino]-2(5H)-oxazolone,
(I-14), 4-[[(6-fluoro-3-pyridinyl)methyl]methoxyamino]-2(5H)-oxazolone,
(I-15), 4-[[(6-bromo-3-pyridinyl)methyl]methylamino]-2(5H)-oxazolone,
(I-16), 4-[[(6-bromo-3-pyridinyl)methyl]ethylamino]-2(5H)-oxazolone,
(I-17), 4-[[(6-bromo-3-pyridinyl)methyl]-2-fluoroethylamino]-2(5H)-oxazolone,
(I-18), 4-[[(6-bromo-3-pyridinyl)methyl]-2,2-difluoroethylamino]-2(5H)-oxazolone,
(I-19), 4-[[(6-bromo-3-pyridinyl)methyl]-2,2,2-trifluoroethylamino]-2(5H)-oxazolone,
(I-20), 4-[[(6-bromo-3-pyridinyl)methyl]cyclopropylamino]-2(5H)-oxazolone,
(I-21), 4-[[(6-bromo-3-pyridinyl)methyl]methoxyamino]-2(5H)-oxazolone,
(I-22), 4-[[(5,6-dichloro-3-pyridinyl)methyl]methylamino]-2(5H)-oxazolone,
(I-23), 4-[[(5,6-dichloro-3-pyridinyl)methyl]ethylamino]-2(5H)-oxazolone,
(I-24), 4-[[(5,6-dichloro-3-pyridinyl)methyl]-2-fluoroethylamino]-2(5H)-oxazolone,
(I-25), 4-[[(5,6-dichloro-3-pyridinyl)methyl]-2,2-difluoroethylamino]-2(5H)-oxazolone,
(I-26), 4-[[(5,6-dichloro-3-pyridinyl)methyl]-2,2,2-trifluoroethylamino]-2(5H)-oxazolone,
(I-27), 4-[[(5,6-dichloro-3-pyridinyl)methyl]cyclopropylamino]-2(5H)-oxazolone,
(I-28), 4-[[(5,6-dichloro-3-pyridinyl)methyl]methoxyamino]-2(5H)-oxazolone,
(I-29), 4-[[(2-chloro-5-thiazolyl)methyl]methylamino]-2(5H)-oxazolone,
(I-30), 4-[[(2-chloro-5-thiazolyl)methyl]ethylamino]-2(5H)-oxazolone,
(I-31), 4-[[(2-chloro-5-thiazolyl)methyl]-2-fluoroethylamino]-2(5H)-oxazolone,
(I-32), 4-[[(2-chloro-5-thiazolyl)methyl]-2,2-difluoroethylamino]-2(5H)-oxazolone,
(I-33), 4-[[(2-chloro-5-thiazolyl)methyl]-2,2,2-trifluoroethylamino]-2(5H)-oxazolone,
(I-34), 4-[[(2-chloro-5-thiazolyl)methyl]cyclopropylamino]-2(5H)-oxazolone,
(I-35) 4-[[(2-chloro-5-thiazolyl)methyl]methoxyamino]-2(5H)-oxazolone,
(I-36), 3-[[(6-chloro-3-pyridinyl)methyl]methylamino]-2-methyl-1,2,4-oxadiazol-5(2H)-one,
(I-37), 3-[[(6-chloro-3-pyridinyl)methyl]ethylamino]-2-methyl-1,2,4-oxadiazol-5(2H)-one,
(I-38), 3-[[(6-chloro-3-pyridinyl)methyl]-2-fluoroethylamino]-2-methyl-1,2,4-oxadiazol-5 (2H)-one,
(I-39), 3-[[(6-chloro-3-pyridinyl)methyl]-2,2-difluoroethylamino]-2-methyl-1,2,4-oxadiazol-5(2H)-one,
(I-40), 3-[[(6-chloro-3-pyridinyl)methyl]-2,2,2-trifluoroethylamino]-2-methyl-1,2,4-oxadiazol-5(2H)-one,
(I-41), 3-[[(6-chloro-3-pyridinyl)methyl]cyclopropylamino]-2-methyl-1,2,4-oxadiazol-5 (2H)-one, and
(I-42), 3-[[(6-chloro-3-pyridinyl)methyl]methoxyamino]-2-methyl-1,2,4-oxadiazol-5(2H)-one.

6. A composition according to claim 1 comprising a penetrant selected from a mineral or vegetable oil and/or a modification thereof and/or an alkanol alkoxylate of formula (III)
R—O-(AO)ᵥ—R′ (III)
in which
R represents straight-chain or branched C₁-C₂₀-alkyl;
R′ represents hydrogen, methyl, ethyl, n-propyl, isopropyl, n-butyl, isobutyl, tert-butyl, n-pentyl or n-hexyl;
AO represents an ethylene oxide radical, a propylene oxide radical, a butylene oxide radical or represents mixtures of ethylene oxide and propylene oxide radicals or butylene oxide radicals; and
v represents a number from 2 to 30.

7. A composition according to claim 6 where the penetrant is a vegetable oil selected from the group consisting of rapeseed oil, sunflower oil and methyl and/or ethyl esters thereof.

8. A composition according to claim 1 comprising an ammonium salt of formula (II) in which
D represents nitrogen;
n represents 1 or 2;
R⁸, R⁹, R¹⁰ and R¹¹ independently of one another represent hydrogen or in each case optionally substituted C₁-C₄-alkyl, where the substituents are selected from the group consisting of halogen, nitro and cyano; and
R¹² represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate.

9. A composition according to claim 1 comprising an ammonium salt selected from among the following salts:
ammonium sulphate, ammonium lactate, ammonium nitrate, ammonium thiosulphate, ammonium thiocyanate, ammonium citrate, ammonium oxalate, ammonium formate, amm-onium hydrogenphosphate, ammonium dihydrogenphosphate, ammonium carbonate, amm-onium benzoate, ammonium sulphite, ammonium benzoate, ammonium hydrogenoxalate, ammonium hydrogencitrate, ammonium acetate, tetramethylammonium sulphate, tetramethylammonium lactate, tetramethylammonium nitrate, tetramethylammonium thiosulphate, tetramethylammonium thiocyanate, tetramethylammonium citrate, tetramethylammonium oxalate, tetramethylammonium formate, tetramethylammonium hydrogenphosphate, tetramethylammonium dihydrogenphosphate, tetraethylammonium sulphate, tetraethylammonium lactate, tetraethylammonium nitrate, tetraethylammonium thiosulphate, tetraethylammonium thiocyanate, tetraethylammonium citrate, tetraethylammonium oxalate, tetraethylammonium formate, tetraethylammonium hydrogenphosphate, and tetraethylammonium dihydrogenphosphate.

10. A composition as defined in claim 1 that is adapted for controlling plant pests.

11. A composition according to claim 10 where the composition is capable of being applied to seed of a conventional and/or transgenic plant.

12. A composition according to claim 10 where the composition is present as a spray liquor or as a tank-mix.

13. A method for controlling plant pests comprising utilizing a composition of claim 1.

14. A method of claim 13, wherein said method comprises applying said composition so as to control plant pests in a conventional and/or transgenic plant and wherein said composition is optionally applied to seed of said plant.

15. A composition according to claim 2 comprising a penetrant selected from a mineral or vegetable oil and/or a modification thereof and/or an alkanol alkoxylate of formula (III)
R—O-(AO)ᵥ—R′ (III)
in which
R represents straight-chain or branched C₁-C₂₀-alkyl;
R′ represents hydrogen, methyl, ethyl, n-propyl, isopropyl, n-butyl, isobutyl, tert-butyl, n-pentyl or n-hexyl;
AO represents an ethylene oxide radical, a propylene oxide radical, a butylene oxide radical or represents mixtures of ethylene oxide and propylene oxide radicals or butylene oxide radicals; and
v represents a number from 2 to 30.

16. A composition according to claim 3 comprising a penetrant selected from a mineral or vegetable oil and/or a modification thereof and/or an alkanol alkoxylate of formula (III)
R—O-(AO)ᵥ—R′ (III)
in which
R represents straight-chain or branched C₁-C₂₀-alkyl;
R′ represents hydrogen, methyl, ethyl, n-propyl, isopropyl, n-butyl, isobutyl, tert-butyl, n-pentyl or n-hexyl;
AO represents an ethylene oxide radical, a propylene oxide radical, a butylene oxide radical or represents mixtures of ethylene oxide and propylene oxide radicals or butylene oxide radicals; and
v represents a number from 2 to 30.

17. A composition according to claim 4 comprising a penetrant selected from a mineral or vegetable oil and/or a modification thereof and/or an alkanol alkoxylate of formula (III)
R—O-(AO)ᵥ—R′ (III)
in which
R represents straight-chain or branched C₁-C₂₀-alkyl;
R′ represents hydrogen, methyl, ethyl, n-propyl, isopropyl, n-butyl, isobutyl, tert-butyl, n-pentyl or n-hexyl;
AO represents an ethylene oxide radical, a propylene oxide radical, a butylene oxide radical or represents mixtures of ethylene oxide and propylene oxide radicals or butylene oxide radicals; and
v represents a number from 2 to 30.

18. A composition according to claim 2 comprising an ammonium salt selected from among the following salts:
ammonium sulphate, ammonium lactate, ammonium nitrate, ammonium thiosulphate, ammonium thiocyanate, ammonium citrate, ammonium oxalate, ammonium formate, ammonium hydrogenphosphate, ammonium dihydrogenphosphate, ammonium carbonate, ammonium benzoate, ammonium sulphite, ammonium benzoate, ammonium hydrogenoxalate, ammonium hydrogencitrate, ammonium acetate, tetramethylammonium sulphate, tetramethylammonium lactate, tetramethylammonium nitrate, tetramethylammonium thiosulphate, tetramethylammonium thiocyanate, tetramethylammonium citrate, tetramethylammonium oxalate, tetramethylammonium formate, tetramethylammonium hydrogenphosphate, tetramethylammonium dihydrogenphosphate, tetraethylammonium sulphate, tetraethylammonium lactate, tetraethylammonium nitrate, tetraethylammonium thiosulphate, tetraethylammonium thiocyanate, tetraethylammonium citrate, tetraethylammonium oxalate, tetraethylammonium formate, tetraethylammonium hydrogenphosphate, and tetraethylammonium dihydrogenphosphate.

19. A composition according to claim 3 comprising an ammonium salt selected from among the following salts:
ammonium sulphate, ammonium lactate, ammonium nitrate, ammonium thiosulphate, ammonium thiocyanate, ammonium citrate, ammonium oxalate, ammonium formate, ammonium hydrogenphosphate, ammonium dihydrogenphosphate, ammonium carbonate, ammonium benzoate, ammonium sulphite, ammonium benzoate, ammonium hydrogenoxalate, ammonium hydrogencitrate, ammonium acetate, tetramethylammonium sulphate, tetramethylammonium lactate, tetramethylammonium nitrate, tetramethylammonium thiosulphate, tetramethylammonium thiocyanate, tetramethylammonium citrate, tetramethylammonium oxalate, tetramethylammonium formate, tetramethylammonium hydrogenphosphate, tetramethylammonium dihydrogenphosphate, tetraethylammonium sulphate, tetraethylammonium lactate, tetraethylammonium nitrate, tetraethylammonium thiosulphate, tetraethylammonium thiocyanate, tetraethylammonium citrate, tetraethylammonium oxalate, tetraethylammonium formate, tetraethylammonium hydrogenphosphate, and tetraethylammonium dihydrogenphosphate.

20. A composition according to claim 4 comprising an ammonium salt selected from among the following salts:
ammonium sulphate, ammonium lactate, ammonium nitrate, ammonium thiosulphate, ammonium thiocyanate, ammonium citrate, ammonium oxalate, ammonium formate, ammonium hydrogenphosphate, ammonium dihydrogenphosphate, ammonium carbonate, ammonium benzoate, ammonium sulphite, ammonium benzoate, ammonium hydrogenoxalate, ammonium hydrogencitrate, ammonium acetate, tetramethylammonium sulphate, tetramethylammonium lactate, tetramethylammonium nitrate, tetramethylammonium thiosulphate, tetramethylammonium thiocyanate, tetramethylammonium citrate, tetramethylammonium oxalate, tetramethylammonium formate, tetramethylammonium hydrogenphosphate, tetramethylammonium dihydrogenphosphate, tetraethylammonium sulphate, tetraethylammonium lactate, tetraethylammonium nitrate, tetraethylammonium thiosulphate, tetraethylammonium thiocyanate, tetraethylammonium citrate, tetraethylammonium oxalate, tetraethylammonium formate, tetraethylammonium hydrogenphosphate, and tetraethylammonium dihydrogenphosphate.

21. A composition as defined in claim 2 that is adapted for controlling plant pests.

22. A composition as defined in claim 3 that is adapted for controlling plant pests.

23. A composition as defined in claim 4 that is adapted for controlling plant pests.

24. A composition as defined in claim 5 that is adapted for controlling plant pests.

25. A composition as defined in claim 6 that is adapted for controlling plant pests.

26. A composition as defined in claim 7 that is adapted for controlling plant pests.

27. A composition as defined in claim 8 that is adapted for controlling plant pests.

28. A composition as defined in claim 9 that is adapted for controlling plant pests.

29. A composition according to claim 5 comprising a penetrant selected from a mineral or vegetable oil and/or a modification thereof and/or an alkanol alkoxylate of formula (III)
R—O-(AO)ᵥ—R′ (III)
in which
R represents straight-chain or branched C₁-C₂₀-alkyl;
R′ represents hydrogen, methyl, ethyl, n-propyl, isopropyl, n-butyl, isobutyl, tert-butyl, n-pentyl or n-hexyl;
AO represents an ethylene oxide radical, a propylene oxide radical, a butylene oxide radical or represents mixtures of ethylene oxide and propylene oxide radicals or butylene oxide radicals; and
v represents a number from 2 to 30.

30. A composition according to claim 2 comprising an ammonium salt of formula (II) in which
D represents nitrogen;
n represents 1 or 2;
R⁸, R⁹, R¹⁰ and R¹¹ independently of one another represent hydrogen or in each case optionally substituted C₁-C₄-alkyl, where the substituents are selected from the group consisting of halogen, nitro and cyano; and
R¹² represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate.

31. A composition according to claim 3 comprising an ammonium salt of formula (II) in which
D represents nitrogen;
n represents 1 or 2;
R⁸, R⁹, R¹⁰ and R¹¹ independently of one another represent hydrogen or in each case optionally substituted C₁-C₄-alkyl, where the substituents are selected from the group consisting of halogen, nitro and cyano; and
R¹² represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate.

32. A composition according to claim 4 comprising an ammonium salt of formula (II) in which
D represents nitrogen;
n represents 1 or 2;
R⁸, R⁹, R¹⁰ and R¹¹ independently of one another represent hydrogen or in each case optionally substituted C₁-C₄-alkyl, where the substituents are selected from the group consisting of halogen, nitro and cyano; and
R¹² represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate.

33. A composition according to claim 5 comprising an ammonium salt of formula (II) in which
D represents nitrogen;
n represents 1 or 2;
R⁸, R⁹, R¹⁰ and R¹¹ independently of one another represent hydrogen or in each case optionally substituted C₁-C₄-alkyl, where the substituents are selected from the group consisting of halogen, nitro and cyano; and
R¹² represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate.

34. A composition according to claim 6 comprising an ammonium salt of formula (II) in which
D represents nitrogen;
n represents 1 or 2;
R⁸, R⁹, R¹⁰ and R¹¹ independently of one another represent hydrogen or in each case optionally substituted C₁-C₄-alkyl, where the substituents are selected from the group consisting of halogen, nitro and cyano; and
R¹² represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate.

35. A composition according to claim 7 comprising an ammonium salt of formula (II) in which
D represents nitrogen;
n represents 1 or 2;
R⁸, R⁹, R¹⁰ and R¹¹ independently of one another represent hydrogen or in each case optionally substituted C₁-C₄-alkyl, where the substituents are selected from the group consisting of halogen, nitro and cyano; and
R¹² represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate or oxalate.

36. A composition according to claim 5 comprising an ammonium salt selected from among the following salts:
ammonium sulphate, ammonium lactate, ammonium nitrate, ammonium thiosulphate, ammonium thiocyanate, ammonium citrate, ammonium oxalate, ammonium formate, ammonium hydrogenphosphate, ammonium dihydrogenphosphate, ammonium carbonate, ammonium benzoate, ammonium sulphite, ammonium benzoate, ammonium hydrogenoxalate, ammonium hydrogencitrate, ammonium acetate, tetramethylammonium sulphate, tetramethylammonium lactate, tetramethylammonium nitrate, tetramethylammonium thiosulphate, tetramethylammonium thiocyanate, tetramethylammonium citrate, tetramethylammonium oxalate, tetramethylammonium formate, tetramethylammonium hydrogenphosphate, tetramethylammonium dihydrogenphosphate, tetraethylammonium sulphate, tetraethylammonium lactate, tetraethylammonium nitrate, tetraethylammonium thiosulphate, tetraethylammonium thiocyanate, tetraethylammonium citrate, tetraethylammonium oxalate, tetraethylammonium formate, tetraethylammonium hydrogenphosphate, and tetraethylammonium dihydrogenphosphate.

37. A composition according to claim 6 comprising an ammonium salt selected from among the following salts:
ammonium sulphate, ammonium lactate, ammonium nitrate, ammonium thiosulphate, ammonium thiocyanate, ammonium citrate, ammonium oxalate, ammonium formate, ammonium hydrogenphosphate, ammonium dihydrogenphosphate, ammonium carbonate, ammonium benzoate, ammonium sulphite, ammonium benzoate, ammonium hydrogenoxalate, ammonium hydrogencitrate, ammonium acetate, tetramethylammonium sulphate, tetramethylammonium lactate, tetramethylammonium nitrate, tetramethylammonium thiosulphate, tetramethylammonium thiocyanate, tetramethylammonium citrate, tetramethylammonium oxalate, tetramethylammonium formate, tetramethylammonium hydrogenphosphate, tetramethylammonium dihydrogenphosphate, tetraethylammonium sulphate, tetraethylammonium lactate, tetraethylammonium nitrate, tetraethylammonium thiosulphate, tetraethylammonium thiocyanate, tetraethylammonium citrate, tetraethylammonium oxalate, tetraethylammonium formate, tetraethylammonium hydrogenphosphate, and tetraethylammonium dihydrogenphosphate.

38. A composition according to claim 7 comprising an ammonium salt selected from among the following salts:
ammonium sulphate, ammonium lactate, ammonium nitrate, ammonium thiosulphate, ammonium thiocyanate, ammonium citrate, ammonium oxalate, ammonium formate, ammonium hydrogenphosphate, ammonium dihydrogenphosphate, ammonium carbonate, ammonium benzoate, ammonium sulphite, ammonium benzoate, ammonium hydrogenoxalate, ammonium hydrogencitrate, ammonium acetate, tetramethylammonium sulphate, tetramethylammonium lactate, tetramethylammonium nitrate, tetramethylammonium thiosulphate, tetramethylammonium thiocyanate, tetramethylammonium citrate, tetramethylammonium oxalate, tetramethylammonium formate, tetramethylammonium hydrogenphosphate, tetramethylammonium dihydrogenphosphate, tetraethylammonium sulphate, tetraethylammonium lactate, tetraethylammonium nitrate, tetraethylammonium thiosulphate, tetraethylammonium thiocyanate, tetraethylammonium citrate, tetraethylammonium oxalate, tetraethylammonium formate, tetraethylammonium hydrogenphosphate, and tetraethylammonium dihydrogenphosphate.

39. A method for controlling plant pests comprising utilizing a composition of claim 2.

40. A method for controlling plant pests comprising utilizing a composition of claim 3.

41. A method for controlling plant pests comprising utilizing a composition of claim 4.

42. A method for controlling plant pests comprising utilizing a composition of claim 5.

43. A method for controlling plant pests comprising utilizing a composition of claim 6.

44. A method for controlling plant pests comprising utilizing a composition of claim 7.

45. A method for controlling plant pests comprising utilizing a composition of claim 8.

46. A method for controlling plant pests comprising utilizing a composition of claim 9.

47. A method for controlling plant pests comprising utilizing a composition of claim 10.

48. A method for controlling plant pests comprising utilizing a composition of claim 11.

49. A method for controlling plant pests comprising utilizing a composition of claim 12.
